(19) United States
(12) Patent Application Publication
(10) Pub. No.: US 2012/0136780 A1
(43) Pub. Date: May 31, 2012

(54) ACCOUNT NUMBER BASED BILL PAYMENT PLATFORM APPARATUSES, METHODS AND SYSTEMS

(76) Inventors: Khalid El-Awady, Mountain View, CA (US); Karen Louise Cervenka, Woodside, CA (US)

(21) Appl. No.: 13/219,258

(22) Filed: Aug. 26, 2011

Related U.S. Application Data
(60) Provisional application No. 61/377,912, filed on Aug. 27, 2010.

(51) Int. Cl. G06Q 20/14

(52) U.S. Cl. 705/40

(57) ABSTRACT

The ACCOUNT NUMBER BASED BILL PAYMENT PLATFORM APPARATUSES, METHODS AND SYSTEMS (“Bill-Pay”) transforms user key-entered billing and account inputs and/or barcode reading inputs via Bill-Pay components into bill payment outputs. In one embodiment, a method is disclosed, comprising: receiving a bill payment transaction request from a bill payment third party agent via a bill payment vehicle; obtaining bill information and payer identifying information; verifying the obtained bill information including a payment amount; retrieving payer account information based on the obtained payer identifying information; and transferring an approved amount to a biller's account from the payer account.

### RELATED APPLICATIONS

Applicant hereby claims priority under 35 USC §119 for U.S. provisional patent application Ser. No. 61/377,912, filed Aug. 27, 2010, entitled “Apparatuses, Methods and Systems for an Account Number Based Bill Payment Platform,” attorney docket no. P-41697PV|20270-014PV.

The instant application is related to Patent Cooperation Treaty international patent application Ser. No. ______, filed ______, entitled “Account Number Based Bill Payment Platform Apparatuses, Methods And Systems,” attorney docket no. P-41697WO01|20270-014PC.

The aforementioned applications are herein expressly incorporated by reference.

This application for letters patent disclosure document describes inventive aspects directed at various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations are directed generally to electronic payment platforms, and more particularly, to ACCOUNT NUMBER BASED BILL PAYMENT PLATFORM APPARATUSES, METHODS AND SYSTEMS.

### BACKGROUND

Consumers may have the need to pay bills for their life expenses. For example, a consumer may receive a printed paper bill (e.g., medical service bills, house utility bills, Internet/cable service bills, etc.) in mail from a service provider at his home address. The consumer may then review the paper bill, and upon agreement to pay, he may write a paper check payable to the service provider, and send the check to the service provider. Upon receiving the check payment, the service provider may deposit the check, and obtain an amount indicated on the original paper bill deposited into the bank account of the service provider.

### BRIEF DESCRIPTION OF THE DRAWINGS

The accompanying appendices and/or drawings illustrate various non-limiting, example, innovative aspects in accordance with the present descriptions:

FIGS. 1A-1F are of a data flow diagrams illustrating data flows between Bill-Pay entities within embodiments of the Bill-Pay operation;

FIGS. 2A-2C and 3A are of logic flow diagrams illustrating aspects of payment process within various embodiments of the Bill-Pay;

FIGS. 3B-3I (broken up into FIGS. 3I-1 to 3I-12) are of flow diagrams illustrating example transaction message flows within embodiments of the Bill-Pay;

FIGS. 4A-4D show example user interface diagrams illustrating example features of a mobile app in some embodiments of the Bill-Pay;

FIGS. 5A-5C show data flow diagrams illustrating an example card-based transaction in some embodiments of the Bill-Pay;

FIGS. 6A-6D show logic flow diagrams illustrating example aspects of executing a card-based transaction in some embodiments of the Bill-Pay;

FIG. 7 shows a block diagram illustrating example data flows of healthcare bill payment within embodiments of the Bill-Pay;

FIGS. 8A-C show logic flow diagrams illustrating various embodiments of healthcare bill payment within embodiments of the Bill-Pay;

FIGS. 9A-B show flow diagrams illustrating alternative embodiments of healthcare bill payment within embodiments of the HP-Platform;

FIGS. 10A-10B show block diagrams illustrating example system components of healthcare bill payment within embodiments of the HP-Platform; and

FIG. 11 shows a block diagram illustrating embodiments of a Bill-Pay controller.

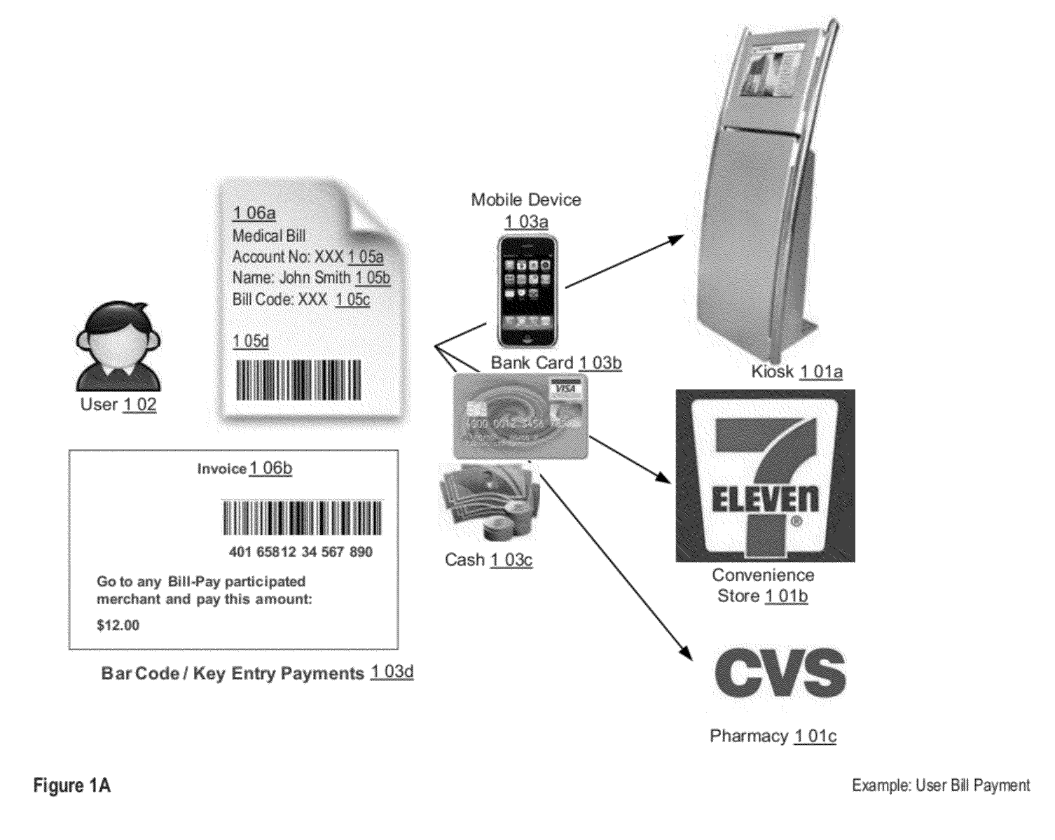

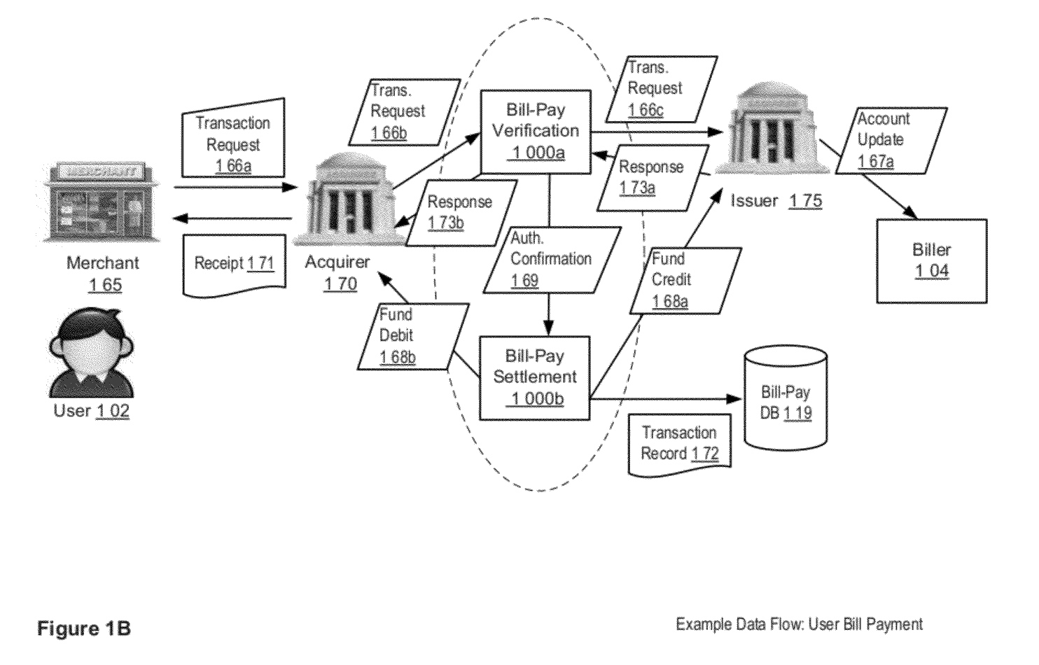

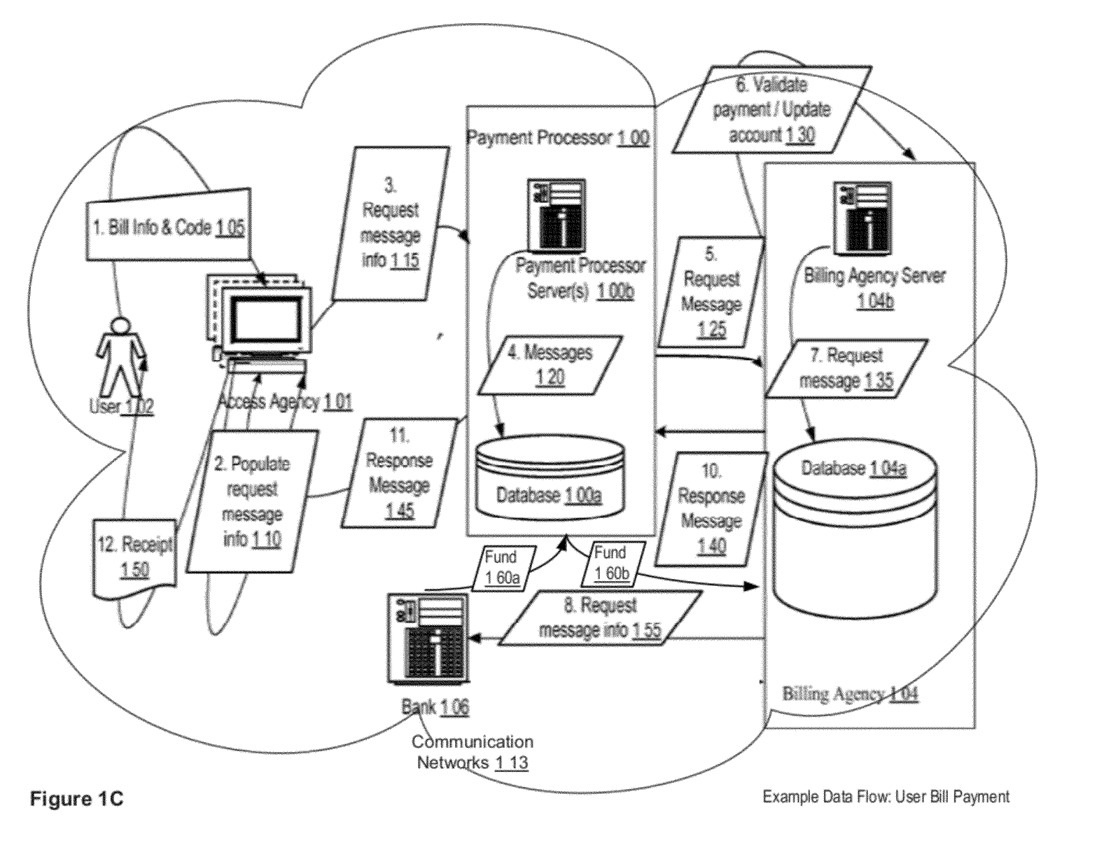

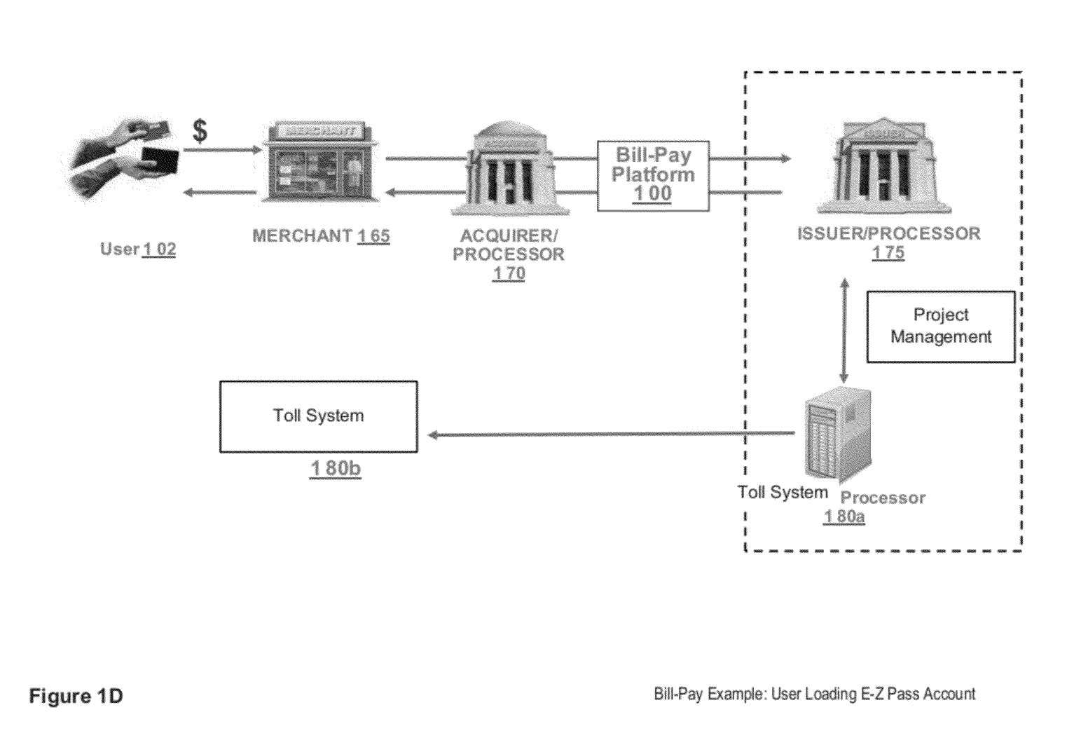

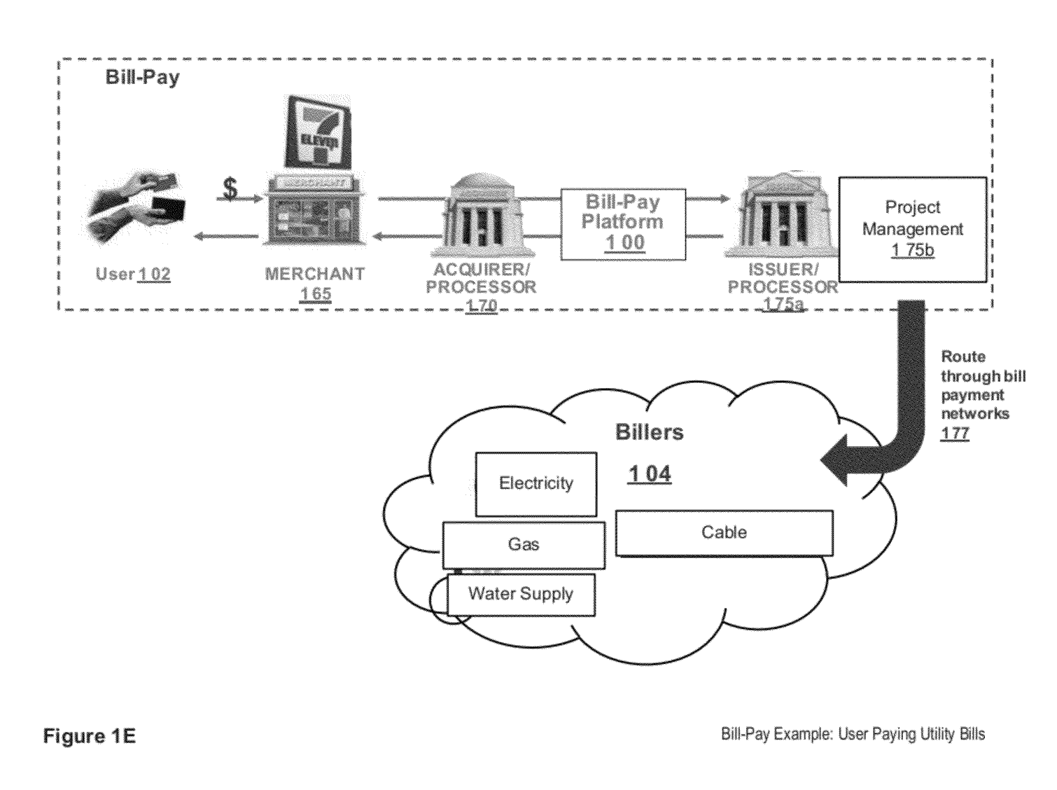

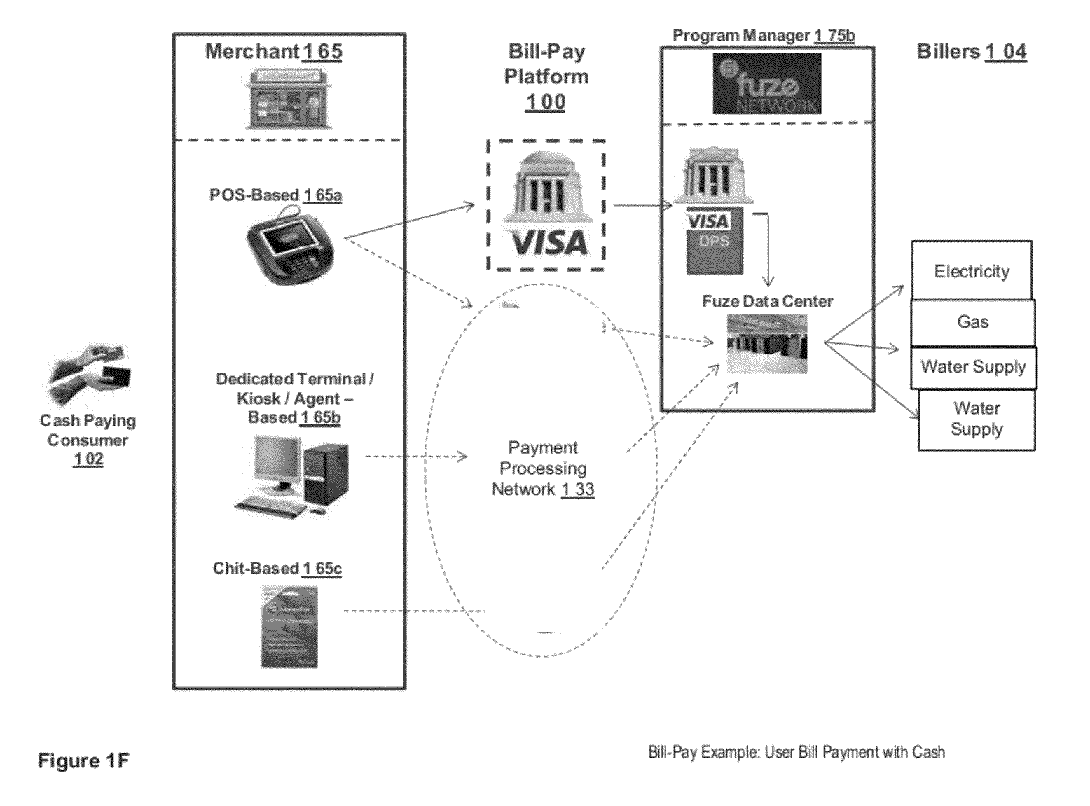

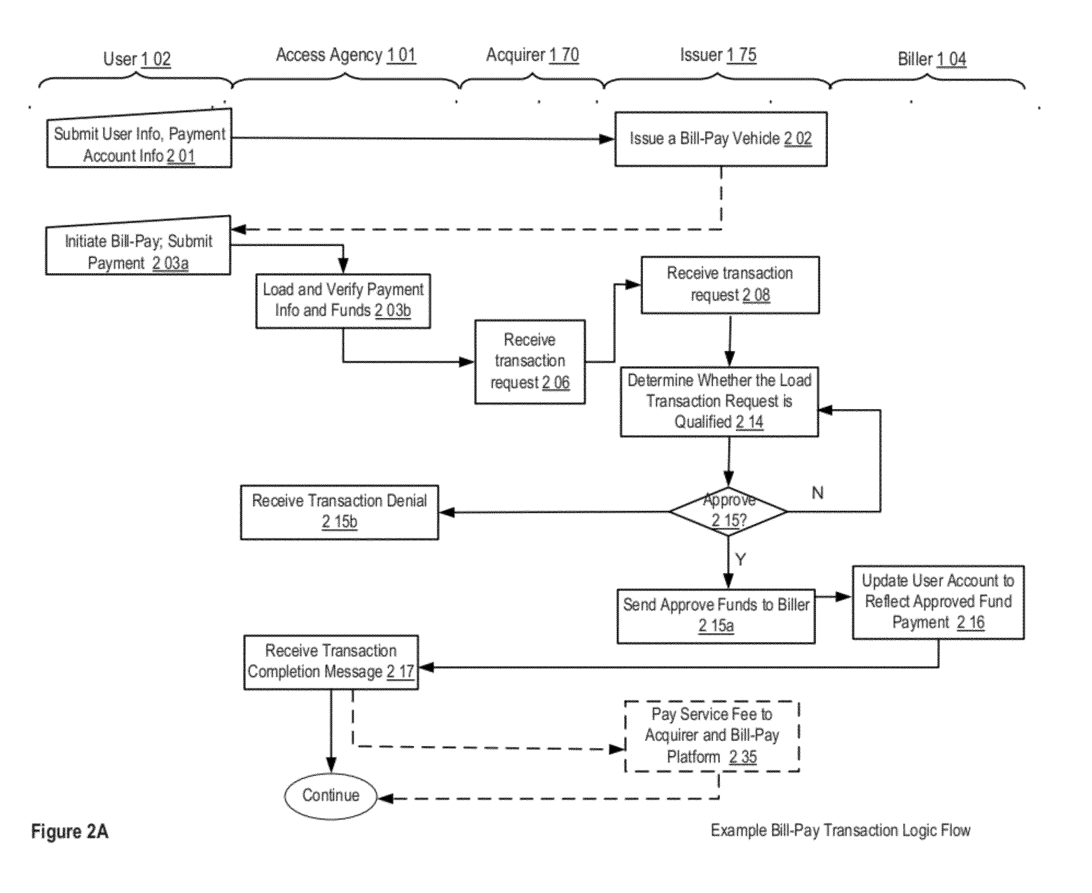

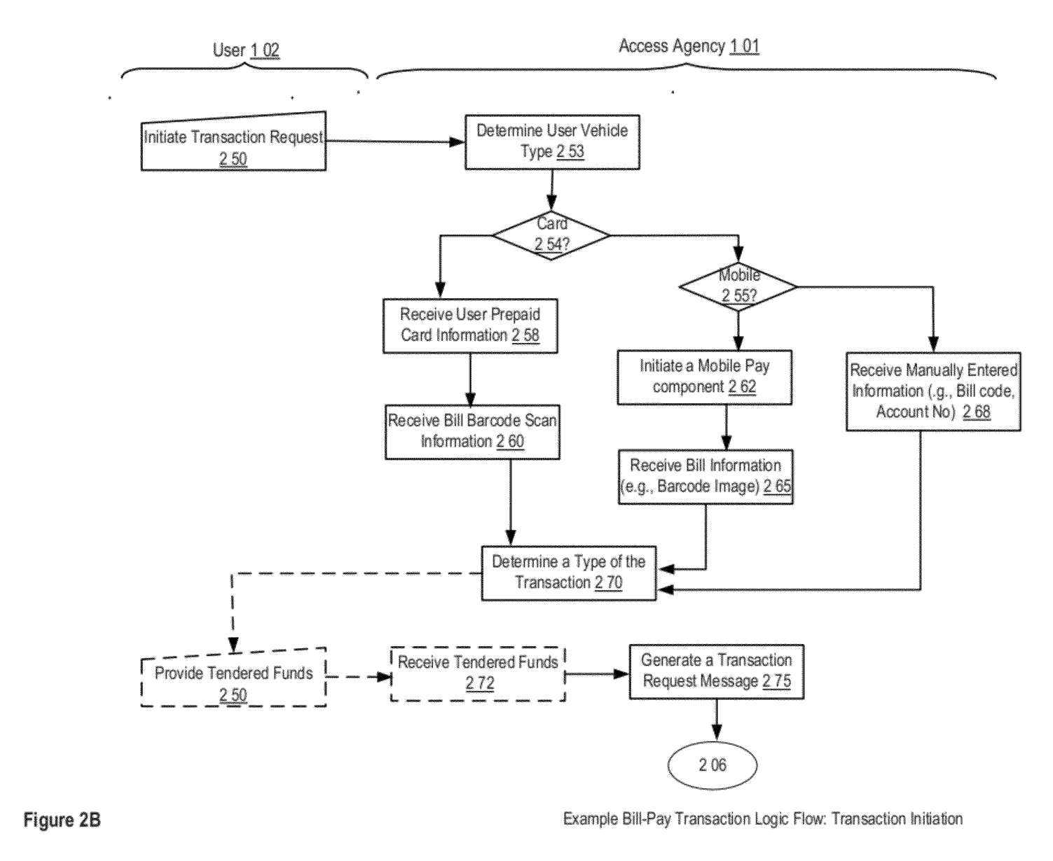

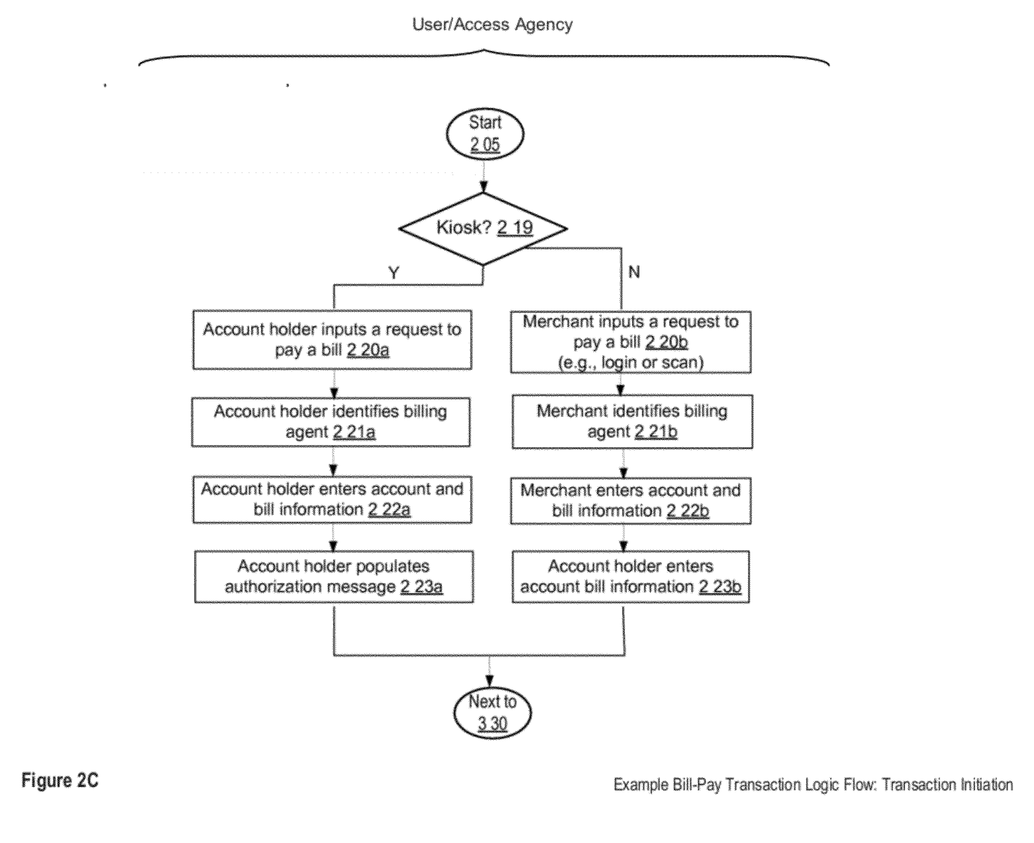

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

The ACCOUNT NUMBER BASED BILL PAYMENT PLATFORM APPARATUSES, METHODS AND SYSTEMS (hereinafter “Bill-Pay”) facilitates, enhances, enables, creates, generates, and/or provides enhanced transactions, transaction management, data collection, data management and/or analysis, interactions, communications, and/or the like, relating to effectuating payments. In one embodiment, the Bill-Pay may be configured to provide users (e.g., cardholdesr of cards associated with the Bill-Pay) with the ability to pay bills using reloadable prepaid card accounts at participating merchant locations. Via the Bill-Pay, a cardholder may make bill payments using a reloadable prepaid card account number that is listed on the bill and/or embedded in specified indicia on a bill (e.g., a bar code).

In some embodiments, prepaid card accounts may be associated with reloadable accounts and may be reloaded through a variety of mechanisms, for example, kiosks located at various retail locations such as convenience stores. These cards may be administered by an entity or entities and/or services associated with the cards (e.g., “Visa ReadyLink” system of Visa Inc.). Depending on the implementation, some embodiments may provide the advantages of being safer than cash.

The Bill-Pay provides a fast and efficient bill payment option to consumers. In some embodiments, the Bill-Pay provides cardholders with the ability to pay bills using reloadable prepaid cards at a participating merchant location using specified indicia on the bill (e.g., the invoice number for the bill the Bill-Pay, a cardholder can use a service that provides the customer with a way to add funds to an eligible and participating reloadable prepaid card, and make bill payments using that card. In some implementations, the Bill-Pay may be configured to drive consumer traffic at participating merchant locations.

### Bill-Pay

FIG. 1A shows a block diagram illustrating user bill payment via Bill-Pay within embodiments of the Bill-Pay. For example, in one implementation, a user 102 may receive a bill, such as a medical bill from a healthcare provider, an Internet/cable bill, a PG&E utility bill, and/or the like. In one implementation, the received bill may be a physical paper bill 106a/b received in mail, facsimile, and/or the like. In another implementation, the bill may comprise an electronic bill received via email, or accessed by the user via the provider's online e-bill platform (e.g., the PG&E online bill system, etc.). In one implementation, the user may bring a copy of the received bill to a Bill-Pay access agency, such as, but not limited to a third party kiosk iota, a convenience store 101b (e.g., a 7/11 store, etc.), a pharmacy 101c (e.g., CVS pharmacy, etc.), and/or the like, to proceed with bill payment.

In another implementation, the user may bring the received bill/invoice 106b to one of the Bill-Pay access agencies 101a-101c and enter barcode/key 103d for payment. For example, a convenience store POS terminal may scan the barcode to read information of the invoice 106b and enter the amount due to process the payment.

In one implementation, the user may engage a Bill-Pay registered vehicle, such as a mobile device 103a, a Bill-Pay card 103b to conduct the payment, together with providing bill payment information, such as, but not limited to the account number 105a, user name 105b, a billing code 105c, barcode information 105d, and/or the like, to the Bill-Pay access agency 101a-101c. For example, the user 102 may swipe a prepaid card 103b at a kiosk 101a, or a point of sale registry at a convenience store/pharmacy to provide payment information. For another example, the user 102 may engage his mobile device 103a, which has been registered with his electronic wallet, for Near Field Communication (NFC) handshake at a POS terminal to provide payment information. For a further implementation, the user may snap a picture of the barcode 105d of the received bill via his mobile device 103a (e.g., an Apple iPhone, etc.), and send the captured barcode together with user credentials and payment information to the Bill-Pay platform. For another example, the user 102 may pay cash 103c at an access agency 101a-101c to complete the bill payment.

FIG. 1B shows a block diagram illustrating interactions and data flows between the Bill-Pay platform and affiliated entities. Within embodiments, a user may pay a bill, load value to a Bill-Pay account and/or the like at a third party point-of-sale (e.g., an access agency) with a Bill-Pay vehicle, e.g., a cardholder's reloadable prepaid card, a Bill-Pay registered mobile device, etc. In one embodiment, a user may submit a Bill-Pay transaction request 166a via a merchant (access agency) 165 to a Bill-Pay acquirer. In one implementation, the Bill-Pay transaction request may comprise a load transaction authorization request, e.g., the user requests to add value to his Bill-Pay account (e.g., a Visa ReadyLink prepaid card). In another implementation, the Bill-Pay transaction request may comprise a bill payment transaction request, e.g., the user requests to pay a bill (or equivalently add value to his account associated with a biller 104). In one implementation, the two types of transactions may be processed by the Bill-Pay in a similar manner via interactions and authorization by acquirers and issuers, and may be used interchangeably throughout the specification.

In one implementation, upon receiving the initial transaction request 166a from a merchant, the acquirer may generate a transaction request 166b, e.g., in a format in compliance with the Visa Single Message System (SMS) and/or InterLink message formats. For example, in one implementation, a transaction authorization request may comprise a Visa SMS 0200/0210 request message, which may comprise fields similar to the following:

TABLE 1
Field Values Required for Settlement of a Load Transaction

| Field | Field Name | Valid Values |
|---|---|---|
| Header | Message status flag, | The value should be set to “1” |
| Field 9, | Gross Interchange | to indicate financial impact |
| Byte 2, Bit 2 | Value updated flag | |
| 2 | Account Number | Number of a Prepaid Card to |
| | | which funds are being loaded |
| 3 | Processing Code, | 28 = Prepaid Load |
| | Transaction Type, | |
| | positions 1-2 | |
| 4 | Amount, transaction | Amount of funds to be loaded |
| 14 | Expiration date | Expiration date of the prepaid |
| | | card |
| . . . | . . . | . . . |
| 63.1 | Network | Acquirers may use priority |
| | Identification code | routing to support the Bill- |
| | | Pay. Acquirers (Network 0003) |
| | | should submit the value 0000 |
| | | and determine the issuer |
| | | network destination and return |
| | | the assigned value of 0002. |
| 63.11 | Reimbursement | Y = SMS supermarket |
| | attribute | Z = SMS general merchant |

In an alternative embodiment, the transaction authorization request may take form similar to a credit transaction data message, e.g., the Visa Original Credit Transaction (OCT) data elements. For example, the transaction authorization request OCT data message may comprise data fields similar to the data message fields table as illustrated in FIGS. 3I-1 to 3I-12.

In one implementation, the transaction request 166c generated and sent by a Bill-Pay verification 1000a may notify the issuer 175 that a specific amount of value is requested to be added to the user's account. Upon approval by the Bill-Pay verification 1000a, the load value amount “reloads” or increments the existing balance of the user's account, e.g., the Reloadable Visa Prepaid card, and/or an account associated with a biller, as further discussed in FIGS. 1D-1F. In one implementation, the Bill-Pay Verification may send an authentication confirmation 169 (e.g., an acknowledgement indicating the transaction is approved or denied, etc.) to the Bill-Pay settlement 1000b. Upon processing the transaction, the Bill-Pay settlement 1000b may credit an approved amount 168a to the issuer 175, and debit the acquirer 170 accordingly of the approved amount 168b. For example, the Bill-Payment settlement 100b may generate a fund transfer log, indicating whether it is a credit or debit. An exemplary eXtensible Markup Language (XML) record of the fund transfer 168a/168b may take a form similar to the following:

<FundTransfer>

<TransferSchedule> 08-18-2000 </TransferSchedule>
<Transferor>
<Bank ID>012345 </Bank ID>
<Bank Account>
<Bank Account Number> 5000555000 </Bank Account Number>
<Bank Account Status> Open </Bank Account Status>
<Bank Routing> XYZ123-456789 </Bank Routing>
</Bank Account>
<TransferType> Credit </TransferType>
<Fund Amount> 100 </Fund Amount>
...
</Transferor>

<Transferee>
<Bank ID>000000</Bank ID>
<Bank Account>
<Bank Account Number> 0000 0000 0000 0000 </Bank

Account Number>

<Bank Account Status> Open </Bank Account Status>
<Bank Routing> 000-0000 </Bank Routing>
</Bank Account>
...
</Transferee>
<TransferType> Credit </TransferType>
<Fund Amount> 100 </Fund Amount>

...
</FundTransfer>

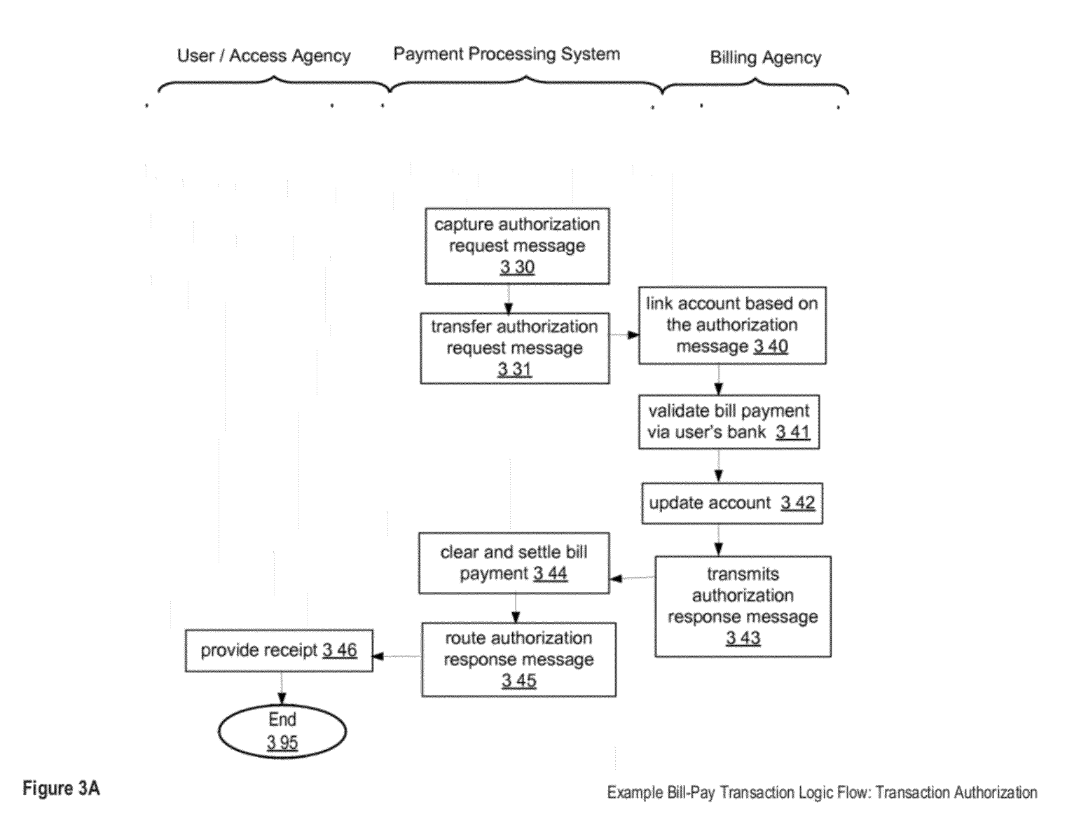

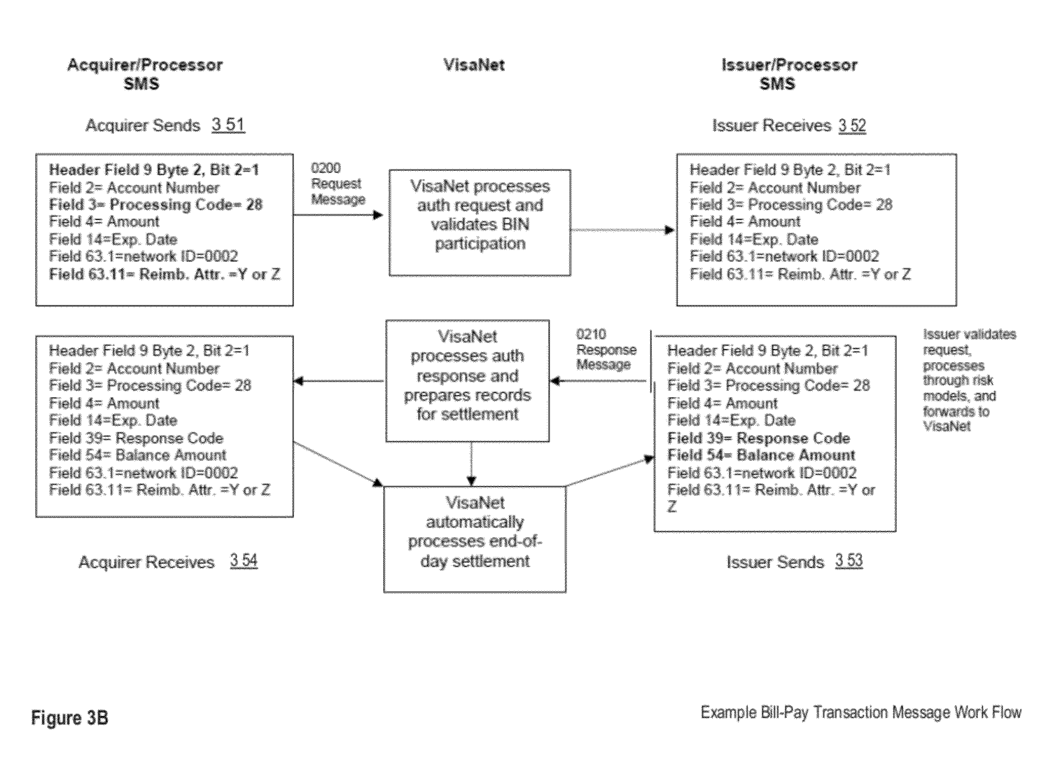

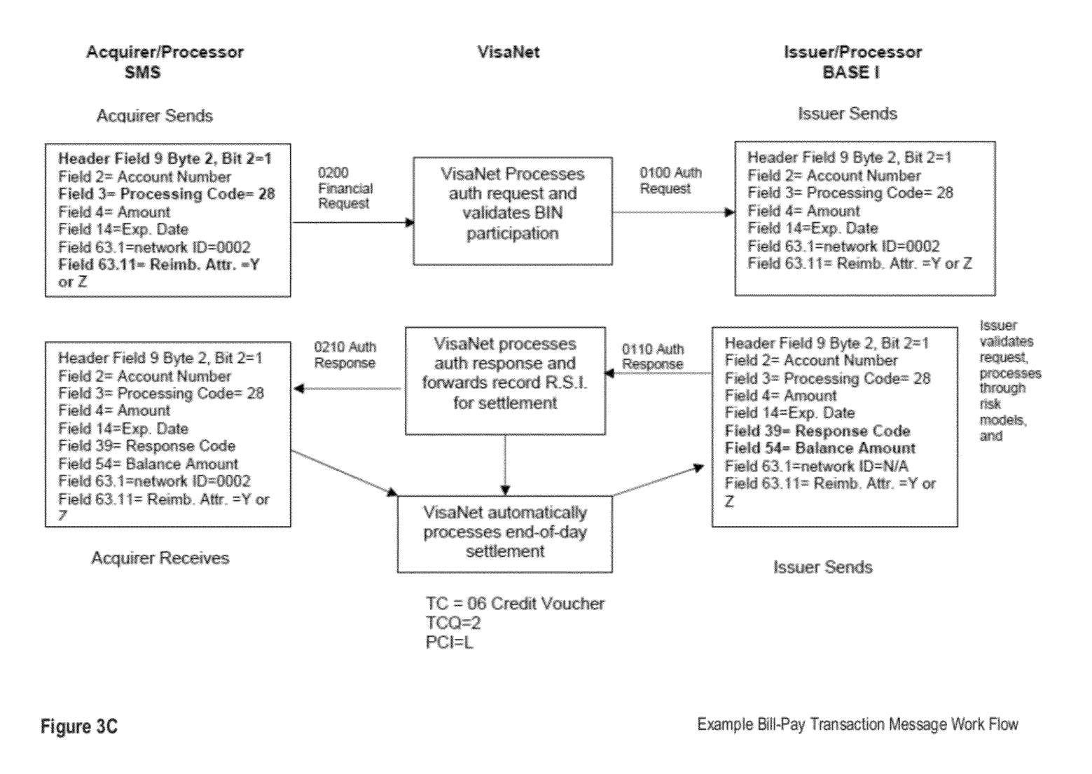

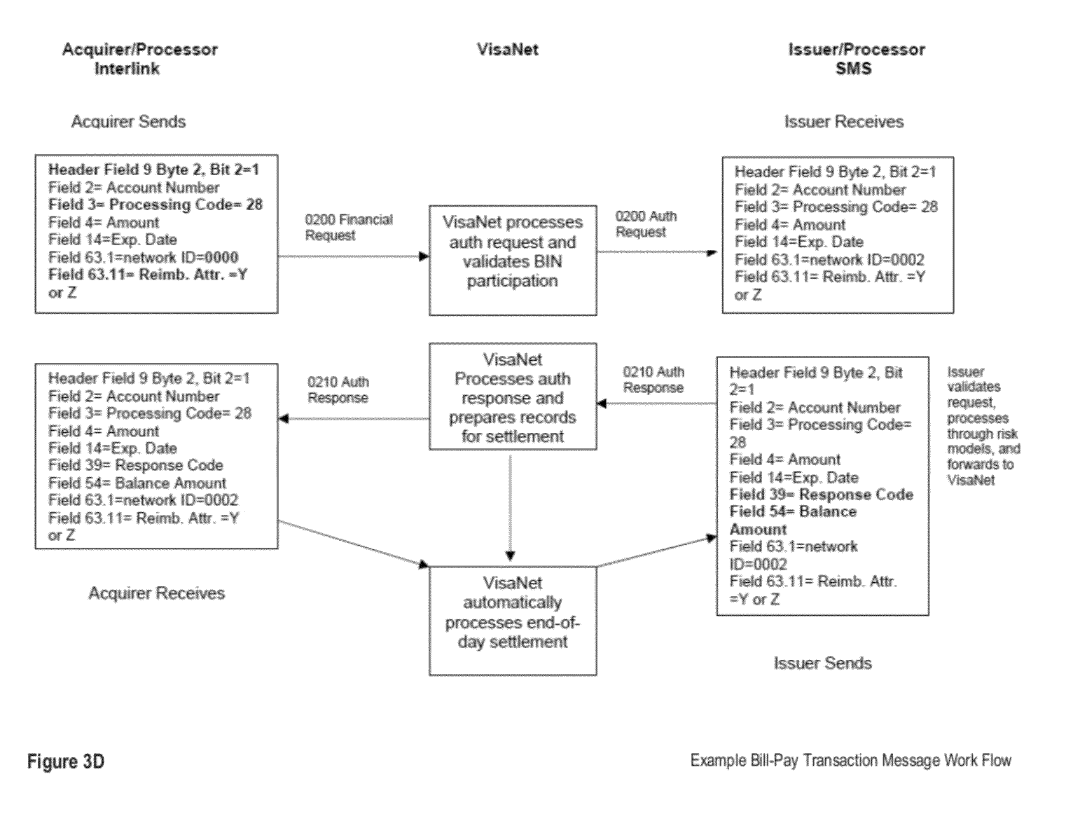

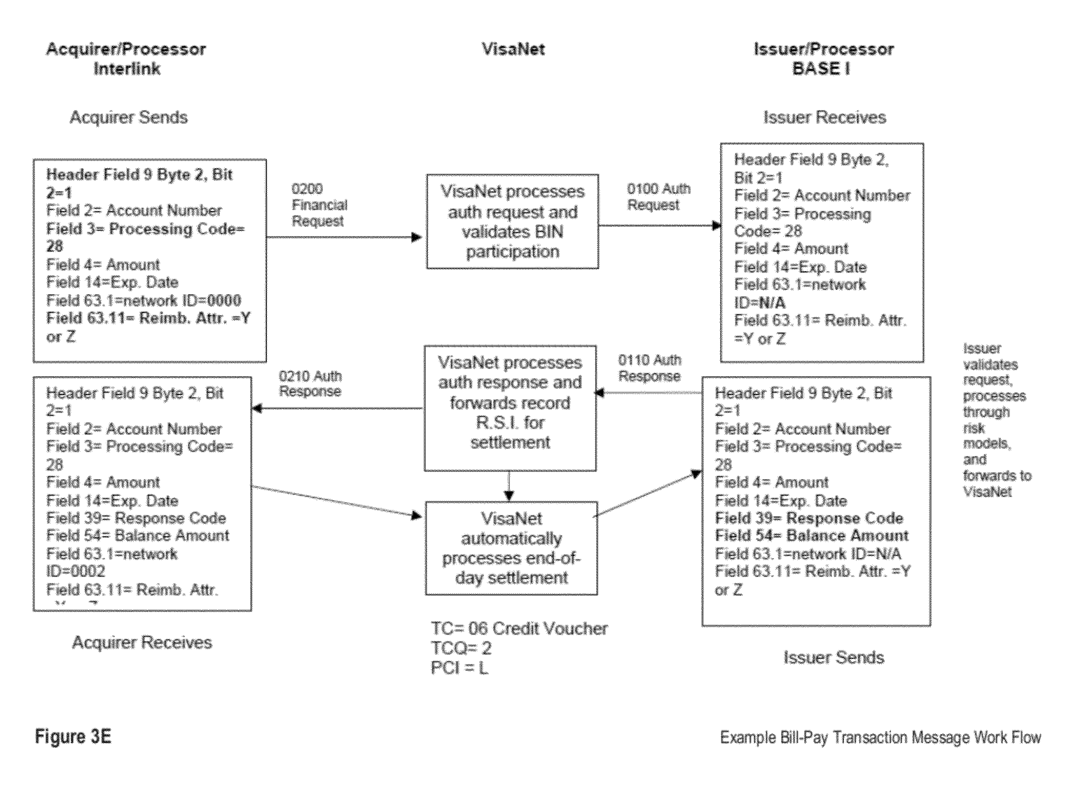

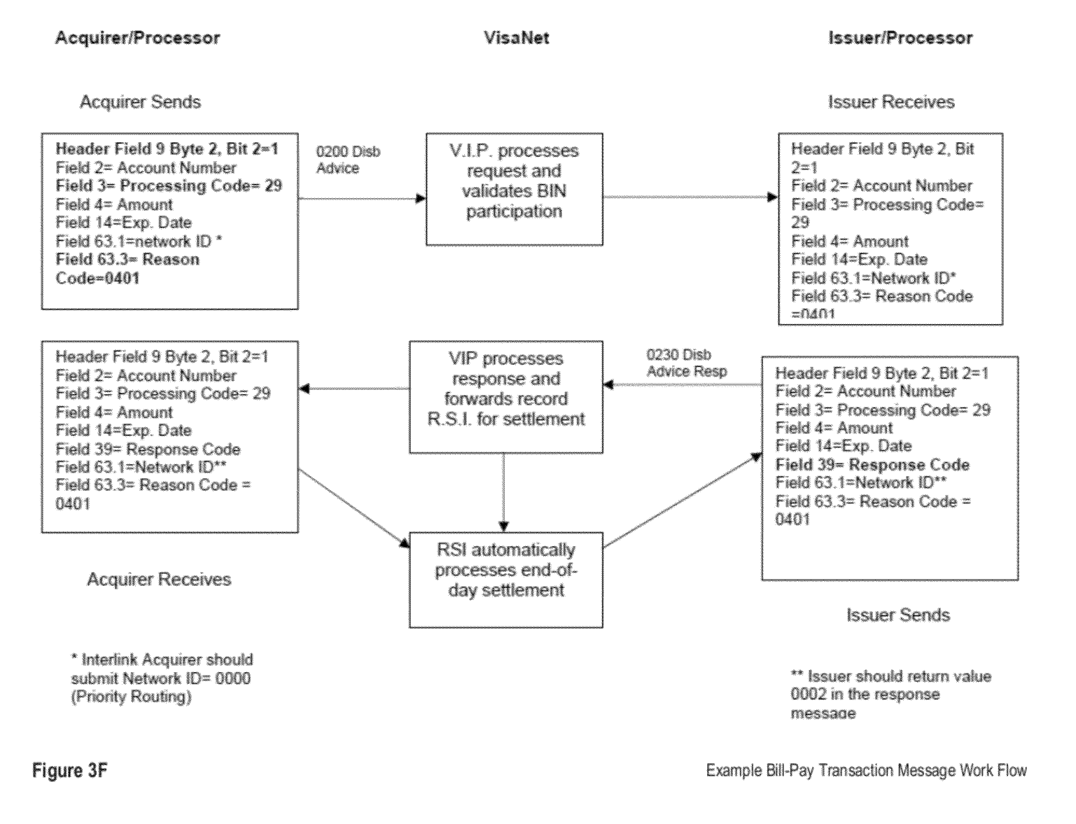

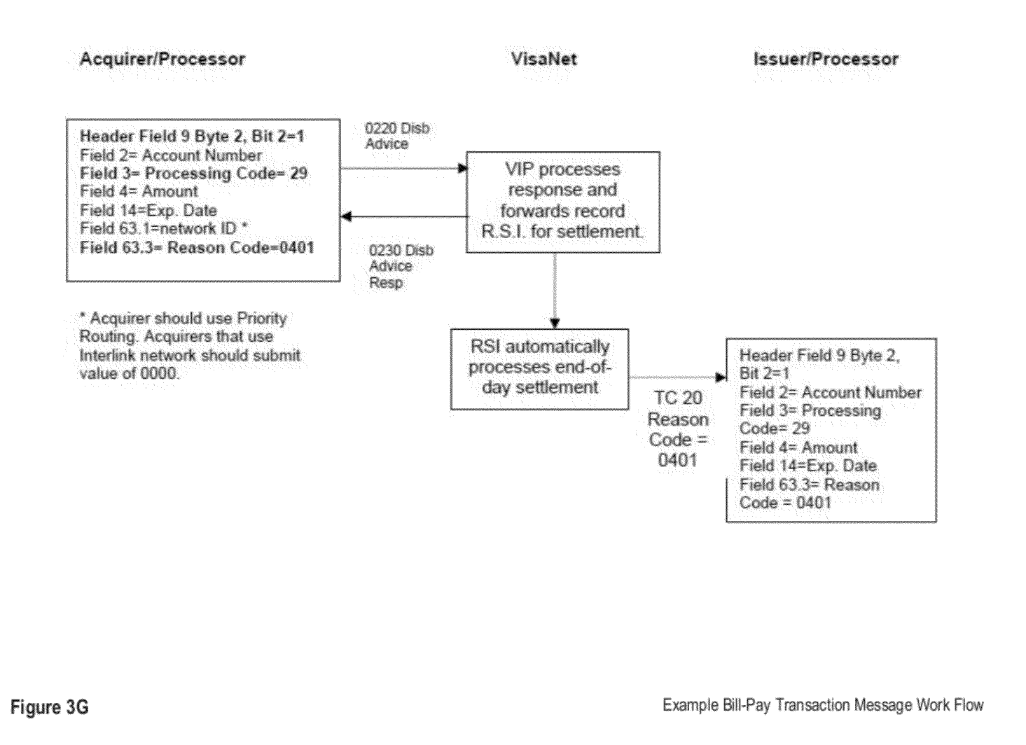

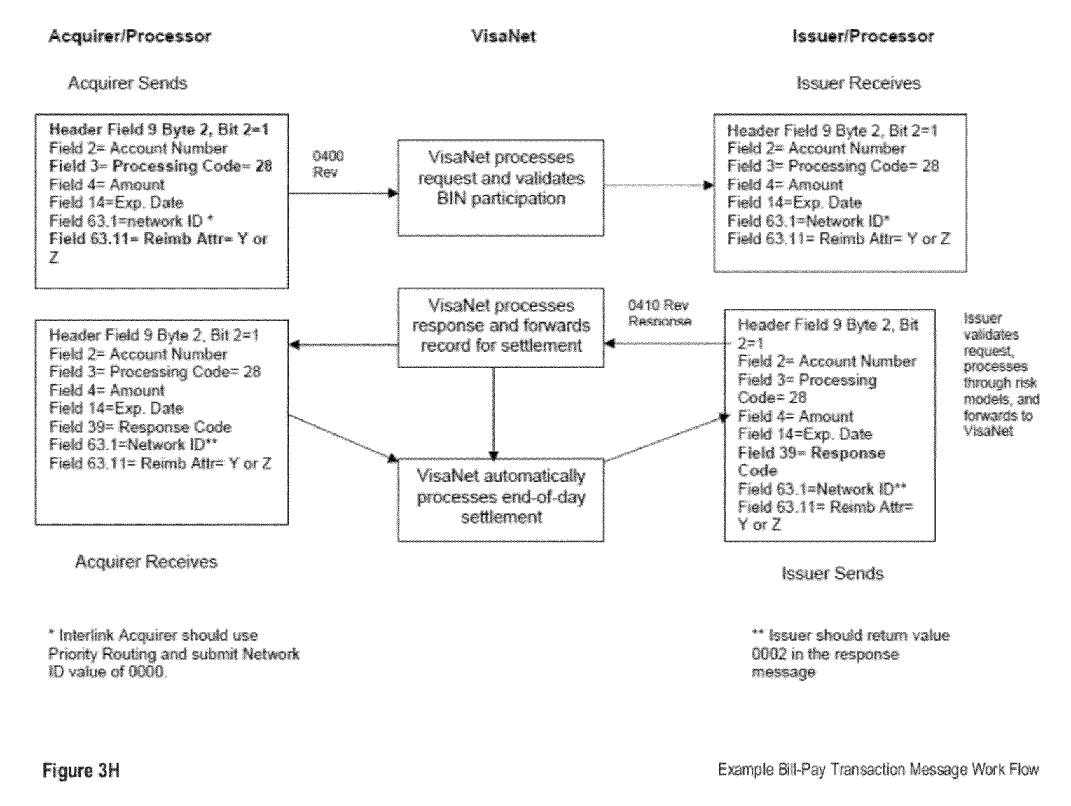

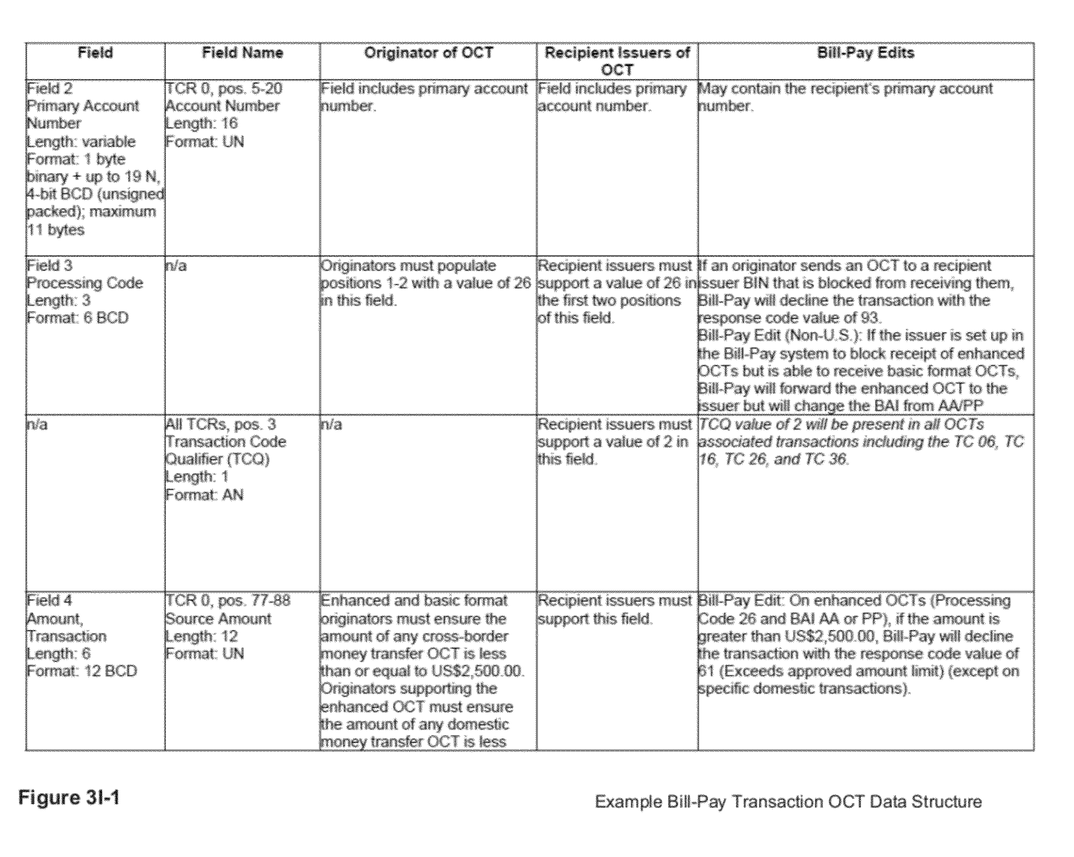

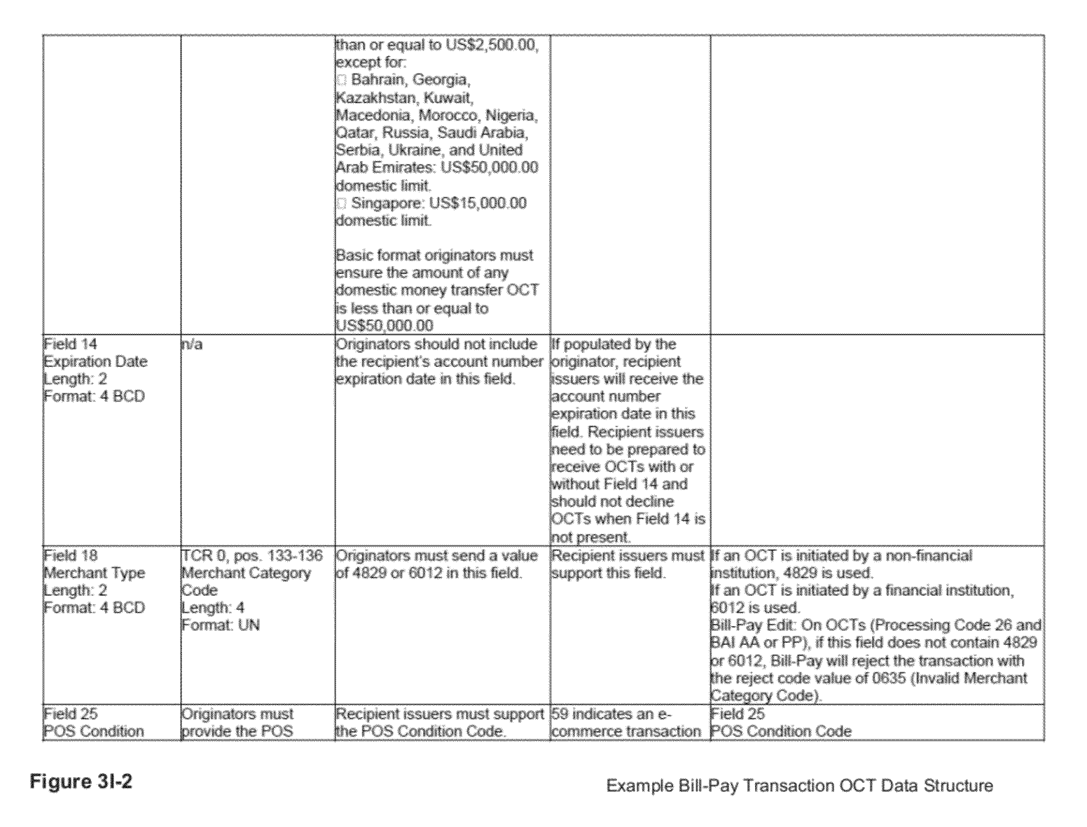

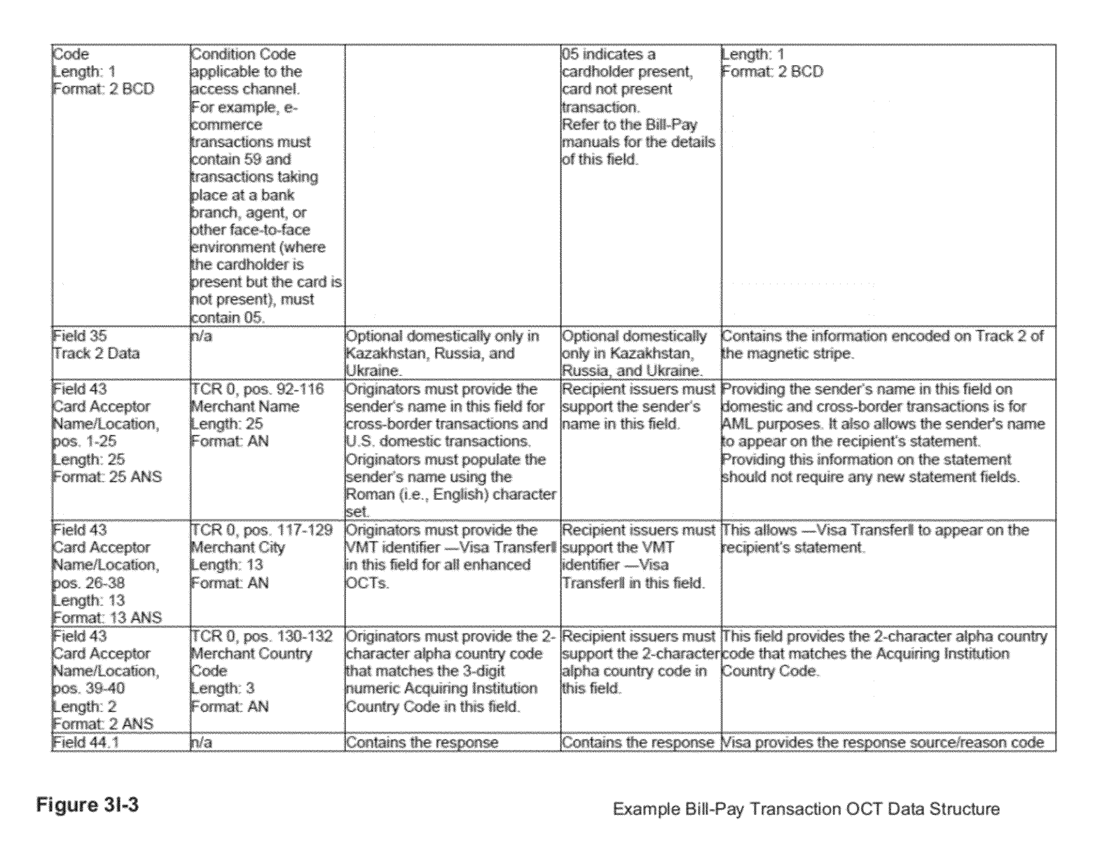

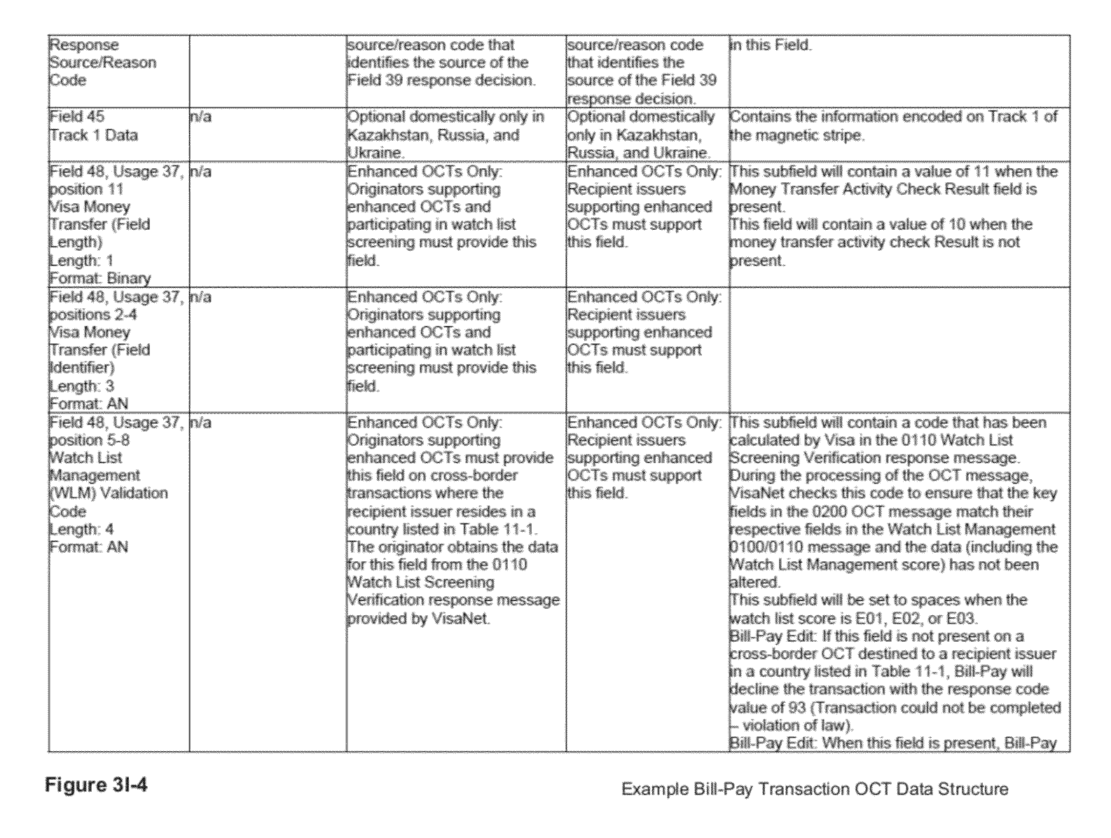

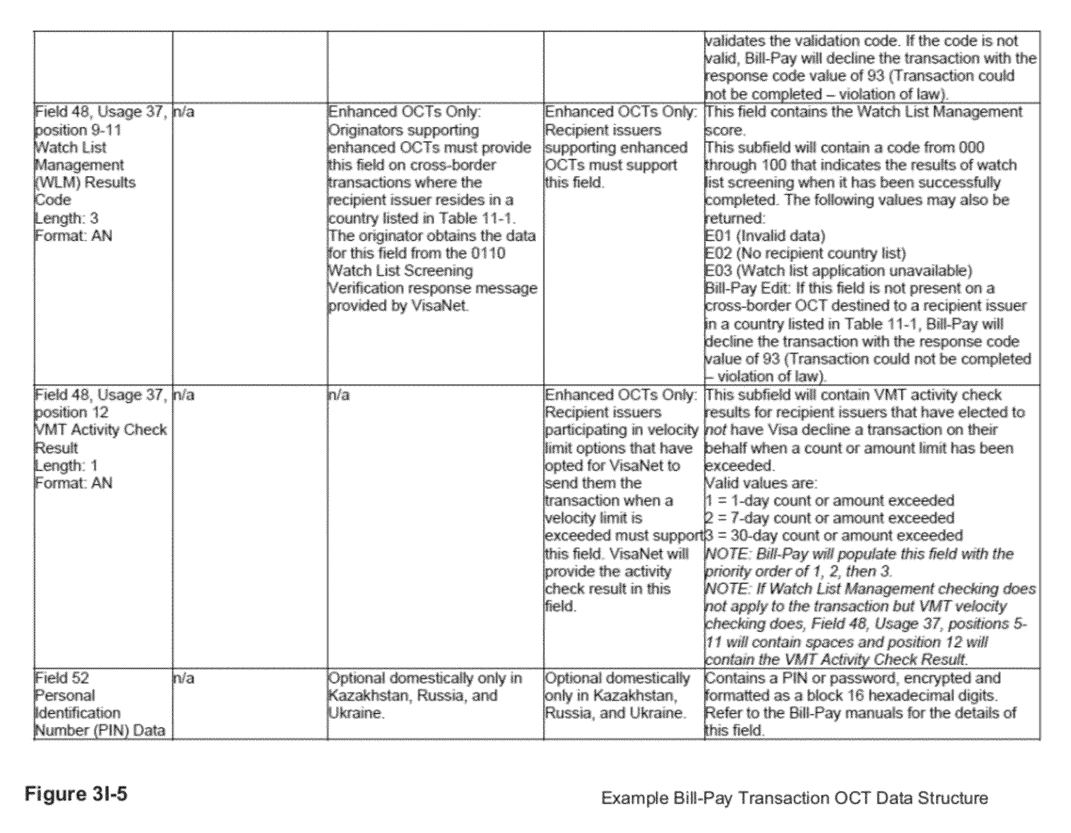

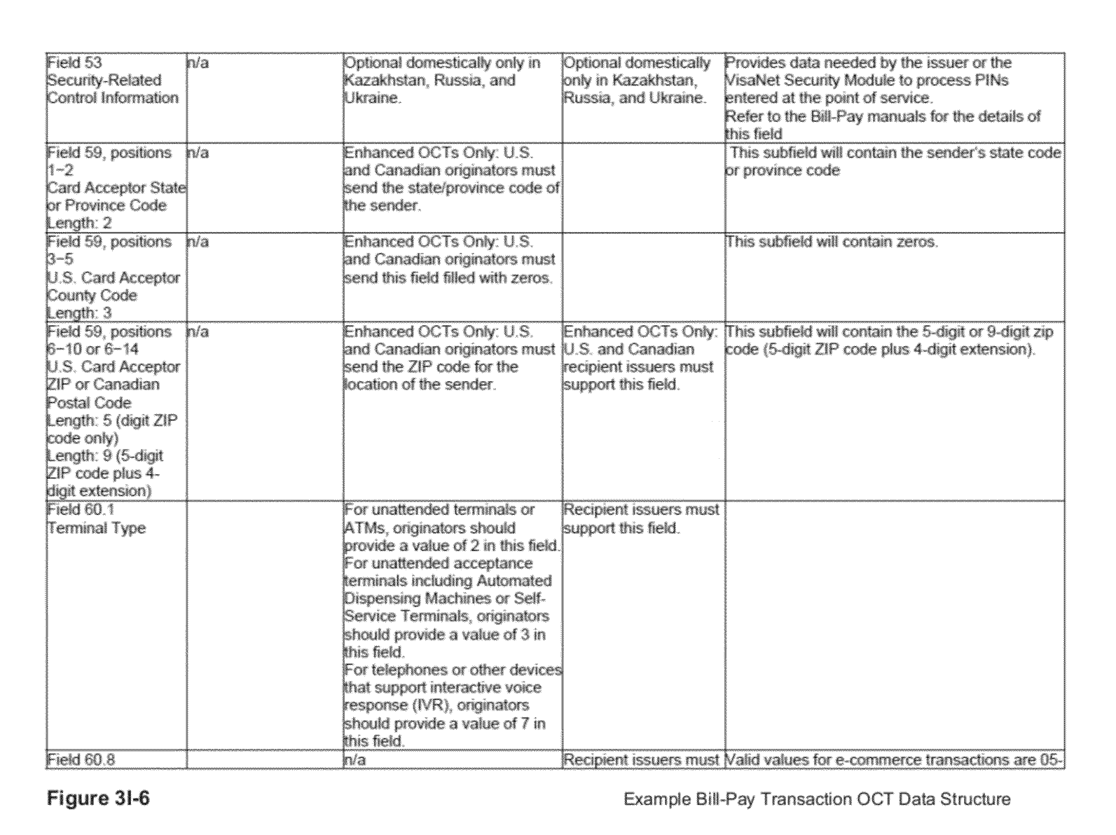

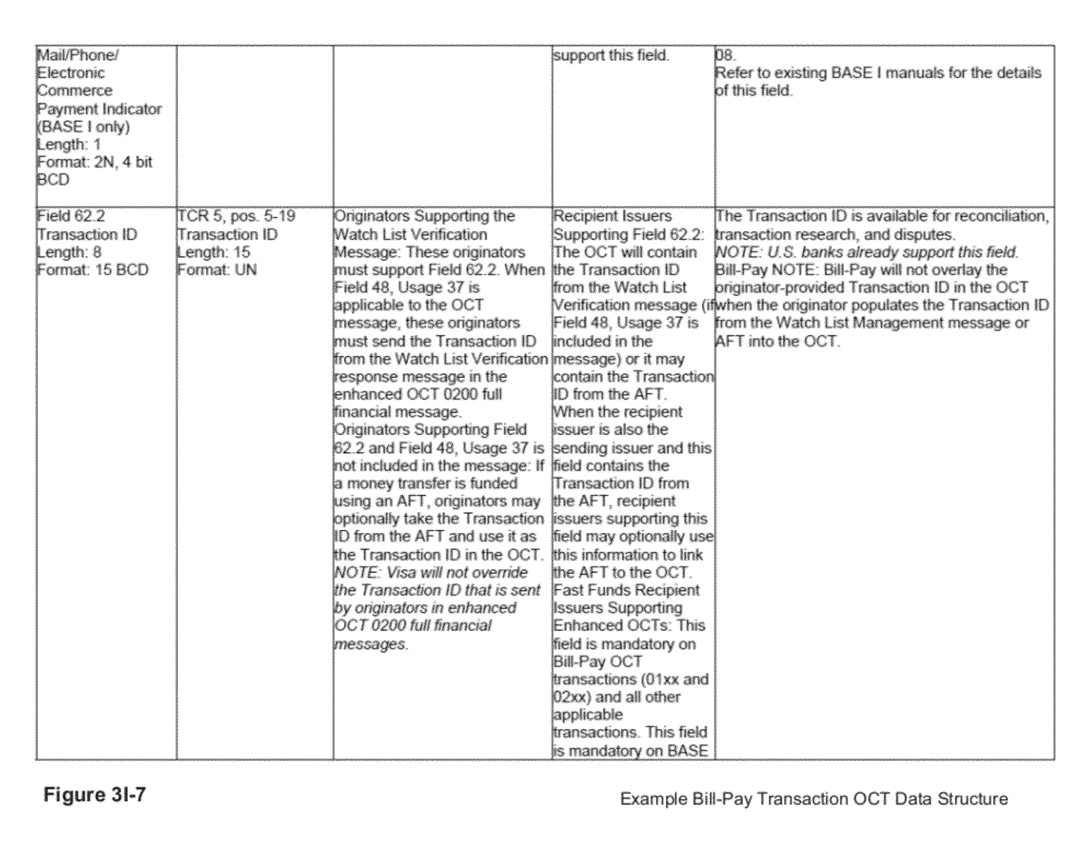

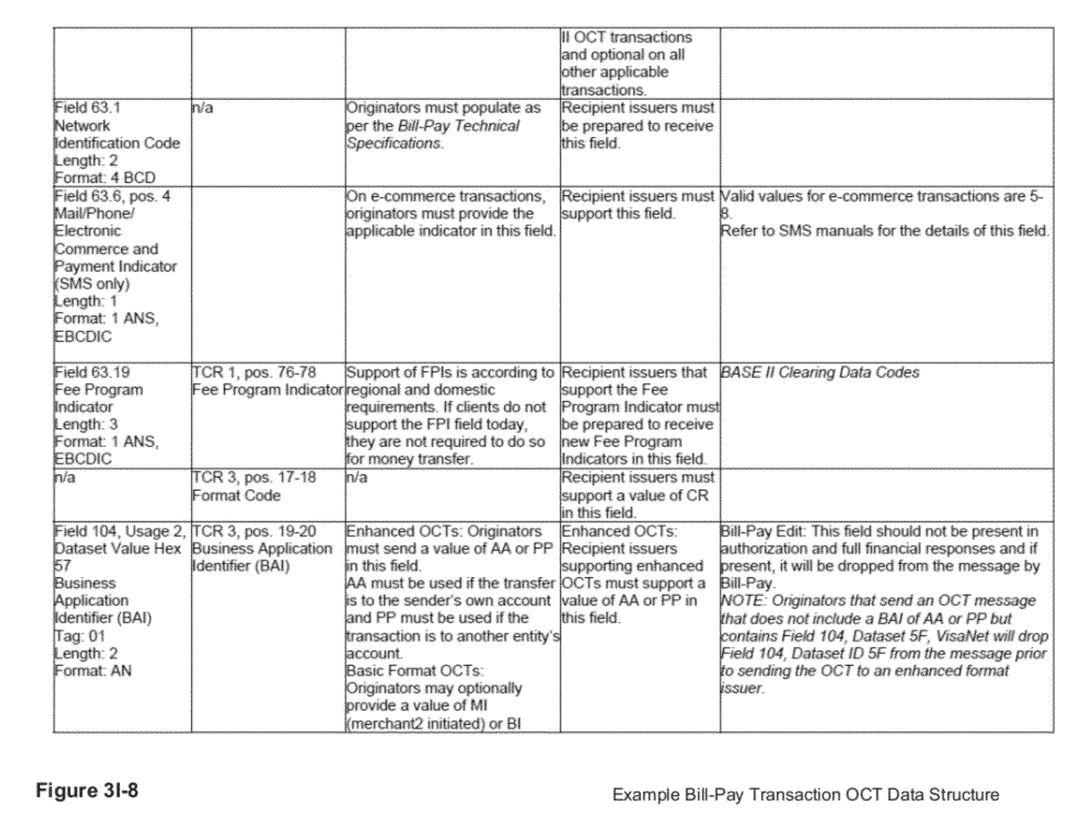

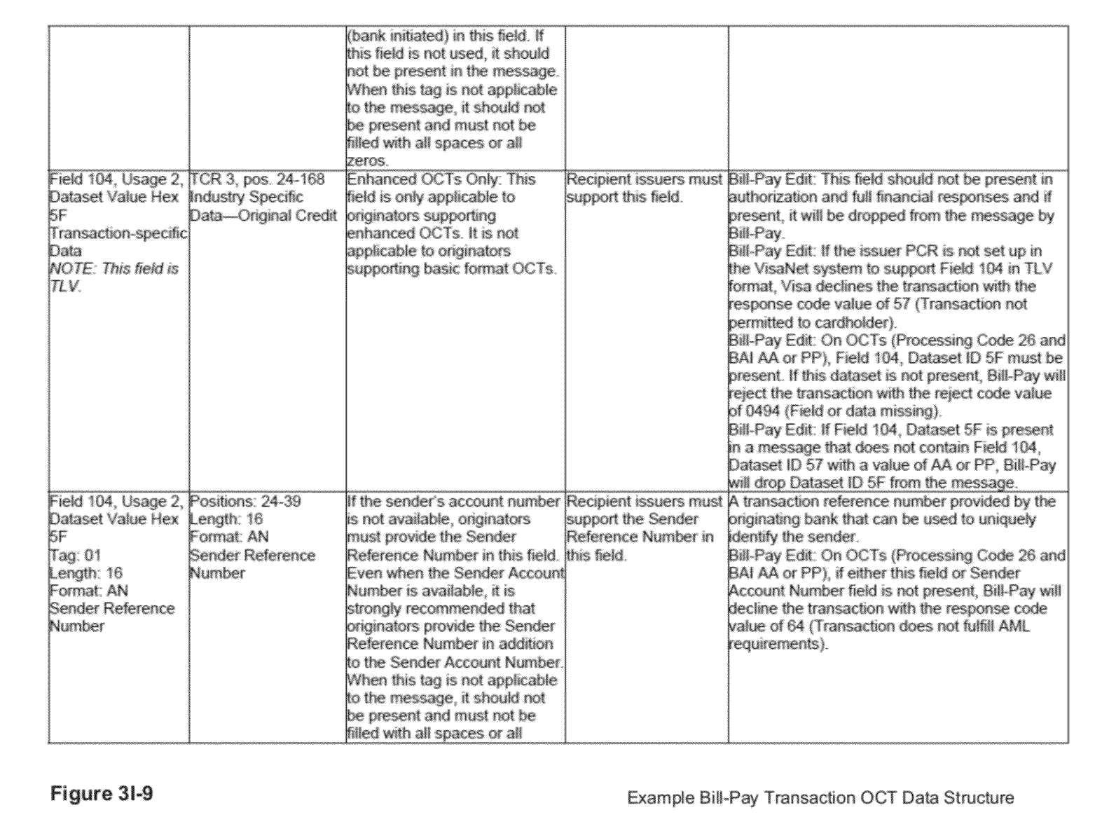

In one implementation, when the transaction comprises a bill payment, upon approving the transaction, the issuer 175 may send a notification to a biller 104 to update the user's account 167a associated with the Biller. Further examples of the transaction message flows 166a, 166b and 166c are discussed in FIGS. 3B-3H.

Upon verification of the transaction, the issuer 175 may send a response 173a (e.g., an acknowledgement of transaction approval or failure in response to the transaction request 166c, etc.) to the Bill-Pay Verification 1000a, which may in turn process the transaction request. For example, the Bill-Pay verification may send an authorization confirmation 169 (e.g., an acknowledgment of transaction authorization or denial) to the Bill-Pay Settlement to trigger fund transfer. In another implementation, the Bill-Pay Verification may forward the response 173b to the acquirer to indicate the completed transaction to the acquirer 170, which may in turn forward the response to the merchant 165 to generate a receipt 171 summarizing the transaction.

In one implementation, the Bill-Pay may generate a transaction record 172 in the Bill-Pay database 119. For example, an XML record of the transaction 172 may take a form similar to:

<Transaction>

<Type> Bill Payment </Type>
<RequestTime> 19:30:27 </RequestTime>
<ReceiptTime> 19:31:56 </ReceiptTime>
<Bill>
<Bill ID> 543210 </Bill ID>
<Bill Issuer ID> 456456 </Bill Issuer ID>
<Bill Name> Cable </Bill Name>
<Bill Amount> 100 </Bill Amount>
<Issuer> ACS </Issuer>
...
</Bill>
<Bank Account>
<Bank Account Number> 55555 </Bank Account Number>
<Bank Account Status> Open </Bank Account Status>
<Bank Routing> XYZ1928 </Bank Routing>
</Bank Account>
<Fund Amount> 100 </Fund Amount>
<Destination>
<Destination ID> 90000 </Destination ID>
<Destination Name> Payment Processor
</Destination Name>
</Destination>
<Merchant>
<Merchant ID> 11111 </Merchant ID>
<Merchant Name> CVS </Merchant Name>
<Merchant Location>
<Merchant City> New York </Merchant City>
<Merchant State> New York </Merchant_ State>
<Merchant Zipcode> 10112 </Merchant_ Zipcode>
<Merchant Fee> 2 </Merchant Fee>
</Merchant>
<ResponseStatus> Clear </ResponseStatus>

...
</Transaction>

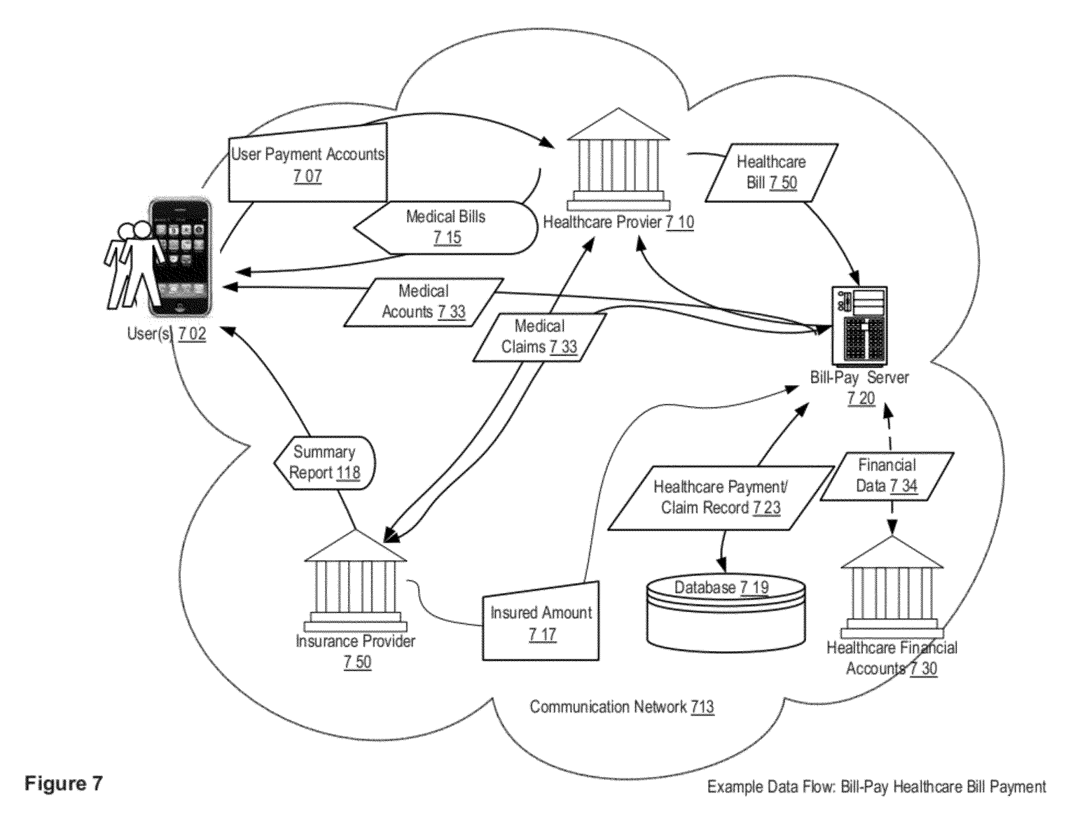

Further implementations of the Bill-Pay databases are discussed in FIG. 1C and 7.

FIG. 1C shows a block diagram illustrating data flows between the Bill-Pay server and affiliated entities within alternative embodiments of the Bill-Pay. Within various embodiments, one or more users 102, Bill-Pay payment processor 100, Bill-Pay access agency 101, Bill-Pay billing agency 104, financial institution (e.g., user's bank, etc.) 106, and/or other entities are shown to interact via various communication network 113. Depending on the embodiment, a variety of other compositions and arrangements of the Bill-Pay, components thereof, and/or affiliated entities may be used.

In the embodiment illustrated in FIG. 1C, a user or users 102 may interact indirectly with a payment processor 100 through an access agency 101 (and/or like entity) and a communications network. The access agency may allow the user to provide user input 105 (e.g., billing information with associated code) via a variety of mechanisms (e.g., keyboard entry into a command-line interface, mouse input in a graphical user interface, gestures on a touch-sensitive interface, voice commands, scanner, camera, etc.). In one implementation, received user input may take a form similar to the following example XML record.

<User Bill Info>

<User>
<User ID> 012345 </User ID>
<User Name> John Smith </User Name>
<User Address>
<User Address City> New York City </User Address City>
<User Address State> New York </User Address State>
<User Phone Number> 2122220000 </User Phone Number>
...
</User Address>
...
</User>
<Bill>
<Bill ID> 543210 </Bill ID>
<Bill Name> Comcast </Bill Name>
<Bill Amount> 100 </Bill Amount>
<BillingCode> ElE-DEC-1999 </BillingCode>
...
</Bill>
<AccountNo> 0000 0000 0000 0000 </AccountNo>
<Barcode>
<BarcodeID> BD0000 </BarcodeID>
<BarcodeType> UPC </BarcodeType>
<BarcodeImage> “BD0000.bmp” </BarcodeImage>
...
</Barcode>
...

</User Bill Info>

In one embodiment, when the information from the user 102 is obtained, it may be parsed to extract the information no and populate the authorization request message 115, and that information provided to the payment processing server mob. In some embodiments, the authorization request message may be, for example, a request from a point-of-sale terminal for authorization for a cardholder purchase or payment. In some embodiments of the Bill-Pay, the payment processor 100 may be implemented on a network that comprises or uses a payment processing network (e.g., VisaNet®). In one embodiment, the payment processor 100 may comprise a group of servers functioning as a unit, such a database server coupled to a web server. In another embodiment, it may comprise a processor and a computer readable medium. Depending on the implementation, the payment processor 100 and any communication network that communicates with the payment processor 100 may use any other suitable wired or wireless network, including the Internet.

In some embodiments, the payment processor 100 may run and/or be implemented on a payment processing organization infrastructure (e.g., Visa ReadyLink). Suitable payment processing organizations may include, for example, Visa Inc., Mastercard Inc., Affiliated Computer Services, and/or others. For example, a prepaid load network, such as Visa ReadyLink, in which customers can load funds to their eligible prepaid cards at various locations. An account balance for a card may comprise a funding amount that is maintained on the prepaid card. Contemplated processors implemented in and/or utilized by the Bill-Pay, may have extensive infrastructure to assist with processing.

Once the message is received, the payment processing server 100b may store the captured information 120 (e.g., the request message information 115, which may take a form similar to 166b as discussed in FIG. 1B) pertaining to the authorization request in a database bow. It is to be understood that a payment processor 100 is illustrated as having remote servers by way of example only and that the Bill-Pay implementation may be customized based on the requirements of a particular billing system, billing entity, and/or participants.

In some embodiments, the payment processing server 100b transmits an authorization request message 125 (e.g., similar message structure may be used for the request message information 115, 166a-b in FIG. 1B, etc.) to the billing agency server(s) 104b. In one implementation, an authorization request message may take a form similar to the following example XML record:

<Autho Request Msg>

<Bill>
<Bill ID> 543210 </Bill ID>
<Bill Issuer ID> 456456 </Bill Issuer ID>
<Bill Name> Cable </Bill Name>
<Bill Amount> 100 </Bill Amount>
</Bill>
<Transaction>
<Transaction ID> 159159 </Transaction ID>
<Transaction Name> Cable Bill </Transaction Name>
</Transaction>
<Destination>
<Destination ID> 10000 </Destination ID>
<Destination Name> Comcast </Destination Name>
</Destination>

<Merchant>

<Merchant ID> 11111 </Merchant ID>
<Merchant Name> CVS </Merchant Name>
<Merchant Location>
<Merchant City> New York City </Merchant City>
<Merchant State> New York </Merchant_ State>
<Merchant Zipcode> 10112 </Merchant_ Zipcode>
<Merchant Fee> 2 </Merchant Fee>
</Merchant>

</Autho Request Msg>

In one embodiment, a billing agency 104 (and/or like entity) may be an account sponsor, in one embodiment an issuing bank with a relationship with a payment processor (e.g., Visa Inc.) and having rights and/or authority to establish card accounts (e.g., Visa accounts) per associated regulations (e.g., Visa Operating Regulations). In some embodiments, such an issuing bank may physically create and/or provide the card for the card accounts. Moreover, in one embodiment, the billing agency 104 may print consumer bills or invoices and may send them to the user(s) 102. In some embodiments, the billing agency 104 includes (e.g., through an issuer processor) a private label account number on the invoice (e.g., a bank card number). In some implementations, a bank card number is the primary account number found on credit cards and prepaid bank cards with other account numbers. Such an account number may have certain internal structure and may share a common format with other account numbers. For example, the account number may be based on a 16 digit format such as a Visa 4 BIN (bank identification number) 16 digit account number. This Visa number is a valid Visa private label account number, starting with a 4, assigned within a Visa BIN range, satisfying mod-lo. Depending on the implementation, the account number may be used for routing the transaction via a bank account number, identifying the payment and ensuring proper account formatting. In some embodiments, online merchants may use issuer identification number lookups to help validate transactions. For example, one implementation may be routing the transaction via the first 6 digits of the account number (also called BIN or issuer identification number), identifying the payment, which corresponds to the middle 9 digits, and ensuring proper account formatting via the last digit.

In one embodiment, the billing agency 104 may act as an issuer, which may be a business entity that issues a consumer device such as a credit or debit card to a consumer. In some embodiments, the issuer may be responsible for the transaction authorization decision. In one embodiment, the billing agency 104 may have a computer and a database associated with the computer. In some embodiments, the computer readable medium may comprise code or instructions for receiving the authorization request messages, and then sending the authorization response messages to the access agency 101.

In one embodiment, the private label account number may be linked to an existing account number of a user 102 at the billing agency 104. Alternatively, in another embodiment, a translation table may be maintained to link the private label account number with the user's actual account number at the billing agency 104. Another implementation may include the user's actual account number on the bill instead of the private label account number. Other types of consumer information that may be included on a bill may include amount due, due date, detailed data about services provided, payment options, and where to pay the bill.

In one embodiment, based on the information embedded in the authorization request message, the payment transaction is validated 130 and the account of the user 102 is updated. Validating may include transmitting the request 155 9 to the user's 102 bank to confirm customer account status and/or account balance, and receiving funds 160b from the payment processor 100 in response to the validation. For example, in one implementation, the user's bank 106 may generate a fund transfer message 160a to the payment processor 100, which may then transfer funds 160b to the billing agency 104. In one implementation, a message associated with the fund may take a form similar to the following example XML record:

<Bank Fund>

<Bank ID>012345 </Bank ID>
<Bank Account>
<Bank Account Number> 5000555000 </Bank Account Number>
<Bank Account Status> Open </Bank Account Status>
<Bank Routing> XYZ123-456789 </Bank Routing>
</Bank Account>
<Bill>
<Bill ID> 543210 </Bill ID>
<Bill Issuer ID> 456456 </Bill Issuer ID>
<Bill Name> Cable </Bill Name>
<Bill Amount> 100 </Bill Amount>
</Bill>
<Fund Amount> 100 </Fund Amount>

</Bank Fund>

In one embodiment, the billing agency server 104b may store the request message 135 (e.g., including the validated information 130, etc.) pertaining to the authorization request in a database 104a. The billing agency 104 delivers an authorization response message 140 to the payment processing server 100b. In one implementation, an authorization response message from the billing agency 104 to the payment processor Dm may take a form similar to the following example XML record:

```
<Autho Response Msg>
          <Bill>
          <Bill ID> 543210 </Bill ID>
          <Bill Issuer ID> 456456 </Bill Issuer ID>
          <Bill Name> Cable </Bill Name>
          <Bill Amount> 100 </Bill Amount>
          </Bill>
          <Bank Account>
          <Bank Account Number> 55555 </Bank Account Number>
          <Bank Account Status> Open </Bank Account Status>
          <Bank Routing> XYZ1928 </Bank Routing>
          </Bank Account>
          <Fund Amount> 100 </Fund Amount>
          <Destination>
          <Destination ID> 90000 </Destination ID>
          <Destination Name> Payment Processor
          </Destination Name>
          </Destination>
          <Merchant>
          <Merchant ID> 11111 </Merchant ID>
          <Merchant Name> CVS </Merchant Name>
          <Merchant Location>
          <Merchant City> New York </Merchant City>
          <Merchant State> New York </Merchant_{—} State>
          <Merchant Zipcode> 10112 </Merchant_{—} Zipcode>
          <Merchant Fee> 2 </Merchant Fee>
          </Merchant>
</Autho Request Msg>
```

In some embodiments, the processing server mob may store the received information pertaining to the authorization response in a database bow. The authorization response message 145 is transmitted to the access agency 101 to complete the processing and issue a bill payment receipt 150 to the user 102. In one implementation, a response message from the payment processor 100 to the access agency 101 may take a form similar to the following example XML record:

```
< Response Msg>
      <Bill>
      <Bill ID> 543210 </Bill ID>
      <Bill Issuer ID> 456456 </Bill Issuer ID>
      <Bill Name> Cable </Bill Name>
      <Bill Amount> 100 </Bill Amount>
      </Bill>
      <Bank Account>
      <Bank Account Number> 5000555000 </Bank Account Number>
      <Bank Account Status> Open </Bank Account Status>
      <Bank Routing> XYZ123-456789 </Bank Routing>
      </Bank Account>
      <Fund Amount> Dm </Fund Amount>
      <Destination>
      <Destination ID> 987654321 </Destination ID>
      <Destination Name> retailer </Destination Name>
      </Destination>
      <Merchant>
      <Merchant ID> 11111 </Merchant ID>
      <Merchant Name> retailer </Merchant Name>
      <Merchant Location>
      <Merchant City> New York City </Merchant City>
      <Merchant State> New York </Merchant_{—} State>
      <Merchant Zipcode> 10112 </Merchant_{—} Zipcode>
      <Merchant Fee> 2 </Merchant Fee>
      </Merchant>
      <Transaction>
      <Transaction ID> 159159 </Transaction ID>
      <Transaction Name> Cable Bill </Transaction Name>
      </Transaction>
</Response Msg>
```

Within implementations, depending on the implementation, the access agency 101 may be a retailer, such as a merchant. In some embodiments, the access agency 101 may utilize point of service terminals at the retail location and other interfacing mechanisms such as a kiosk. Such a mechanism may be a computerized telecommunications device that provides the users or consumers of one or more financial institutions such as the billing agency 104 with access to financial transactions in a public space without the need for a cashier, human clerk or bank teller. In some embodiments, the access agency 101 terminals may be in a variety of locations, such as convenience stores, drug stores and general purpose merchandisers, as well as potentially through kiosks or vending machines at various locations, such as transit stations and other access points.

In one embodiment, the user 102 interacts with the access agency 101 to pay bills. The access agency 101 may be connected to payment processor 100 through a communications network. One embodiment may provide instructions to the user 102 to follow payment instructions for bill payment at the kiosk or point of service terminal at the access agency 101. For example, in one embodiment, if the customer takes the bill to the kiosk, then the customer may initiate the bill payment transaction. If the customer takes the bill to a point of service terminal, then a merchant may initiate the payment transaction.

In some embodiments, the access agency 101 may have an acquirer, e.g., a commercial bank that has a business relationship with the access agency 101. The acquirer may charge the access agency a fee (e.g. a fee per transaction, a periodic fee, a percentage fee, and/or the like). The acquirer collects funds for a bill payment from the merchant.

FIGS. 1D-1F provide block diagrams illustrating examples of Bill-Pay transactions with various commercial issuers and billers within embodiments of the Bill-Pay. For example, FIG. 1D illustrates an example for user load transaction for his toll system account (e.g., E-Z Pass, Smart Tag, etc.). In one implementation, an issuer 175, e.g., a project management company such as, but not limited to the ACS EPPIC platform, etc., may issue prepaid card with an account number linked to a user's toll system account. In one implementation, the user 102 may go to a participating merchant 165, e.g., a kiosk, a convenience store, etc., with the issued prepaid card. The participating merchant 165 may accept funds from the user 102 and initiate a card load by swiping the user's toll system companion card at its POS terminal and selecting “load/reload.”

In one implementation, the acquirer 170 obtaining the toll system load transaction request form the merchant 165, may send a load transaction authorization request to the issuer 175 via the Bill-Pay platform 100, and/or a payment processing network (e.g., VisaNet, etc.). Upon receiving a load transaction request, the issuer (e.g., ACS company, Fuze Network, etc.) may communicate with the toll system processor 180a to determine in real-time whether to approve or decline the load request, e.g., based on the user's account status (expired, active, etc.). For example, the toll system processor 180a may receive a toll system account identifier, based on which the toll system processor 180a may form a query on its repository of user account profiles to retrieve the user toll system account information. In one implementation, the user may set up rules to allow or forbid Bill-Pay load transactions for his toll system account. For example, the user may specify a maximum load amount (e.g., $750.00) per transaction, per day, a maximum frequency of Bill-Pay transactions (e.g., no more than every 12 hours, etc.), and/or the like. In one implementation, the toll system processor may reject a transaction request if the load amount exceeds the user specified maximum load amount.

In one implementation, the toll system may update a user's toll system account 180b to reflect a load of approved funds. The toll system processor may transmit a notification of fund loading to the issuer, which may in turn forward the notice to the merchant 165 via the Bill-Pay platform. In one implementation, the merchant 165 may complete the transaction by generating a receipt to the user 102, who may have immediate access to funds loaded into his toll system account from the issuer approved transaction.

In further implementations, the Bill-Pay may charge different entities for the load transaction as service fee. For example, a reverse interchange of 5 cents may be applied to the acquirer; 2.5 cents per load may be charged by the Bill-Pay platform as processing fee and an additional 2.5 cent authorization access fee. For another example, the fee to be charged may be assessed by the Bill-Pay based on the transaction amount.

FIG. 1E shows an example implementation of paying various utility bills (e.g., TV cables, electricity, gas, etc.) via Bill-Pay. In one implementation, the issuer 175a may bridge with a utility payment network program manager 175b (e.g., the Fuze network, ACS company, etc.), so that the Bill-Pay may facilitate utility bill payment via the project manager's white label, closed network solution to allow the user 102 with a project manager biller account to swipe and pay bill at a Bill-Pay participating merchant location 165 (e.g., a 7/11 store, etc.). In another implementation, the issuer 175a may bridge with direct payment solution (DPS) providers to establish Bill-Pay.

In one implementation, the issuer 175a may obtain a bill payment request, in a similar manner as that of receiving toll system account loading transaction request in FIG. 1C, and may process the payment request by transferring funds from the user's registered bank accounts to the user's project manager account (e.g., Fuze, etc.). For example, the user may provide information of his Fuze account by swiping his Fuze card, which is activated for a specific bill (e.g., a type of electricity, gas, or TV cable bill). The Fuze program manager 175b may then route the payment through bill payment networks 177 to billers 104. For example, various billers 104 may comprise TXU energy, PaylessPower, DirectTV, Verizon, Comcast, and/or the like.

FIG. 1F provides an example implementation of bill payment by cash via various example networks and issuer/payment program managers within implementations of the Bill-Pay. In one implementation, the user may be a cash paying consumer 102 who may possess a Bill-Pay card to load user credentials for Bill-Pay. In one implementation, the cash paying consumer 102 may initiate a transaction request at merchant 165, e.g., a POS based terminal 165a, a dedicated terminal/kiosk/agent based Bill-Pay terminal 165b (e.g., equipped with Bill-Pay barcode reader, etc.), a chit-based agency 165c, and/or the like.

In one implementation, such transaction request may be sent to a Bill-Pay platform 100. For example, messages from the POS terminal may be transmitted to a Visa payment network, and processed by Visa DPS, which in turn forwarded the transaction to a data center (e.g., the Fuze data center, etc.) for biller 104 updates. In this example, the Visa network may act as a program manager 175b may act as a program manager who may maintain biller connectivity and settlement. In a further implementation, the Visa network may recruit and manage users (cardholders).

In another implementation, Bill-Pay transaction requests originated from kiosks 165b, chit-based terminals 165c may be transmitted to a variety of alternative payment processing platforms 133 bridged with Bill-Pay, such as, but not limited to PayNearMe, MoneyGram, WestUnion, Greendot, and/or the like. The payment networks may further forward the transaction to the program manager data center for account updates. In a further implementation, the alternative payment platforms 133 may charge a service fee. For example, such payment service may take $2-$3 per transaction and/or a $6-$8 consumer fee.

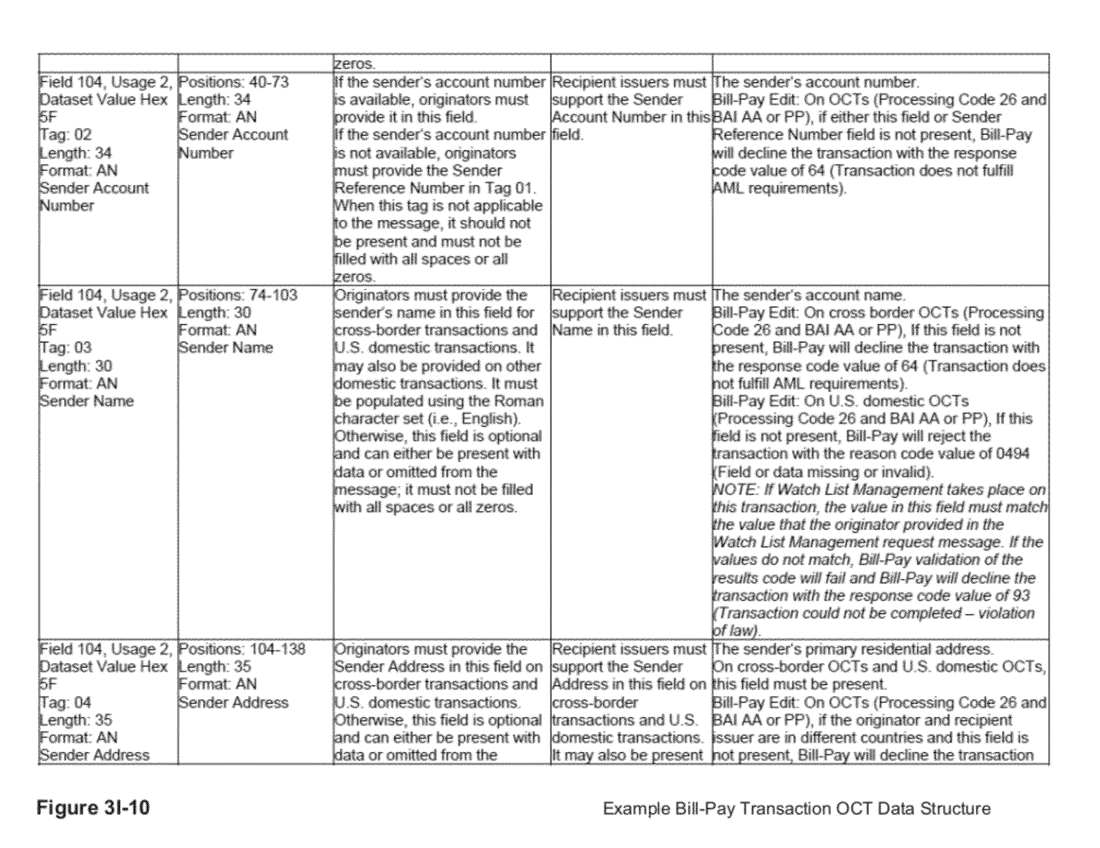

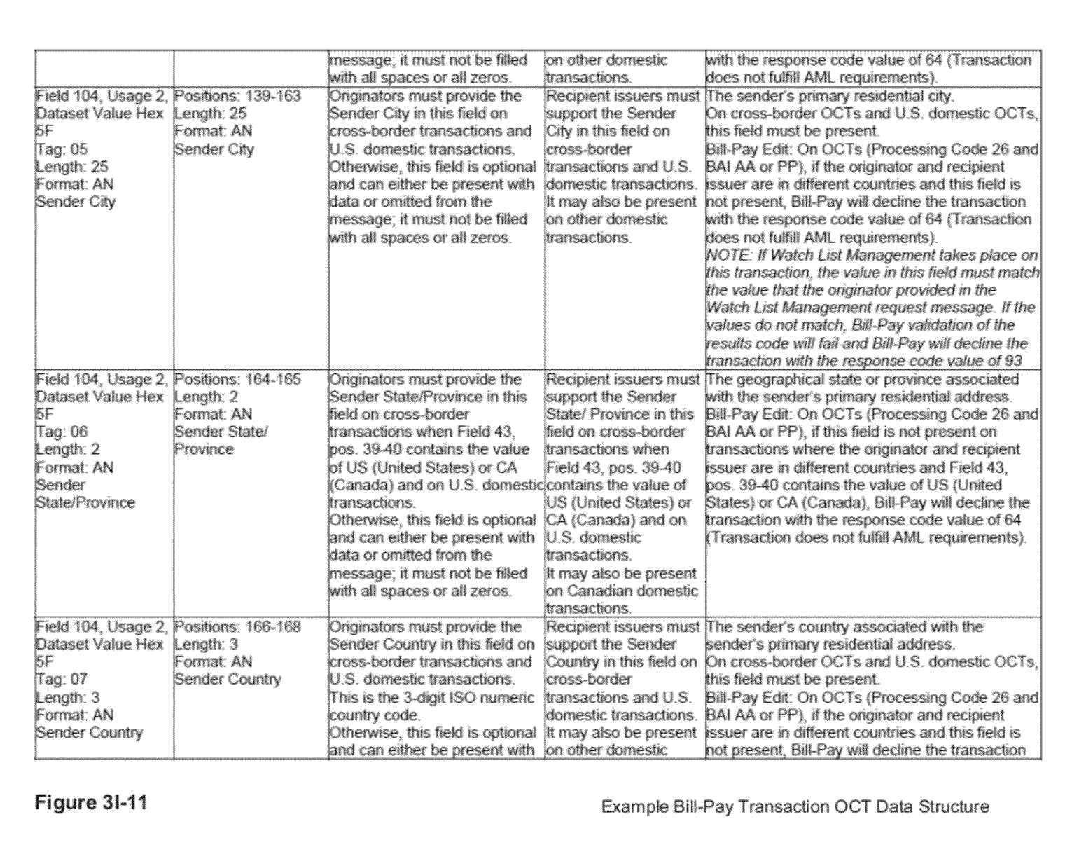

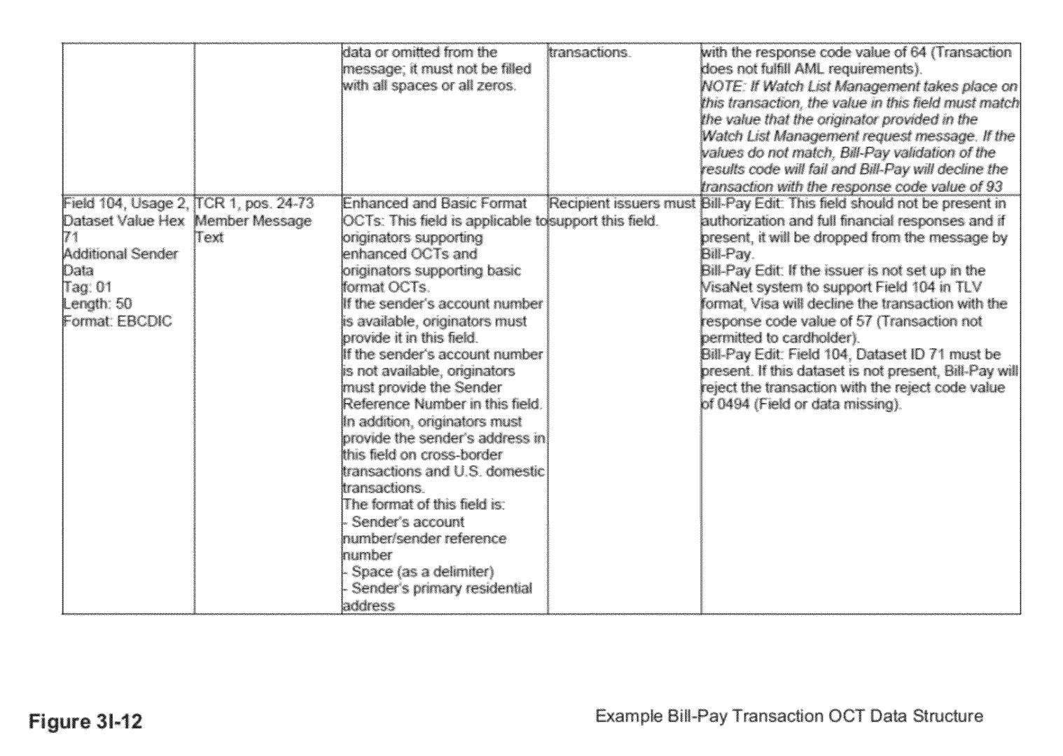

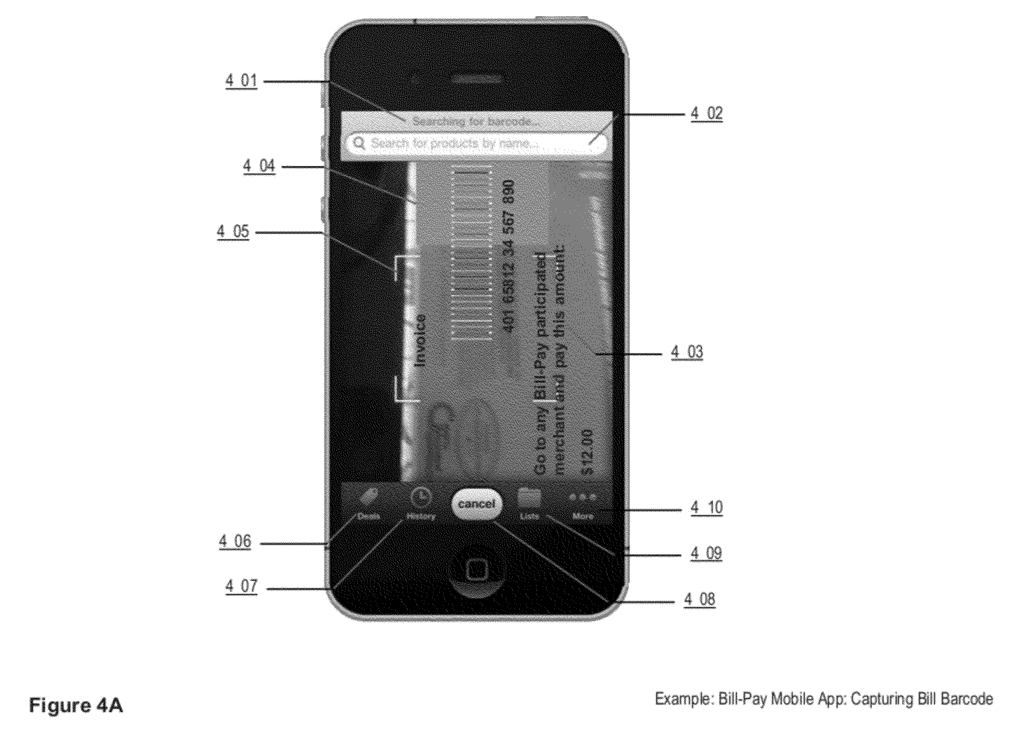

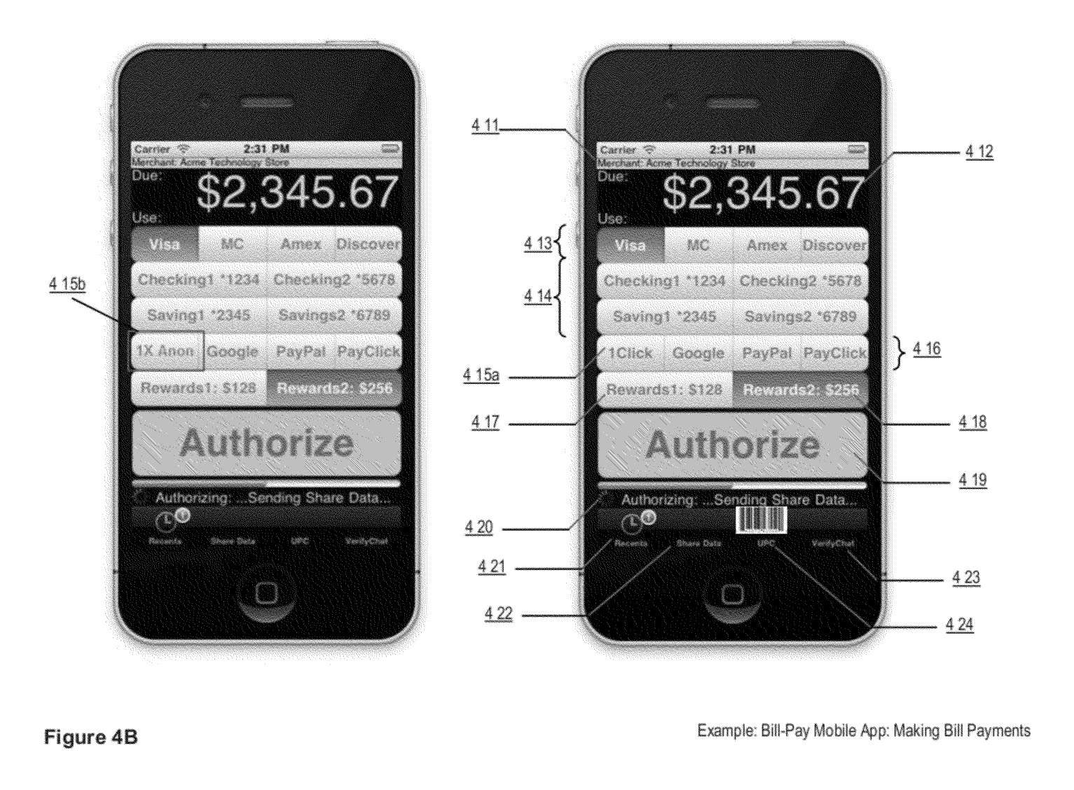

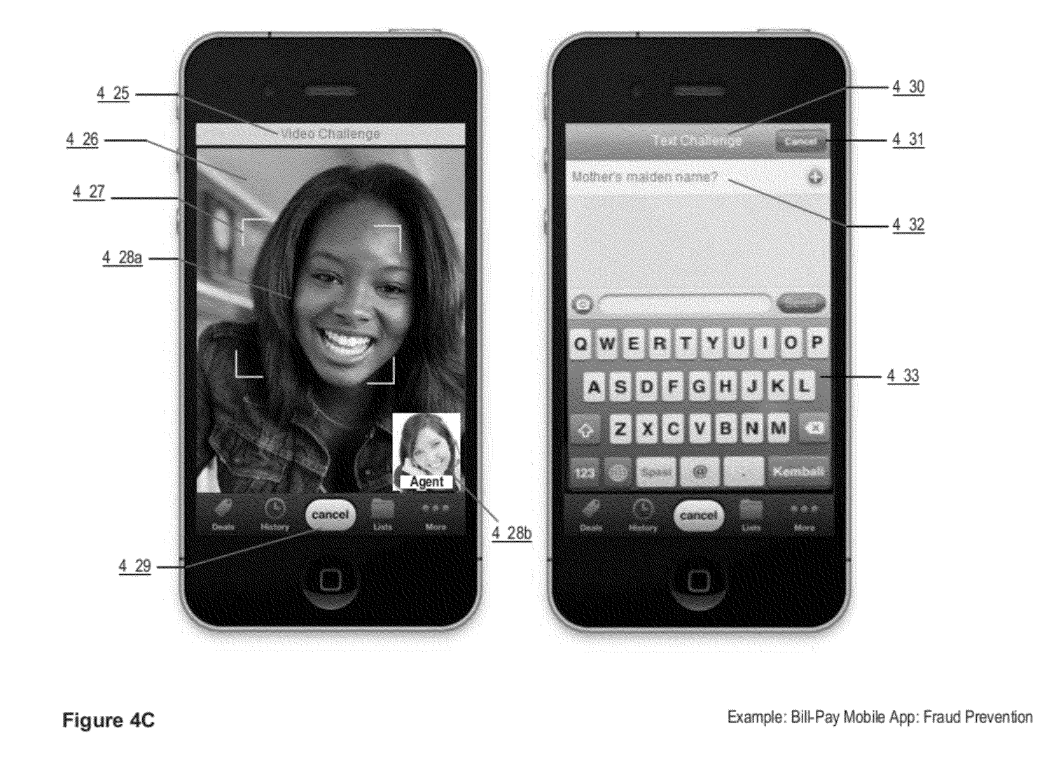

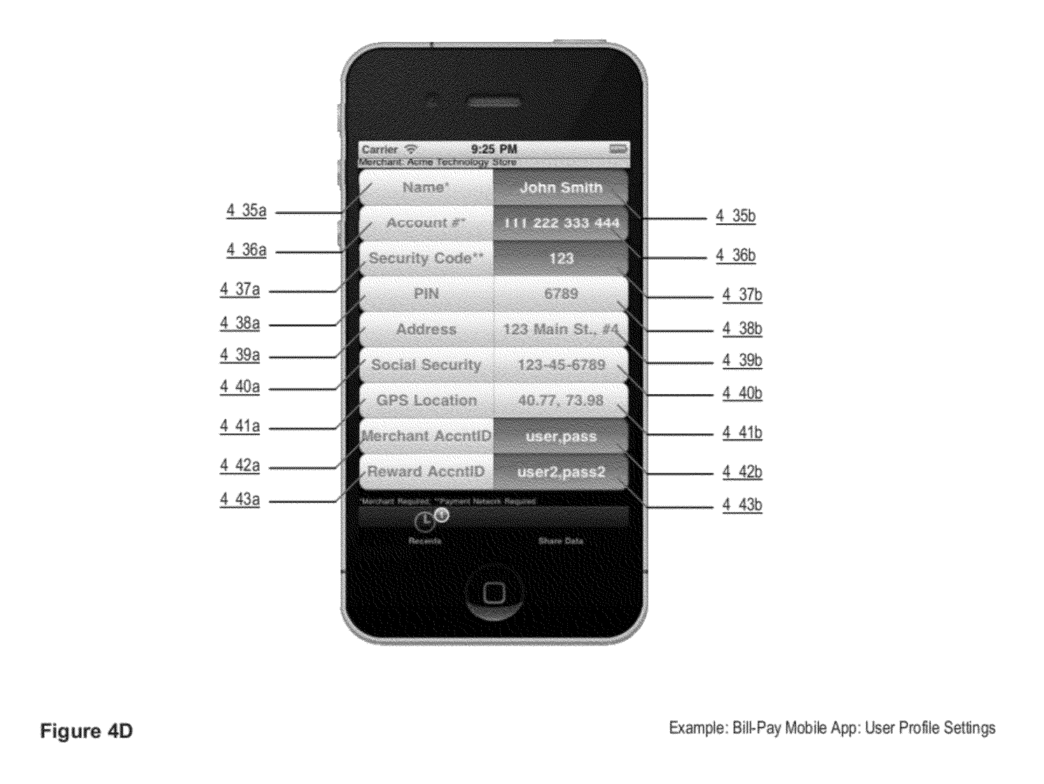

FIGS. 2A-2C provide logic flows illustrating Bill-Pay transaction flow within implementations of the Bill-Pay. In one implementation, the user 102 may submit user information and payment account information 201 to apply for a Bill-Pay vehicle. For example, in one implementation, the Bill-Pay may issue a Visa prepaid card to the user 202. For another example, the issuer 175, e.g., the ACS company as in FIG. 1D, Fuze network 175b as in FIG. 1E, etc., may issue a user card linking to the user's account associated with a biller (e.g., utility billers, etc.). For another example, the issuer 175 may provide mobile applications for the user to download, and use the mobile application as a Bill-Pay vehicle, as further illustrated in FIGS. 4A-4D.

In one implementation, upon user registration, the Bill-Pay may link the created user Bill-Pay vehicle (e.g., the prepaid card, a mobile application, etc.) associated with the user Bill-Pay account with a variety of user bank accounts, and/or user account associated with a biller (e.g., utility billers, toll system account, etc.). For example, the user may provide his bank account number, bank routing number of one or more of his checking account, saving account, credit card account, and/or the like to the Bill-Pay. For another example, the user may provide his user credential (e.g., user name, password, and/or the like) of his toll system login, and/or other utility account to the Bill-Pay. For a further example, the user may provide alternative payment credentials to Bill-Pay, such as PayPal account name, etc. In one implementation, upon receiving user account information, the Bill-Pay may generate an access request to the user's bank account, utility biller account, PayPal account, and/or the like, to add these user payment account to the user's Bill-Pay profile.

For example, an exemplary user Bill-Pay account profile in XML may take a form similar to:

```
<User>
            <UserName>  John Smith </UserName>
            <UserID> JS0000 </UserID>
            <Password> 0000 </Password>
            <PasswordQ>
                  <Question1> Where were you born </Question1>
                  <Answer1> New York </Answer>
                  ...
            </PasswordQ>
            <BillerAccount>
                  <Account1>
                        <AccountName> E-Z Pass </AccountName>
                        <AccountNo> 0000 </AccountNo>
                              ...
                  </Account>
                  ...
            </BillerAccount>
            <PaymentAccount>
                  <Account1>
                        <Type> Checking </Type1>
                        <BankID> BOA0000 </BankID>
                        <RoutingNo> 000000000 </RoutingNo>
                        <AccountNo> 00010001 </AccountNo>
                        ...
                  </Account1>
                  <Account2>
                        <Type> alternative </Type>
                        <Subtype> PayPal </Subtype>
                        <Name> JS@email.com </Name>
                        ...
                  </Account2>
            </BillerAccount>
...
</User>
```

In one implementation, a user may visit a load transaction access agency for bill payment. In one implementation, the access agency may be marked with a brand mark (e.g., a merchant store with a Visa ReadyLink brand mark) at the retail POS indicating that the location can facilitate reloads to eligible Bill-Pay cards. In one implementation, the user may initiate a Bill-Pay transaction 203a by submitting a load transaction request with the access agency 101.

In one implementation, upon loading payment information and verifying the tender amount 203b, the access agency may enter an amount for bill payment, e.g., via an electronic cash register (ECR), and accept card data upon the user swiping a Bill-Pay card through a merchant's stand-alone POS terminal to initiate the bill payment transaction. The Bill-Pay card may comprise a Visa prepaid card. For another example, the Bill-Pay card may comprise issuer issued card linked to the user's account associated with a biller, e.g., a toll system card (as discussed in FIG. 1D), a Fuze card (as discussed in FIG. 1E), and/or the like.

In one implementation, the access agency may generate and transmit a bill payment transaction request 206 (e.g., see at least 166a in FIG. 1B, etc.). For example, the merchant's POS system may format the transaction authorization request with the data required for a VisaNet SMS message and transmit it to the Bill-Pay acquirer 170. In one implementation, upon receiving such transaction request 206, the Bill-Pay acquirer may route the request to Bill-Pay payment processing network (e.g., VisaNet, etc.). Upon receiving the transaction request, the Bill-Pay may determine an appropriate routing to transmit the request to a participating issuer. For example, the Bill-Pay may determine the issuer based on an issuer identifier in the bill information embedded in the transaction request, indicating the issuer is E-Z Pass, Fuze, and/or the like.

In one implementation, upon receiving a transaction request (e.g., see 166b in FIG. 1B, etc.) from the acquirer 208, the issuer may verify the requested transaction and determine whether the transaction request can be approved 214. For example, the issuer may retrieve user specified rules for verification (e.g., the user may have specified a maximum amount for Bill-Pay transaction).

Upon verification, the issuer may send a transaction authorization approval 215 or decline response (e.g., see 169, 173 in FIG. 1B) to the acquirer 215b. In one implementation, the issuer may maintain records of whitelist/blacklist of transaction prototypes to approve/reject a requested transaction. For example, the issuer may not authorize a transaction unless the user has provided the issuer with sufficient information to meet its anti-money laundering obligations under the Bank Secrecy Act. For another example, if the issuer BIN indicated in the transaction has not been set-up as a BIN eligible to participate in a Bill-Pay processing transaction (e.g., Visa ReadyLink, etc.), the Bill-Pay may return a reject response (e.g., see 173 in FIG. 71B) to the acquirer, which may forward the rejection response to the merchant.

In one implementation, upon approval of the transaction, the issuer may process the transaction, and determine whether the user account is open and in good standing, and/or send approved funds to the biller 215a. In one implementation, the Bill-Pay may also checks for any other status indicators and/or velocity parameters. For example, if there are no adverse indicators, the issuer's authorization system may process the bill payment transaction, and the biller 104 may update the user's Bill-Pay account or an account associated with the biller 104 (e.g., E-Z Pass account, Fuze Account, etc.) to reflect the approved fund payment 216. The issuer may further format and return an approval authorization response to the access agency 101.

In one implementation, when the issuer approves the authorization request at 215, the issuer may be obligated to make the approved amount available to the user (when it is a prepaid card load transaction) and/or the biller (when it is a bill payment transaction) regardless of whether the user's funds are actually transmitted to the acquirer. As such, as between the issuer and the user, once the user has tendered funds to the access agency in the amount for which an approval code has been received from or on behalf of the issuer, the risk of loss associated with the failure to deliver the funds to the issuer may fall upon the acquirer. At that point, the acquirer becomes responsible to Bill-Pay for settlement of the authorized load amount. In further implementations, the acquirer 170 in turn may be responsible for ensuring that it has appropriate contractual recourse to the access agency 101. For example, if the user has tendered a bad check or counterfeit currency, the access agency 101 may have recourse against the user, but that risk is allocable between the acquirer 170 and the access agency 101, which may not affect the acquirer's responsibility to Bill-Pay for the settlement of the authorized transaction amount by the issuer 175.

In one implementation, if there are adverse status indicators or the user's Bill-Pay account has exceeded the issuer's policy relative to the number, dollar value or frequency of permitted Bill-Pay transaction, the issuer's system may return a declined authorization response 215b. For example, the issuer may determine the user's account may have expired or be close to expiration. For another example, the issuer may determine the requested transaction has exceeded a maximum amount specified by the user and/or Bill-Pay (e.g., $750), and/or the like.

In one implementation, Bill-Pay may return the response to the acquirer who, in turn, sends the response to the access agency 101, e.g., at 217. Upon receiving the authorization response 217, the POS system at the access agency 101 may generate a receipt that is signed by the user to document the completion of the Bill-Pay transaction. If the transaction is denied by the issuer at 215, the POS system may generate the receipt documenting the decline. For example, the receipt may contain information regarding the name and location of the access agency (e.g., a merchant site), the date, the amount of the transaction and such other information as may be required by applicable law or regulation.

In one implementation, Bill-Pay may settle the transaction between the acquirer 170 and the issuer 175 in a settlement processing cycle. For example, Bill-Pay may automatically settle the transaction, crediting the issuer and debiting the acquirer in the next settlement processing cycle. Thus, issuers may receive settlement of funds for approved transactions during that processing cycle.

In further implementations, the Bill-Pay may collect service fee from the acquirer and issuer 235 for the transaction service. In one implementation, the merchant (access agency) may charge a consumer fee for the Bill-Pay service. In another implementation, interchange reimbursement fee may be charged for each Bill-Pay transaction by the acquirer from the issuer. Such interchange fee may be reversed (e.g., issuer charges the acquirer) upon settlement of a reversal transaction, e.g., when there is a processing problem or error that prevents the issuer's authorization response from being returned to the merchant. In further implementations, the Bill-Pay may charge the acquirer and the issuer for a service fee for every transaction. In further implementations, the Bill-Pay may charge the biller a fee for the Bill-Pay service.

For example, if the user pays a $50 utility bill via Bill-Pay, the access agency may charge $5 for merchant markup/convenience fee from the consumer (which may be refunded by the biller). The Bill-Pay may charge $1.50 from the merchant, $0.20 from the acquirer, $0.10 from the issuer, and/or the like.

FIG. 2B shows a logic flow illustrating example embodiments of transaction request initiation within embodiments of the Bill-Pay. As shown in FIG. 232B, upon user initiating a transaction request 250, the access agency 101 may determine the user vehicle type. For example, the user may present a reloadable visa prepaid card 254 at a participating load location (e.g., a merchant POS terminal) and tell the sales associate the amount to be added to the card. The merchant may then receive user prepaid card information 258, including a user name, account number, bank routing number, issuer information, expiration date, and/or the like. In one implementation, the user 102 may use the prepaid card to pay a bill, and/or add funds to the prepaid card.

In one implementation, the user may provide a billing statement, an invoice, and/or the like to the participating merchant to provide bill information. The access agency may scan a bill barcode at its POS terminal to obtain bill information 260. For example, the POS terminal may be equipped with a barcode reader, such as, but not limited to Unitech All Terminals Ms146i-3ps2g Ms146 Barcode Slot Reader Ps2 Conn Infrared Ip54 Std, Intel IMAGETEAM 3800LR Bar Code Reader, and/or the like. For another example, the access agency 101 may decode a barcode via software such as, but not limited to VisionShape, Barcode Xpress, Softek Software, Data Matrix Reader for Symbian OS, and/or the like to extract information from a barcode image. In another implementation, the billing information may be loaded from the prepaid card. For example, as shown in FIG. 1E, a biller related Bill-Pay card, e.g., issued by Fuze network, may comprise user's utility bill information.

In another implementation, the user may initiate the transaction by submitting electronic billing information and account information via a mobile device 255, with or without walking to a access agency 101 (e.g., a merchant site). For example, a user may receive an electronic bill at his mobile device, and may authorize bill payment via his electronic wallet (e.g., a Visa V-Wallet, etc.). For another example, the user may walk in an access agency and initiate a transaction 262 via NFC payment component (e.g., equipped with radio component, such as NFC-296/896 Antenna Tuning Unit (ATU), and/or the like) at a POS terminal at the access agency. In one implementation, the user may capture an image of the bill 265 and submit the image to an acquirer, as further illustrated in FIGS. 4A-4D.

In a further implementation, other than a “card present” transaction, the access agency may originate a key-entered transaction. For example, the access agency and/or merchant may enter account number, bill code, user name, and/or the like at its ECR while a user Bill-Pay vehicle is optional, e.g., at 268. In one implementation, for key-entered transactions, the issuer may establish verification and authorization policies for the received information from an acquirer. For example, the issuer may verify Field 22 (POS entry mode code) and Field 25 (POS condition code) of a load transaction message to handle the key-entered transaction, in the example transaction message illustrated in Table 1.

In one implementation, the access agency 101 may determine a type of the transaction 270, e.g., a prepaid card load transaction request, a bill payment via the prepaid card, and/or the like. For example, in one implementation, a Visa SMS 0200/0210 request message (e.g., see 166a in FIG. 1B, etc.) may contain a field (e.g., with field number 3) whose field value indicates the transaction type, e.g., the field code 28″ may indicate a prepaid load transaction. In one implementation, when the user needs to load a prepaid card, the user may provide payment of a tendered amount at the participating merchant for bill payment 250. The tendered amount may comprise a variety of forms, such as cash, paper checks, bank notes, credit card, debit cards, and/or the like. For example, the access agency may determine a user payment type based on the amount of the load transaction to be paid by reloadable visa prepaid cardholders at the point of sale. In one implementation, the access agency may determine the type of tender that is acceptable which may comprise cash, money order, check, or payment card, and receive tendered funds from the eligible vehicle 272.

Upon receiving information of the transaction, the access agency may generate a transaction request message 275 (e.g., see 166a in FIG. 1B), comprising information related to the transaction type, user account information, proposed transaction amount, and route the message to an acquirer 206.

FIG. 2C provides a logic flow diagram illustrating Bill-Pay transaction initiation in alternative embodiments of the Bill-Pay. It is to be understood the process illustrated in FIG. 2C is not restrictive and may be customized based on the requirements of various billing systems including, but not limited to, bank account administrators. Once a billing agency sends a bill to a cardholder or account holder, the account holder may decide to pay the bill via the access agency using the payment processor too.

In some embodiments, the account holder may use a point of service terminal or a user interface device, such as a kiosk 219. If the account holder chooses to use a kiosk, the Bill-Pay prompts the account holder to input a request to pay a bill 220a and identify a billing agency 221a. Once the billing agency is identified, the Bill-Pay prompts the account holder to enter the account number, from which the payment is to be made, and payment amount along with any other data necessary to complete the bill payment 222a. The account holder may choose to enter the information manually via a user interface (e.g., touchscreen, keys, keyboard, etc.). Alternatively, the account holder may scan a bar code (and/or like indicia) with the payment account number embedded in it if such an option is supported by the kiosk and the bill. Once the kiosk bill payment procedures are completed, which may include but not limited to cash deposit, the Bill-Pay facilitates the population of the information necessary for an authorization request message, via the account number and the payment amount entered or presented by the account holder 223a.

In one implementation of the Bill-Pay, if the account holder utilizes a point of service terminal to make the bill payment, a merchant may be prompted to input a request to pay a bill of the account holder 220b and identify a billing agency 221b. The merchant submits the account number along with the other data necessary to complete the payment transaction 222b. In some embodiments, information may be entered manually via a physical user interface (e.g., keyboard). For example, the account information may be inserted in the account number field of a user interface (e.g., Visa ReadyLink transaction interface). Alternatively, the merchant may scan a bar code with the payment account number embedded in it if such an option is supported by the point of service terminal and the bill. When the payment procedures are followed for initiating the payment process (e.g., which may include but not limited to cash deposit), one implementation of the Bill-Pay may prompt the merchant to populate an authorization message (e.g., Visa ReadyLink Load (VRL) authorization) using the account number and the payment amount entered or presented by the account holder 223b. In other embodiments of the Bill-Pay, a kiosk or a service terminal option may not be available. The account holder may proceed with the available method of requesting to pay a bill using the payment processor (e.g., mobile device).

In one embodiment, as shown in FIG. 3A, the payment processor may capture the authorization request 330 and transmit it to the billing agency 331. As an alternative, in another embodiment, the authorization request message may be sent to the access agency's acquirer, from which it is sent to the payment processor. In one embodiment, once the authorization request is received at the billing agency, the billing agency (e.g., via an issuer processor) may form a query based on the user credential in the authorization payment request (e.g., the user identifier, etc.) to retrieve the user's account associated with the billing agency. For example, a user may have linked his bank account number with his E-Z Pass account. The billing agency may link the account holder's actual account number to the account number contained in the authorization message 340. Once the actual account number is linked and identified, the bill payment may be validated, including the account status, account number, payment amount, payment due date, etc. 341.

Depending on the implementation, the account holder's account may be updated with the received information 342. For example, such update may reflect receipt of funds. In one embodiment, the billing agency remits funds for the bill payment (e.g., via an issuer processor). The billing agency may transmit an authorization response message (e.g., 140 in FIG. 1C) to payment processor 343. The payment processor clears and settles the bill payment transaction 344. In one embodiment, the transactions may be cleared and settled individually. In another embodiment, the transactions may be batch processed (e.g., periodically and/or with other financial transactions). Once the payment is cleared, the payment processor routes the authorization response message to the access agency 345. Alternatively, the payment processor (e.g., VisaNet®) may route the authorization response message back to the acquirer. In some embodiments, the acquirer routes the authorization response message to the merchant.

The access agency provides the account holder with a receipt for the bill payment 346. In one embodiment, the receipt may be a physical document. In another embodiment, the receipt can be an electronic record, a copy of which may be sent to the user via email or phone. Once the Bill-Pay confirms that the receipt is generated, the process ends 395.

FIGS. 3B-3H provide diagrams illustrating example transaction message flows of a Bill-Pay transaction. For example, in FIG. 3B, an acquirer may send a transaction request 351 in the format of a 0200 request message to the Bill-Pay processing network (e.g., VisaNet), which may process the authorization request and validate the BIN participation in the data message. The SMS transaction request message may comprise fields indicating the user's account number, a processing code, a payment amount, an expiration date of the user's account, a network ID, and/or the like. In one implementation, the issuer may receive such transaction request 352, and upon verification (as discussed at 214-215 in FIG. 2A) and send a SMS transaction authorization message (e.g., a 0210 response message) 353 back to the acquirer. The acquirer may receive the response 354 from the Bill-Pay as completion of the transaction. FIGS. 3C-3H provide different examples of message flows in different message formats (e.g., Visa SMS, Visa InterLink, Visa Base I, II, and/or the like).

FIGS. 4A-D show application user interface diagrams illustrating example features of a mobile app in some embodiments of the Bill-Pay. In some implementations, the app may be configured to recognize bill identifiers (e.g., barcodes, QR codes, etc.). In some implementations, the user may be required to sign in to the app to enable its features. Once enabled, the camera may provide in-person one tap Bill-Pay features for the user (e.g., see application Ser. No. 61/467,890, filed on Mar. 25, 2011, and application Ser. No. 61/467,969, both entitled “In-Person One-Tap Purchasing Apparatuses, Methods and Systems,” which are herein expressly incorporate by reference). For example, the client device may have a camera via which the app may acquire images, video data, streaming live video, and/or the like, e.g., 403. The app may be configured to analyze the incoming data, and search, e.g., 401, for a bill identifier, e.g., 404. In some implementations, the app may overlay cross-hairs, target box, and/or like alignment reference markers, e.g., 405, so that a user may align the bill identifier using the reference markers so facilitate bill identifier recognition and interpretation. In some implementations, the app may include interface elements to allow the user to switch back and forth between the bill identification mode and the bill offer interface display screens (see, e.g., 406), so that a user may accurately study the deals available to the user before capturing a bill identifier. In some implementations, the app may provide the user with the ability to view prior bill identifier captures (see, e.g., 407) so that the user may be able to better decide which bill identifier the user desires to capture. In some implementations, the user may desire to cancel bill payment; the app may provide the user with a user interface element (e.g., 408) to cancel the product identifier recognition procedure and return to the prior interface screen the user was utilizing. In some implementations, the user may be provided with information about the bills, user settings, merchants, offers, etc. in list form (see, e.g., 409) so that the user may better understand the user's purchasing options. Various other features may be provided for in the app (see, e.g., 410).

FIG. 4B shows an example user interface of Bill-Pay mobile application via a user's electronic wallet within implementations of the Bill-Pay. In some implementations, the app executing on the client device of the user may include an app interface providing various features for the user. In some implementations, the app may include an indication of the location (e.g., name of the merchant store, geographical location, information about the aisle within the merchant store, etc.) of the user, e.g., 411. The app may provide an indication of a pay amount due for the purchase of the product, e.g., 412. In some implementations, the app may provide various options for the user to pay the amount for bill payment. For example, the app may utilize the GPS coordinates to determine the merchant store within the user is present, and direct the user to a website of the merchant. In some implementations, the Bill-Pay may provide an API for participating merchants directly to facilitate transaction processing. In some implementations, a merchant-branded Bill-Pay application is developed with the Bill-Pay functionality, which may directly connect the user into the merchant's transaction processing system. For example, the user may choose from a number of cards (e.g., credit cards, debit cards, prepaid cards, etc.) from various card providers, e.g., 413. In some implementations, the app may provide the user the option to pay the purchase amount using funds included in a bank account of the user, e.g., a checking, savings, money market, current account, etc., e.g., 414. In some implementations, the user may have set default options for which card, bank account, etc. to use for the transactions via the app. In some implementations, such setting of default options may allow the user to initiate the transaction via a single click, tap, swipe, and/or other remedial user input action, e.g., 415. In some implementations, when the user utilizes such an option, the app may utilize the default settings of the user to initiate the transaction. In some implementations, the app may allow the user to utilize other accounts (e.g., Google™ Checkout, Paypal™ account, etc.) to pay for the transaction, e.g., 416. In some implementations, the app may allow the user to utilize rewards points, airline miles, hotel points, electronic coupons, printed coupons (e.g., by capturing the printed coupons similar to the product identifier) etc., to pay for the transaction, e.g., 417-418. In some implementations, the app may provide an option to provide express authorization before initiating the transaction, e.g., 1119. In some implementations, the app may provide progress indicator provide indication on the progress of the transaction after the user has selected an option to initiate the transaction, e.g., 420. In some implementations, the app may provide the user with historical information on the user's prior purchases via the app, e.g., 421. In some implementations, the app may provide the user with an option to share information about the purchase (e.g., via email, SMS, wall posting on Facebook®, tweet on Twitter™, etc.) with other users, e.g., 422. In some implementations the app may provide the user an option to display the product identification information captured by the client device (e.g., in order to show a customer service representative at the exit of a store the product information), e.g., 424. In some implementations, the user, app, client device and or Bill-Pay may encounter an error in the processing. In such scenarios, the user may be able to chat with a customer service representative (e.g., VerifyChat 423) to resolve the difficulties in the transaction procedure.

For example, as shown in FIG. 4C, in some implementations, the “VerifyChat” feature may be utilized for fraud prevention. For example, the Bill-Pay may detect an unusual and/or suspicious transaction (e.g., when an issuer determines a frequent attempt for bill payment which exceeds the user's specified maximum amount at 215 in FIG. 2A). The Bill-Pay may utilize the VerifyChat feature to communicate with the user, and verify the authenticity of the originator of the transaction. In various implementations, the Bill-Pay may send electronic mail message, text (SMS) messages, Facebook® messages, Twitter™ tweets, text chat, voice chat, video chat (e.g., Apple FaceTime), and/or the like to communicate with the user. For example, the Bill-Pay may initiate a video challenge for the user, e.g., 425. For example, the user may need to present him/her-self via a video chat, e.g., 426. In some implementations, a customer service representative, e.g., agent 428b, may manually determine the authenticity of the user using the video of the user. In some implementations, the Bill-Pay may utilize face, biometric and/or like recognition (e.g., using pattern classification techniques) to determine the identity of the user, e.g., 428a. In some implementations, the app may provide reference marker (e.g., cross-hairs, target box, etc.), e.g., 427, so that the user may the video to facilitate the Bill-Pay's automated recognition of the user. In some implementations, the user may not have initiated the transaction, e.g., the transaction is fraudulent. In such implementations, the user may cancel, e.g., 429, the challenge. The Bill-Pay may then cancel the transaction, and/or initiate fraud investigation procedures on behalf of the user.

In some implementations, the user may select to conduct the transaction using a one-time anonymized credit card number, e.g., 415b. In such implementations, the app may automatically set the user profile settings such that the any personal identifying information of the user will not be provided to the merchant and/or other entities. In one embodiment, the user may be required to enter a user name and password to enable the one-time anonymization feature.

In some implementations, the Bill-Pay may utilize a text challenge procedure to verify the authenticity of the user, e.g., 430. For example, the Bill-Pay may communicate with the user via text chat, SMS messages, electronic mail, Facebook® messages, Twitter™ tweets, and/or the like. The Bill-Pay may pose a challenge question, e.g., 432, for the user. The app may provide a user input interface element(s) (e.g., virtual keyboard 433) to answer the challenge question posed by the Bill-Pay. In some implementations, the challenge question may randomly selected by the Bill-Pay automatically; in some implementations, a customer service representative may manually communicate with the user. In some implementations, the user may not have initiated the transaction, e.g., the transaction is fraudulent. In such implementations, the user may cancel, e.g., 431, the text challenge. The Bill-Pay may then cancel the transaction, and/or initiate fraud investigation procedures on behalf of the user.

In some implementations, the user may be able to view and/or modify the user profile and/or settings of the user, e.g., by activating user interface element 409 (see FIG. 4A). For example, the user may be able to view/modify a user name (e.g., 435a-b), account number (e.g., 436a-b), user security access code (e.g., 437a-b), user pin (e.g., 438a-b), user address (e.g., 439a-b), social security number associated with the user (e.g., 440a-b), current device GPS location (e.g., 441a-b), user account of the merchant in whose store the user currently is (e.g., 442a-b), the user's rewards accounts (e.g., 443a-b), and/or the like. In some implementations, the user may be able to select which of the data fields and their associated values should be transmitted to facilitate the transaction. For example, in the example illustration in FIG. 4D, the user has selected the name 435a, account number 436a, security code 437a, merchant account ID 442a and rewards account ID 443a as the fields to be sent as part of the notification to process the transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the Bill-Pay with the GPS location of the user. Based on the GPS location of the user, the Bill-Pay may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

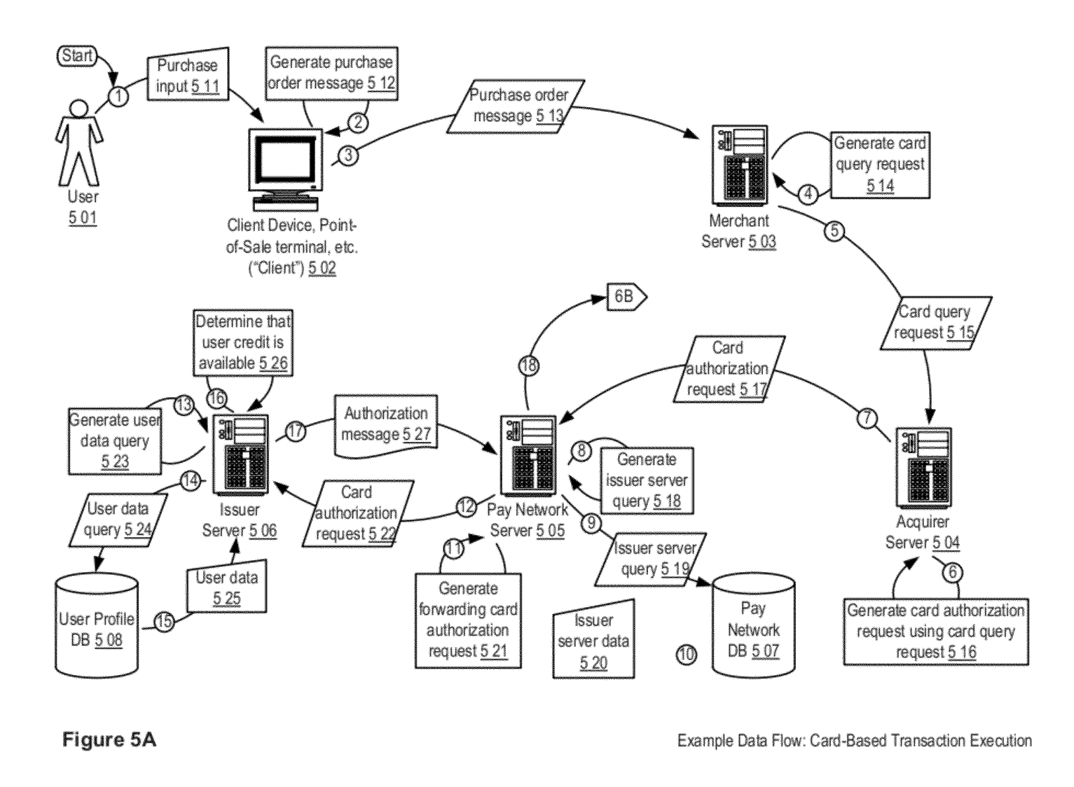

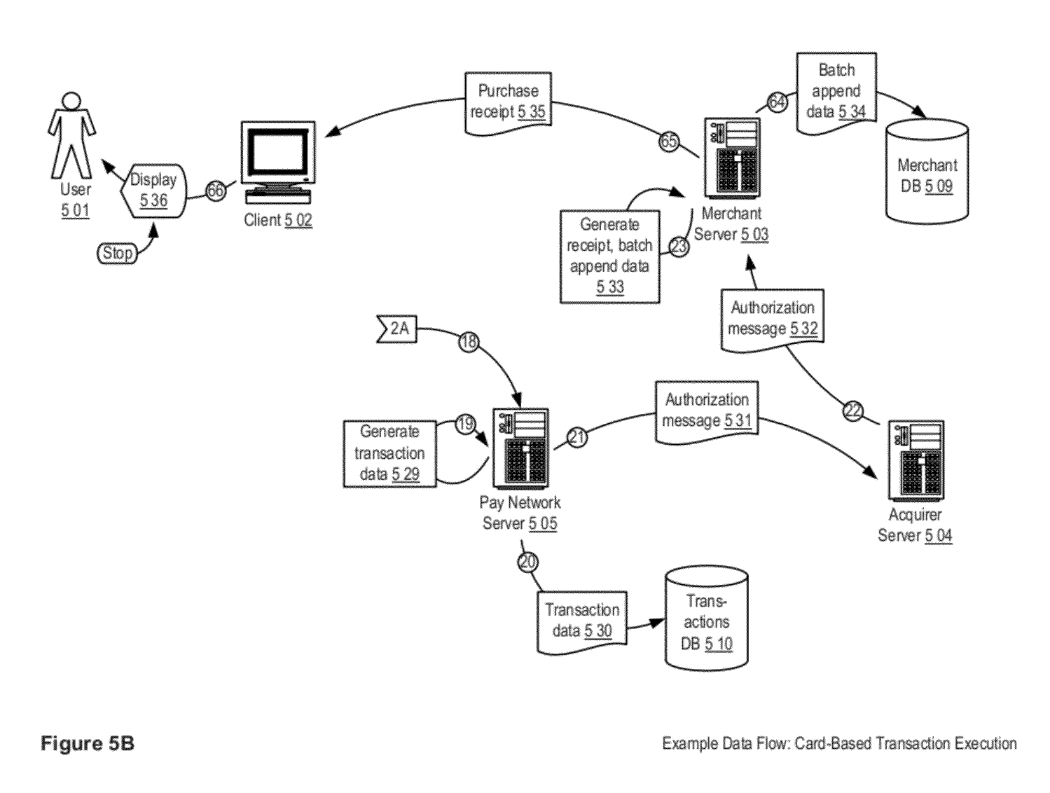

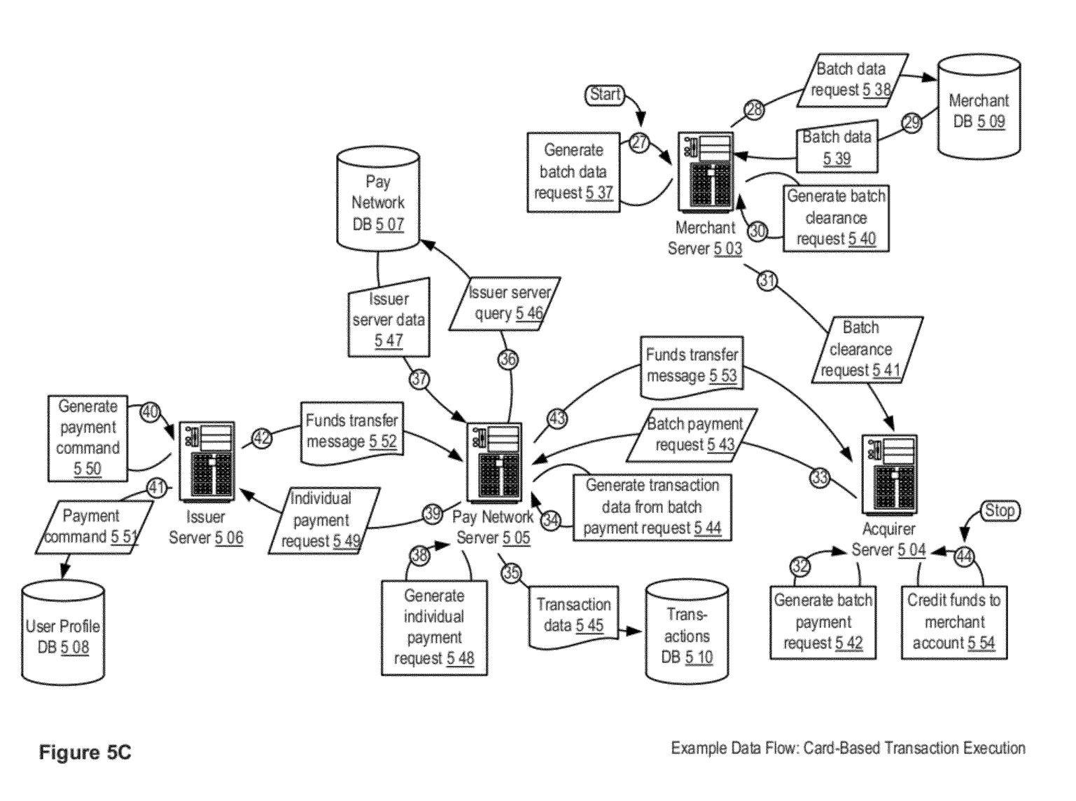

FIGS. 5A-C show data flow diagrams illustrating an example procedure to execute a card-based transaction resulting in raw card-based transaction data in some embodiments of the EISA. In some implementations, a user, e.g., 501, may desire to purchase a product, service, offering, (e.g., bill barcode key-entry payment, mobile bill payment, etc. as discussed in FIGS. 1A-2C) and/or the like (“product”), from a merchant. The user may communicate with a merchant server, e.g., 503, via a client such as, but not limited to: a personal computer, mobile device, television, point-of-sale terminal, and/or the like (e.g., 502). For example, the user may provide user input, e.g., purchase input 511, into the client indicating the user's desire to purchase the product. In various implementations, the user input may include, but not be limited to: keyboard entry, mouse clicks, depressing buttons on a joystick/game console, voice commands, single/multi-touch gestures on a touch-sensitive interface, touching user interface elements on a touch-sensitive display, and/or the like. For example, the user may direct a browser application executing on the client device to a website of the merchant, and may select a product from the website via clicking on a hyperlink presented to the user via the website.

In some implementations, the client may generate a purchase order message, e.g., 512, and provide, e.g., 513, the generated purchase order message to the merchant server. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

```
GET  /purchase.php HTTP/1.1
Host: www.merchant.com
Content-Type: Application/XML
Content-Length: 1306
<?XML version = “1.0” encoding = “UTF-8”?>
<purchase_order>
    <order_ID>4NFU4RG94</order_ID>
    <timestamp>2011-02-22 15:22:43</timestamp>
    <user_ID>john.q.public@gmail.com</user_ID>
    <client_details>
        <client_IP>192.168.23.126</client_IP>
        <client_type>smartphone</client_type>
        <client_model>HTC Hero</client_model>
        <OS>Android 11.2</OS>
        <app_installed_flag>true</app_installed_flag>
    </client_details>
    <purchase_details>
        <num_products>1</num_products>
        <product>
            <product_type>book</product_type>
            <product_params>
                <product_title>XML for dummies</product_title>
                <ISBN>938-2-14-168710-0</ISBN>
                <edition>2nd ed.</edition>
                <cover>hardbound</cover>
                <seller>bestbuybooks</seller>
            </product_params>
            <quantity>1</quantity>
        </product>
    </purchase_details>
    <account_params>
        <account_name>John Q. Public</account_name>
        <account_type>credit</account_type>
        <account_num>123456789012345</account_num>
        <billing_address>123 Green St., Norman, OK
98765</billing_address>
        <phone>123-456-7809</phone>
        <sign>/jqp/</sign>
        <confirm_type>email</confirm_type>
        <contact_info>john.q.public@gmail.com</contact_info>
    </account_params>
    <shipping_info>
        <shipping_adress>same as billing</shipping_address>
        <ship_type>expedited</ship_type>
        <ship_carrier>FedEx</ship_carrier>
        <ship_account>123-45-678</ship_account>
        <tracking_flag>true</tracking_flag>
        <sign_flag>false</sign_flag>
    </shipping_info>
</purchase_order>
```

In some implementations, the merchant server may obtain the purchase order message from the client, and may parse the purchase order message to extract details of the purchase order from the user. The merchant server may generate a card query request, e.g., 514 to determine whether the transaction can be processed. For example, the merchant server may attempt to determine whether the user has sufficient funds to pay for the purchase in a card account provided with the purchase order. The merchant server may provide the generated card query request, e.g., 515, to an acquirer server, e.g., 504. For example, the acquirer server may be a server of an acquirer financial institution (“acquirer”) maintaining an account of the merchant. For example, the proceeds of transactions processed by the merchant may be deposited into an account maintained by the acquirer. In some implementations, the card query request may include details such as, but not limited to: the costs to the user involved in the transaction, card account details of the user, user billing and/or shipping information, and/or the like. For example, the merchant server may provide a HTTP(S) POST message including an XML-formatted card query request similar to the example listing provided below:

```
POST /cardquery.php HTTP/1.1
Host: www.acquirer.com
Content-Type: Application/XML
Content-Length: 624
<?XML version = “1.0” encoding = “UTF-8”?>
<card_query_request>
    <query_ID>VNEI39FK</query_ID>
    <timestamp>2011-02-22 15:22:44</timestamp>
    <purchase_summary>
        <num_products>1</num_products>
        <product>
            <product_summary>Book - XML for
dummies</product_summary>
            <product_quantity>1</product_quantity?
        </product>
    </purchase_summary>
    <transaction_cost>$34.78</transaction_cost>
    <account_params>
        <account_name>John Q. Public</account_name>
        <account_type>credit</account_type>
        <account_num>123456789012345</account_num>
        <billing_address>123 Green St., Norman, OK
98765</billing_address>
        <phone>123-456-7809</phone>
        <sign>/jqp/</sign>
    </account_params>
    <merchant_params>
        <merchant_id>3FBCR4INC</merchant_id>
        <merchant_name>Books & Things, Inc.</merchant_name>
        <merchant_auth_key>1NNF484MCP59CHB27365
        </merchant_auth_key>
    </merchant_params>
</card_query_request>
```

In some implementations, the acquirer server may generate a card authorization request, e.g., 516, using the obtained card query request, and provide the card authorization request, e.g., 517, to a pay network server, e.g., 505. For example, the acquirer server may redirect the HTTP(S) POST message in the example above from the merchant server to the pay network server.

In some implementations, the pay network server may obtain the card authorization request from the acquirer server, and may parse the card authorization request to extract details of the request. For example, the request message may be similar to that of the transaction request message 166b in FIG. 1B. Using the extracted fields and field values, the pay network server may generate a query, e.g., 518, for an issuer server corresponding to the user's card account. For example, the user's card account, the details of which the user may have provided via the client-generated purchase order message, may be linked to an issuer financial institution (“issuer”), such as a banking institution, which issued the card account for the user. An issuer server, e.g., 506, of the issuer may maintain details of the user's card account. In some implementations, a database, e.g., pay network database 507, may store details of the issuer servers and card account numbers associated with the issuer servers. For example, the database may be a relational database responsive to Structured Query Language (“SQL”) commands. The pay network server may execute a hypertext preprocessor (“PHP”) script including SQL commands to query the database for details of the issuer server. An example PHP/SQL command listing, illustrating substantive aspects of querying the database, is provided below:

<?PHP
header(‘Content-Type: text/plain’);
mysql_connect(“254.93.179.112”,$DBserver,$password); // access
database server
mysql_select_db(“ISSUERS.SQL”); // select database table to search
//create query for issuer server data
$query = “SELECT issuer_name issuer_address issuer_id ip_address
mac_address auth_key port_num security_settings_list FROM
IssuerTable WHERE account_num LIKE ‘%’ $accountnum”;
$result = mysql_query($query); // perform the search query
mysql_close(“ISSUERS.SQL”); // close database access
?>

In response to obtaining the issuer server query, e.g., 519, the pay network database may provide, e.g., 52o, the requested issuer server data to the pay network server. In some implementations, the pay network server may utilize the issuer server data to generate a forwarding card authorization request, e.g., 521, to redirect the card authorization request from the acquirer server to the issuer server. The pay network server may provide the card authorization request, e.g., 522, to the issuer server. In some implementations, the issuer server, e.g., 506, may parse the card authorization request, and based on the request details may query a database, e.g., user profile database 508, for data of the user's card account. For example, the issuer server may issue PHP/SQL commands similar to the example provided below:

<?PHP
header(‘Content-Type: text/plain’);
mysql_connect(“254.93.179.112”,$DBserver,$password); // access
database server
mysql_select_db(“USERS.SQL”); // select database table to search
//create query for user data
$query = “SELECT user_id user_name user_balance account_type
FROM UserTable WHERE account_num LIKE ‘%’ $accountnum”;
$result = mysql_query($query); // perform the search query
mysql_close(“USERS.SQL”); // close database access
?>

In some implementations, on obtaining the user data, e.g., 525, the issuer server may determine whether the user can pay for the transaction using funds available in the account, e.g., 526. For example, the issuer server may determine whether the user has a sufficient balance remaining in the account, sufficient credit associated with the account, and/or the like. If the issuer server determines that the user can pay for the transaction using the funds available in the account, the server may provide an authorization message, e.g., 527, to the pay network server. For example, the server may provide a HTTP(S) POST message similar to the examples above.

In some implementations, the pay network server may obtain the authorization message, and parse the message to extract authorization details. Upon determining that the user possesses sufficient funds for the transaction, the pay network server may generate a transaction data record, e.g., 529, from the card authorization request it received, and store, e.g., 530, the details of the transaction and authorization relating to the transaction in a database, e.g., transactions database 510. For example, the pay network server may issue PHP/SQL commands similar to the example listing below to store the transaction data in a database:

<?PHP
header(‘Content-Type: text/plain’);
mysql_connect(″254.92.185.103”,$DBserver,$password); // access
database server
mysql_select(″TRANSACTIONS.SQL″); // select database to append
mysql_query(“INSERT INTO PurchasesTable
(timestamp, purchase_summary_list, num_products,
product_summary, product_quantity, transaction_cost,
account_params_list, account_name, account_type,
account_num, billing_addres, zipcode, phone, sign,
merchant_params_list, merchant_id,
merchant_name, merchant_auth_key)
VALUES (time( ), $purchase_summary_list, $num_products,
$product_summary, $product_quantity, $transaction_cost,
$account_params_list, $account_name, $account_type,
$account_num, $billing_addres, $zipcode, $phone, $sign,
$merchant_params_list, $merchant_id, $merchant_name,
$merchant_auth_key)”); //
add data to table in database
mysql_close(″TRANSACTIONS.SQL″); // close connection to database
?>

In some implementations, the pay network server may forward the authorization message, e.g., 531, to the acquirer server, which may in turn forward the authorization message, e.g., 532, to the merchant server. The merchant may obtain the authorization message, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 533, and store the XML data file, e.g., 534, in a database, e.g., merchant database 509. For example, a batch XML data file may be structured similar to the example XML data structure template provided below:

```
<?XML version = “1.0” encoding = “UTF-8”?>
<merchant_data>
          <merchant_id>3FBCR4INC</merchant_id>
          <merchant_name>Books & Things, Inc.</merchant_name>
          <merchant_auth_key>1NNF484MCP59CHB27365
          </merchant_auth_key>
          <account_number>123456789</account_number>
</merchant_data>
<transaction_data>
          <transaction 1>
                ...
          </transaction 1>
          <transaction 2>
                ...
          </transaction 2>
                .
                .
                .
          <transaction n>
                ...
          </transaction n>
</transaction_data>
```

In some implementations, the server may also generate a purchase receipt, e.g., 533, and provide the purchase receipt to the client. The client may render and display, e.g., 536, the purchase receipt for the user. For example, the client may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIG. 5C, in some implementations, the merchant server may initiate clearance of a batch of authorized transactions. For example, the merchant server may generate a batch data request, e.g., 537, and provide the request, e.g., 538, to a database, e.g., merchant database 509. For example, the merchant server may utilize PHP/SQL commands similar to the examples provided above to query a relational database. In response to the batch data request, the database may provide the requested batch data, e.g., 539. The server may generate a batch clearance request, e.g., 540, using the batch data obtained from the database, and provide, e.g., 541, the batch clearance request to an acquirer server, e.g., 504. For example, the merchant server may provide a HTTP(S) POST message including XML-formatted batch data in the message body for the acquirer server. The acquirer server may generate, e.g., 542, a batch payment request using the obtained batch clearance request, and provide the batch payment request to the pay network server, e.g., 543. The pay network server may parse the batch payment request, and extract the transaction data for each transaction stored in the batch payment request, e.g., 544. The pay network server may store the transaction data, e.g., 545, for each transaction in a database, e.g., transactions database 510. For each extracted transaction, the pay network server may query, e.g., 546, a database, e.g., pay network database 507, for an address of an issuer server. For example, the pay network server may utilize PHP/SQL commands similar to the examples provided above. The pay network server may generate an individual payment request, e.g., 548, for each transaction for which it has extracted transaction data, and provide the individual payment request, e.g., 549, to the issuer server, e.g., 506. For example, the pay network server may provide a HTTP(S) POST request similar to the example below:

```
POST /requestpay.php HTTP/1.1
Host: www.issuer.com
Content-Type: Application/XML
Content-Length: 788
<?XML version = “1.0” encoding = “UTF-8”?>
<pay_request>
    <request_ID>CNI4ICNW2</request_ID>
    <timestamp>2011-02-22 17:00:01</timestamp>
    <pay_amount>$34.78</pay_amount>
    <account_params>
        <account_name>John Q. Public</account_name>
        <account_type>credit</account_type>
        <account_num>123456789012345</account_num>
        <billing_address>123 Green St., Norman, OK
98765</billing_address>
        <phone>123-456-7809</phone>
        <sign>/jqp/</sign>
    </account_params>
    <merchant_params>
        <merchant_id>3FBCR4INC</merchant_id>
        <merchant_name>Books & Things, Inc.</merchant_name>
        <merchant_auth_key>1NNF484MCP59CHB27365
        </merchant_auth_key>
    </merchant_params>
    <purchase_summary>
        <num_products>1</num_products>
        <product>
            <product_summary>Book - XML for
dummies</product_summary>
            <product_quantity>1</product_quantity?
        </product>
    </purchase_summary>
</pay_request>
```

In some implementations, the issuer server may generate a payment command, e.g., 550. For example, the issuer server may issue a command to deduct funds from the user's account (or add a charge to the user's credit card account). The issuer server may issue a payment command, e.g., 551, to a database storing the user's account information, e.g., user profile database 508. The issuer server may provide a funds transfer message, e.g., 552, to the pay network server, which may forward, e.g., 553, the funds transfer message to the acquirer server. An example HTTP(S) POST funds transfer message is provided below:

```
POST  /clearance.php HTTP/1.1
Host: www.acquirer.com
Content-Type: Application/XML
Content-Length: 206
<?XML version = “1.0” encoding = “UTF-8”?>
<deposit_ack>
            <request_ID>CNI4ICNW2</request_ID>
            <clear_flag>true</clear_flag>
            <timestamp>2011-02-22 17:00:02</timestamp>
            <deposit_amount>$34.78</deposit_amount>
</deposit_ack>
```

In some implementations, the acquirer server may parse the funds transfer message, and correlate the transaction (e.g., using the request_ID field in the example above) to the merchant. The acquirer server may then transfer the funds specified in the funds transfer message to an account of the merchant, e.g., 554.

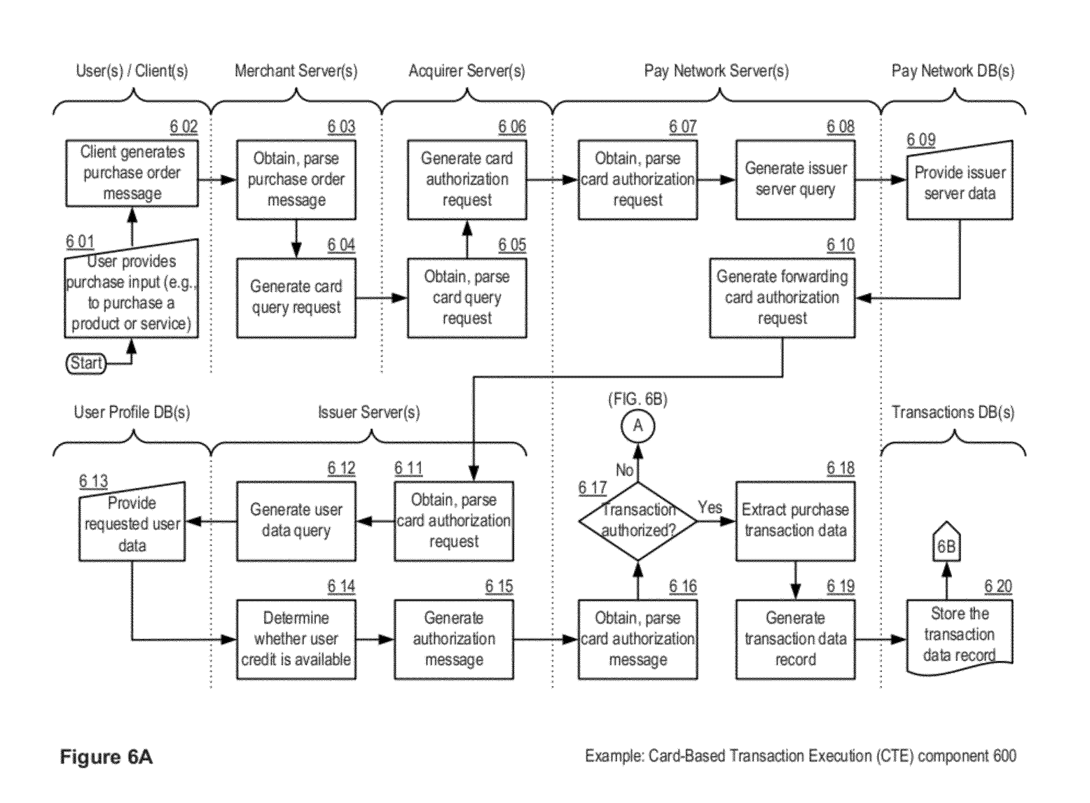

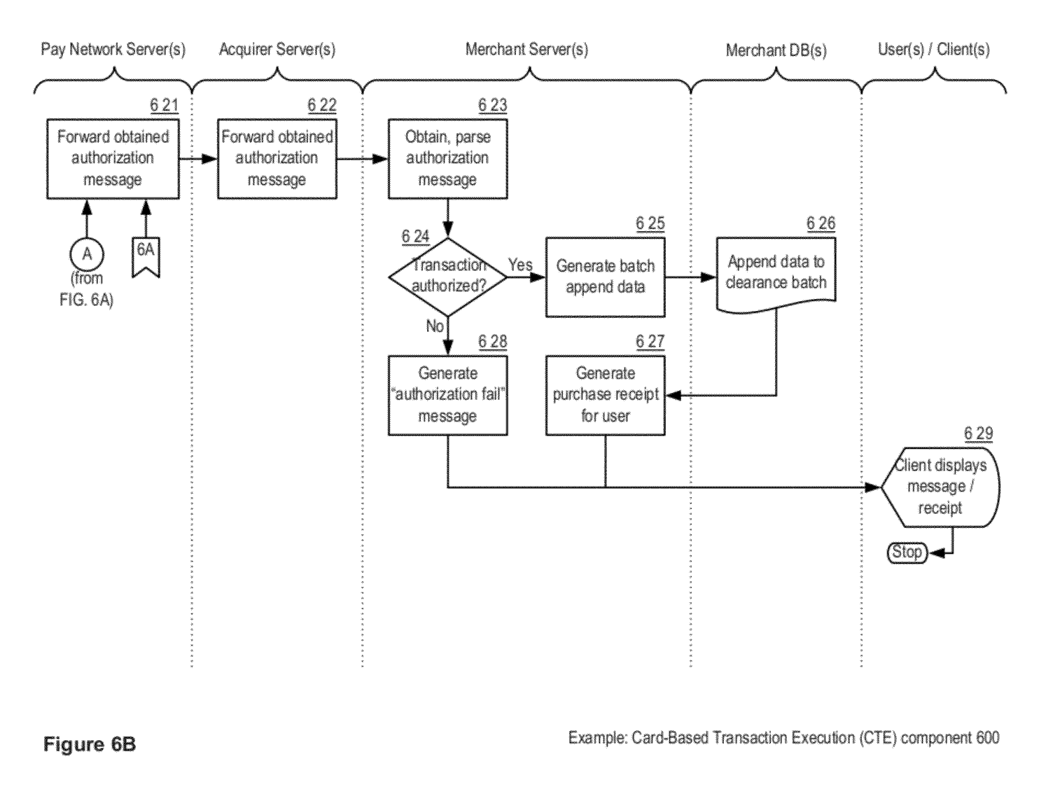

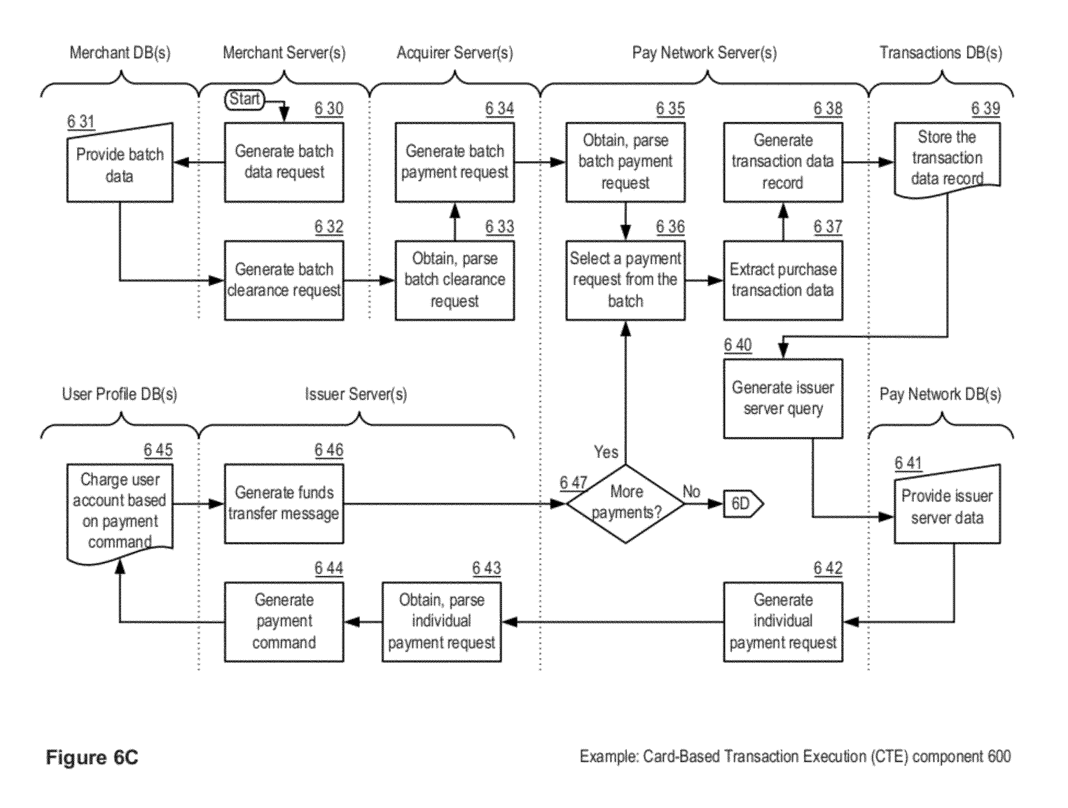

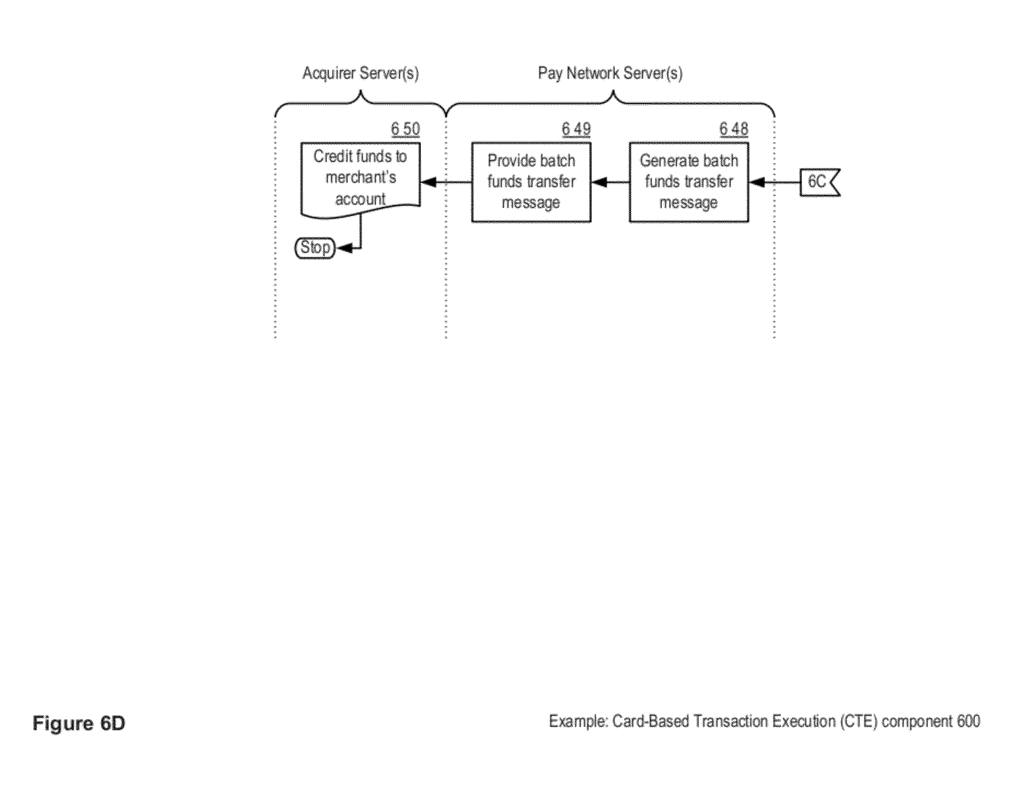

FIGS. 6A-D show logic flow diagrams illustrating example aspects of executing a card-based transaction resulting in generation of raw card-based transaction data in some embodiments of the EISA, e.g., a Card-Based Transaction Execution (“CTE”) component 600. In some implementations, a user may provide user input, e.g., 601, into a client indicating the user's desire to purchase a product from a merchant. The client may generate a purchase order message, e.g., 602, and provide the generated purchase order message to the merchant server. In some implementations, the merchant server may obtain, e.g., 603, the purchase order message from the client, and may parse the purchase order message to extract details of the purchase order from the user. Example parsers that the merchant client may utilize are discussed further below with reference to FIG. 21. The merchant server may generate a card query request, e.g., 604, to determine whether the transaction can be processed. For example, the merchant server may process the transaction only if the user has sufficient funds to pay for the purchase in a card account provided with the purchase order. The merchant server may provide the generated card query request to an acquirer server. The acquirer server may generate a card authorization request, e.g., 606, using the obtained card query request, and provide the card authorization request to a pay network server. In some implementations, the pay network server may obtain the card authorization request from the acquirer server, and may parse the card authorization request to extract details of the request. Using the extracted fields and field values, the pay network server may generate a query, e.g., 608, for an issuer server corresponding to the user's card account. In response to obtaining the issuer server query the pay network database may provide, e.g., 609, the requested issuer server data to the pay network server. In some implementations, the pay network server may utilize the issuer server data to generate a forwarding card authorization request, e.g., 610, to redirect the card authorization request from the acquirer server to the issuer server. The pay network server may provide the card authorization request to the issuer server. In some implementations, the issuer server may parse, e.g., 611, the card authorization request, and based on the request details may query a database, e.g., 612, for data of the user's card account. In response, the database may provide the requested user data. On obtaining the user data, the issuer server may determine whether the user can pay for the transaction using funds available in the account, e.g., 614. For example, the issuer server may determine whether the user has a sufficient balance remaining in the account, sufficient credit associated with the account, and/or the like, but comparing the data from the database with the transaction cost obtained from the card authorization request. If the issuer server determines that the user can pay for the transaction using the funds available in the account, the server may provide an authorization message, e.g., 615, to the pay network server.

In some implementations, the pay network server may obtain the authorization message, and parse the message to extract authorization details. Upon determining that the user possesses sufficient funds for the transaction (e.g., 617, option “Yes”), the pay network server may extract the transaction card from the authorization message and/or card authorization request, e.g., 618, and generate a transaction data record, e.g., 619, using the card transaction details. In one implementation, the transaction data record (e.g., 123 in FIG. 1) may comprise an entry of authorized transaction of the original price (e.g., 238 in FIG. 2), and an entry of affiliate payment and/or incentive rewards (e.g., 250, 255 in FIG. 2). The pay network server may provide the transaction data record for storage, e.g., 62o, to a database. In some implementations, the pay network server may forward the authorization message, e.g., 621, to the acquirer server, which may in turn forward the authorization message, e.g., 622, to the merchant server. The merchant may obtain the authorization message, and parse the authorization message o extract its contents, e.g., 623. The merchant server may determine whether the user possesses sufficient funds in the card account to conduct the transaction. If the merchant server determines that the user possess sufficient funds, e.g., 624, option “Yes,” the merchant server may add the record of the transaction for the user to a batch of transaction data relating to authorized transactions, e.g., 625. The merchant server may also generate a purchase receipt, e.g., 627, for the user. For example, the receipt may comprise information as to the date and time of the transaction, the merchant ID and location, user payment amount, etc., as the receipt 171 in FIG. 1B. If the merchant server determines that the user does not possess sufficient funds, e.g., 624, option “No,” the merchant server may generate an “authorization fail” message, e.g., 628. The merchant server may provide the purchase receipt or the “authorization fail” message to the client. The client may render and display, e.g., 629, the purchase receipt for the user.

In some implementations, the merchant server may initiate clearance of a batch of authorized transactions by generating a batch data request, e.g., 630, and providing the request to a database. In response to the batch data request, the database may provide the requested batch data, e.g., 631, to the merchant server. The server may generate a batch clearance request, e.g., 632, using the batch data obtained from the database, and provide the batch clearance request to an acquirer server. The acquirer server may generate, e.g., 634, a batch payment request using the obtained batch clearance request, and provide the batch payment request to a pay network server. The pay network server may parse, e.g., 635, the batch payment request, select a transaction stored within the batch data, e.g., 636, and extract the transaction data for the transaction stored in the batch payment request, e.g., 637. The pay network server may generate a transaction data record, e.g., 638, and store the transaction data, e.g., 639, the transaction in a database. For the extracted transaction, the pay network server may generate an issuer server query, e.g., 640, for an address of an issuer server maintaining the account of the user requesting the transaction. The pay network server may provide the query to a database. In response, the database may provide the issuer server data requested by the pay network server, e.g., 641. The pay network server may generate an individual payment request, e.g., 642, for the transaction for which it has extracted transaction data, and provide the individual payment request to the issuer server using the issuer server data from the database.

In some implementations, the issuer server may obtain the individual payment request, and parse, e.g., 643, the individual payment request to extract details of the request. Based on the extracted data, the issuer server may generate a payment command, e.g., 644. For example, the issuer server may issue a command to deduct funds from the user's account (or add a charge to the user's credit card account). The issuer server may issue a payment command, e.g., 645, to a database storing the user's account information. In response, the database may update a data record corresponding to the user's account to reflect the debit/charge made to the user's account. The issuer server may provide a funds transfer message, e.g., 646, to the pay network server after the payment command has been executed by the database.

In some implementations, the pay network server may check whether there are additional transactions in the batch that need to be cleared and funded. If there are additional transactions, e.g., 647, option “Yes,” the pay network server may process each transaction according to the procedure described above. The pay network server may generate, e.g., 648, an aggregated funds transfer message reflecting transfer of all transactions in the batch, and provide, e.g., 649, the funds transfer message to the acquirer server. The acquirer server may, in response, transfer the funds specified in the funds transfer message to an account of the merchant, e.g., 650.

### Embodiments of Bill-Pay: Healthcare Bill Payment

FIGS. 7-11 describe embodiments of Bill-Pay in its application in healthcare bill payment. Within embodiments, the Bill-Pay may provide a healthcare payment platform which facilitates healthcare payment from a user selected qualified healthcare payment account in real-time (e.g., see application Ser. No. 61/449,224, filed Mar. 4, 2011, entitled “Apparatuses, Methods and Systems for A Mobile Healthcare Payment Platform,” which is herein expressly incorporated by reference).

In one embodiment, a user may operate a mobile device (e.g., a smart phone, etc.) for checkout at a healthcare service provider, wherein the mobile computing device is web enabled, and may receive a communication from a point of service terminal (POS). The communication may include a balance due bill of a healthcare provider for healthcare to a user. The web enabled mobile computing device may execute an application that derives an optimized payment of the balance due bill that substantially maximizes incentives and minimize penalties in paying the healthcare provider for the healthcare provided to the user. The optimized payment is transmitted from the web enabled mobile computing device to the POS for further authorization processing of one or more currency amounts to be paid from respective accounts to satisfy the balance due bill.

In one implementation, the Bill-Pay may access and retrieve information from one or more online databases. Some databases contain a rule for a payment made towards the balance due bill for the healthcare provided by the healthcare worker to the user. By way of example, and not by way of limitation, a database can contain a negative wealth impacting (e.g., deduction, liability, insurance, debt, tax, negative interests, and/or other wealth reducing factor) rule pertaining to payment to the healthcare provider for the healthcare to the user. Another database can contains an insurance rule pertaining to payment for the healthcare to the user. Other online databases accessible by the Bill-Pay to retrieve information can contain data specific to the user and an insured entity financially responsible for the user, as well as currency balances in each of one or more accounts respectively issued by an issuer.

In one implementation, the information retrieved by the Bill-Pay from the online databases is processed by an optimization algorithm that operates on the rules in the retrieved information. The Bill-Pay may derive a recommendation that includes a currency payment amount to pay against the balance due bill respectively from each said currency balance of the one or more accounts issued by respective issuers. The recommendation is rendered on the web enabled mobile computing device for approval by the user. If the recommendation is approved, the enabled mobile computing device transmits the recommendation to the POS. In one implementation, the POS may transmit the recommendation for authorization processing of each currency payment amount to pay against the balance due bill respectively from each currency balance of each account as provided by the recommendation. In a further implementation, the Bill-Pay may substantially maximize pre-negative wealth impactor currency payments pay against the balance due bill, as well as substantially minimize out-of-pocket payments pay against the balance due bill.

In one implementation, a user may download and install a Bill-Pay mobile application on a smart phone (e.g., an Apple iPhone, etc.) or other portable web-enabled computing device. The mobile application may be used by a user who is presented with a request to pay for healthcare service charges. When so used by the user, the mobile application makes a recommendation of which the user's account to offers the greatest advantage to the user when used to pay for healthcare service charges. The mobile application provides a real time decision tool for the user to choose one or more healthcare accounts from which to withdraw currency or other funds in order to pay for a healthcare service. To assist the user in making the right choice, the mobile application is programmed to access local negative wealth impactor and regulatory business rules for healthcare services. The mobile application is programmed to access: (i) user-specific data and (ii) balances held by the user in multiple payment accounts issued to the user who is financially responsible for the healthcare service charges. The mobile application is further programmed to apply the negative wealth impactor and regulatory business rules to the online data (i.e., user-specific data and balances) in order to make a recommendation to the user as to which of the user's payment accounts be use in paying for the healthcare service charges. The user can adopt, or over ride, the mobile application's recommendations. Thereafter, the user's smart phone can then be used at a healthcare service providers POS to make contactless payments from each of the user's account as were recommended by the mobile application.

The mobile application can have online access to various information for processing against the negative wealth impactor and regulatory business rules. For instance, local negative wealth impacting rules may provide various incentives and penalties as are applicable to: (a) a Flexible Savings Account (FSA); (b) a Health Savings Account (HSA); (c) Government Insurance (e.g.; Medicare); (d) Private Insurance; (e) Other Negative wealth impactor Favored Payment Accounts (e.g.; employee benefits plans); (f) Income negative wealth impactor deduction rules; (g) etc.

The mobile application can have online access to various information for processing against insurance payment coverage rules. For instance, insurance payment coverage rules may provide various incentives and penalties as are applicable to: (a) a portion of the healthcare provided by the healthcare provider to the user that are and are not covered and thus will and will not be paid for via insurance coverage; (b) specific spending limit rules for the healthcare provider and health provided by same; (c) annual and life-time limits for spending: (i) by-the person; and (ii) by-the insurance policy; (d) limitations on the type and quantity of healthcare goods and/or services type, including but not limited to: (i) pharmacy; (ii) vision; (iii) dental, (iv) psychological; (v) substance abuse rehabilitation; (vi) etc.; (e) limitation on payments payment to a certain type of merchant, including but not limited to: (i) ‘big-box’ retailer; (ii) pharmacy retailer; (iii) physician sale of goods and services; (iv) etc.; (f) co-payments by insurance vehicle type; (g) etc.

The mobile application can have online access to currency balances available for use, and respective calendar dates of availability, to pay the balance due bill for the healthcare provided by the healthcare provider. For instance, these accounts can include: (a) a Flexible Savings Account (FSA), where data retrieved can include a current currency balance, a date by which all funds in FSA must be spent; (b) a Health Savings Account (HSA), where data retrieved can include a liquid asset balance and a non-liquid asset balance (e.g.; stocks, mutual funds, Certificates of Deposit, etc.), and an amount charged for a commission to trade an illiquid asset for a liquid asset that can be used to pay the balance due bill from the healthcare provider; (c) a remaining negative wealth impactor deductible contribution amount to a healthcare-relates account amount for a specific negative wealth impactor year; (d) a government insurance prepaid account; (e) a private insurance deductible information; (e) other negative wealth impactor favored payment accounts (e.g.; employee benefits plans); (f) non-negative wealth impactor favored payment accounts (e.g.; credit, debit, prepaid accounts) including information for these accounts such as loyalty points and awards having currency equivalents that can be made available for payment against the balance due bill and award thresholds for such loyalty points and awards. The mobile application can also have online access to a prediction as to the likely income and local negative wealth impactor bracket of the user for negative wealth impactor year in which the healthcare provider's balance billing is due.

In still another implementation, a healthcare provider provides healthcare to a user. One or more insurance carriers are queried by the healthcare provider to obtain payment for the healthcare provided by the healthcare provider to the user. When the insurance carriers have not paid, or are unlikely to pay, for the healthcare, then the healthcare provider calculates a balance due bill for which the user is financially responsible. A Point of Service terminal (POS) transmits the balance due bill to the user's smart phone. The smart phone executes a mobile application to perform real time online access to various databases. This real time access obtains business rules and user data sufficient for the mobile application to derive a recommendation as to which the user's accounts will provide the greatest advantage to the user when used to pay for healthcare service charges, both goods and services, of the balance due bill. The user's smart phone can then send a transmission to the healthcare provider's POS as a contactless payment from each of the user's recommended accounts. For each account in the recommendation: (i) the healthcare provider's POS sends the user's proposed payment amount to an acquirer for the healthcare provider; (ii) the acquirer sends an authorization request for the amount to a transaction handler (i.e., VisaNet) who sends the authorization request to the corresponding issuer of the user's account. Note that, in addition to the VisaNet network provided by Visa Inc., other networks (Discover and American Express) can be used to accept healthcare service payment transactions. Moreover, other payment options can also be made, such as ACH or online bill pay, each of which could be facilitated by either the foregoing implementations or by being routed to another payment portal; and (iii) the issuer sends an authorization response back to the transaction handler who sends the authorization response back to the healthcare provider's acquirer. Assuming that the healthcare provider's payment is authorized by the issuer, the smart phone receives an electronic acknowledgement of payment from each of the issuers 8 for each of the accounts. Clearing and settlement will then follow for each account selected by the user to pay the healthcare provider.

In the foregoing implementation, the derivation of the recommendation can rely on an application of mathematical (quantitative) techniques to make a healthcare payment decision recommendation. To do so, the user's negative wealth impactor and insurance penalties and incentives are defined and modeled as a set of mathematical equations. Data that is also made available for the derivation are currency balances, and dates as to availability of same, in one or more accounts to which the user has access for payment of the balance due bill. The equations are subjected to computer analysis to yield an optimized solution as to those user's accounts that will provide the greatest advantage to the user when used to pay for healthcare service charges, both goods and services, as defined in the balance due bill from the healthcare provider. Optimizing the solution may requires one or more iterations to test against various circumstances and situations until the optimized solution is found for making the recommendation. The set of mathematical equations can apply any of several different approaches, including but not limited to dynamic and linear programming, as well as forecasting and simulation techniques such as the Monte Carlo method.

FIG. 7 shows a block diagram illustrating data flows between Bill-Pay server and affiliated entities within various embodiments of the Bill-Pay. Within various embodiments, one or more user(s) 702, Bill-Pay server 720, Bill-Pay database(s) 719, healthcare provider(s) 110, healthcare financial account(s) 730, and insurance provider(s) 750 are shown to interact via various communication networks 713.

Within various embodiments, the user 702 may include a wide variety of different communications devices and technologies within embodiments of Bill-Pay operation. For example, in one embodiment, the users 702 may include, but are not limited to, terminal computers, work stations, servers, cellular telephony handsets, smart phones, PDAs, and/or the like. In one embodiment, the Bill-Pay server 720 may be equipped at a terminal computer of the user 702. In another embodiment, the Bill-Pay server 720 may be a remote server which is accessed by the user 702 via a communication network 713, such as, but not limited to local area network (LAN), in-house intranet, the Internet, and/or the like. In a further implementation, the Bill-Pay merchant 716 may be integrated with a user 702 at a computer terminal.

In one embodiment, after receiving medical treatment and/or service at a healthcare provider 710, the user 702 may receive medical bills 715 from the healthcare provider 710. The medical bills 715 for the user may be generated by the healthcare provider 710, wherein the healthcare provider may send an original healthcare bill 750 to a Bill-Pay server 120 for processing. In one implementation, the Bill-Pay server 720 may communicate with an insurance provider 750 for medical claims 733, e.g., an insurance plan covered portion, etc. In an alternative implementation, the Insurance provider 750 may directly communicate with the healthcare provider 710 for medical claims 733. For example, the insurance provider 750 may provide payment of an insured amount 717.

In one implementation, the Bill-Pay server may retrieve financial data 734 from a Healthcare financial account 730, and provide a list of available medical accounts 733 to the user to proceed with payments. The user 702 may submit a selection of the medical accounts 707, for user payments. The Bill-Pay server may then obtain financial data 734 from the healthcare financial accounts 730 to furnish the uninsured portion of the medical bill.

In one implementation, the Bill-Pay server 720 may also communicate with a Bill-Pay database 719 to store and/or retrieve healthcare payment/claim record In some embodiments, a Bill-Pay server 720 may be integrated with a local Bill-Pay database 719. In other embodiments, a Bill-Pay server 720 may access a remote Bill-Pay database 719 via the communication network 713. The Bill-Pay server 720 may send the information to the database 719 for storage, such as, but not limited to user account information, order record information 725, payment record information 723, and/or the like, as further illustrated at 1119 in FIG. 12.

In one embodiment, the Bill-Pay server 720 may establish data records of registered users, healthcare providers, insurance providers, past transactions 723 for storage in a database 719. For example, an exemplar XML code of a user record may take a form similar to the following:

```
<User>
          <UserID>
          123456789
          </UserID>
          <UserName>
          John Smith
          </UserName>
          </UserAddress>
          111 White road
          </UserAddress>
          <UserPhoneNumber>
                  000-000-2222
          </UserPhoneNumber>
          ...
          </UserDeviceID>
          11111111
          </UserDeviceID>
          <UserLicenseInfo>
                              .....
          </UserLicenseInfo>
          <UserEmail>
          jsmith@email.com
          </UserEmail>
          <UserInsurance>
                  <InsurnaceID>
                        66666
                  </InsurnaceID>
                  <InsuranceName>
                        all dental plan
                  </InsurnaceName>
                  ...
          </UserInsurance>
          <UserAccount>
                  <Account1>
                        <AccountID>
                                00023213
                        </AccountID>
                        <AccountName>
                                Employee FSA
                        </AccountName>
                        <AccountNumber>
                                ...
                        </AccountNumber>
                        <AccountMax>
                                2000.00
                        </AccountMax>
                        ...
                  </Account1>
          ...
</User>
```

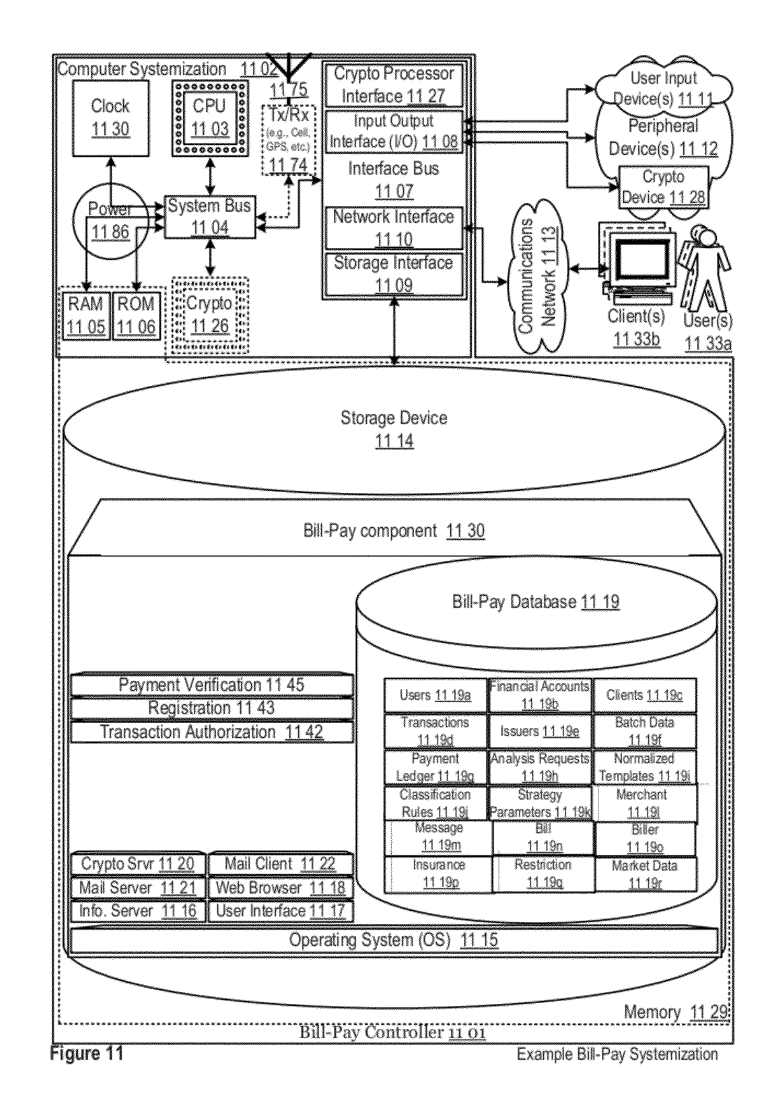

Further implementations of the database are discussed in FIG. 11 (e.g., 1119a-1119r).

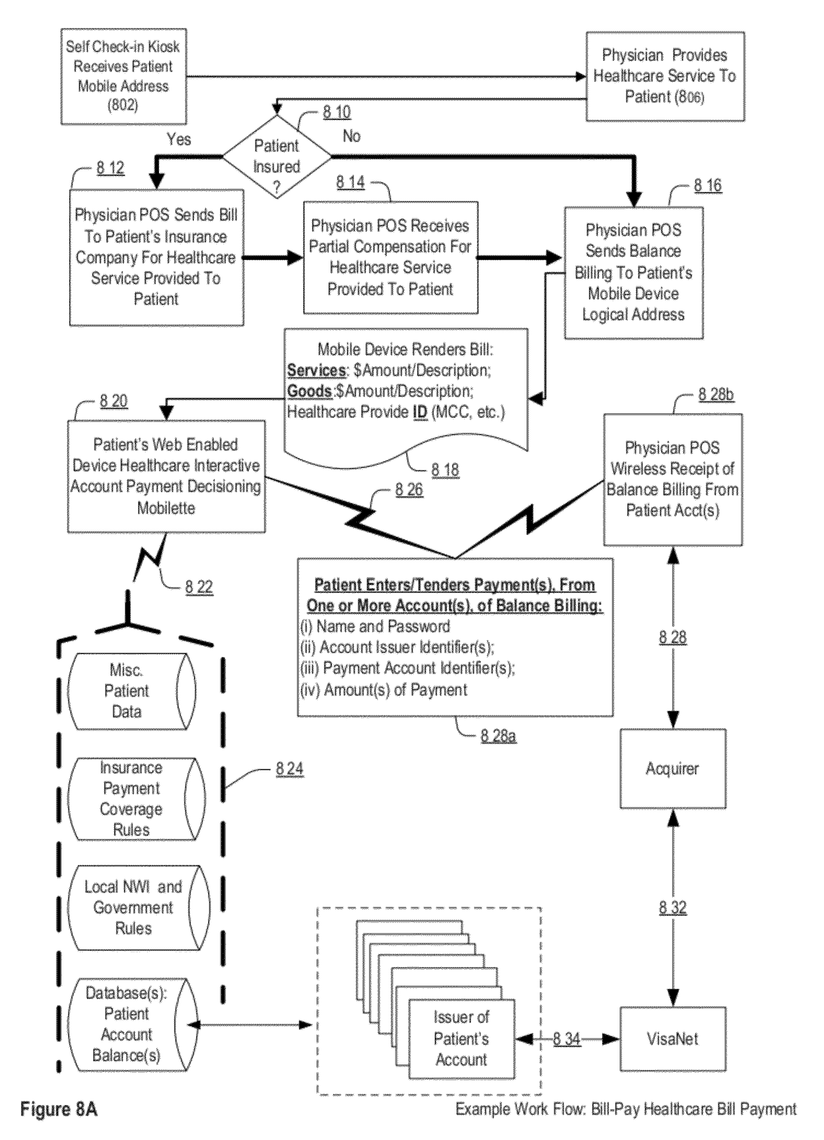

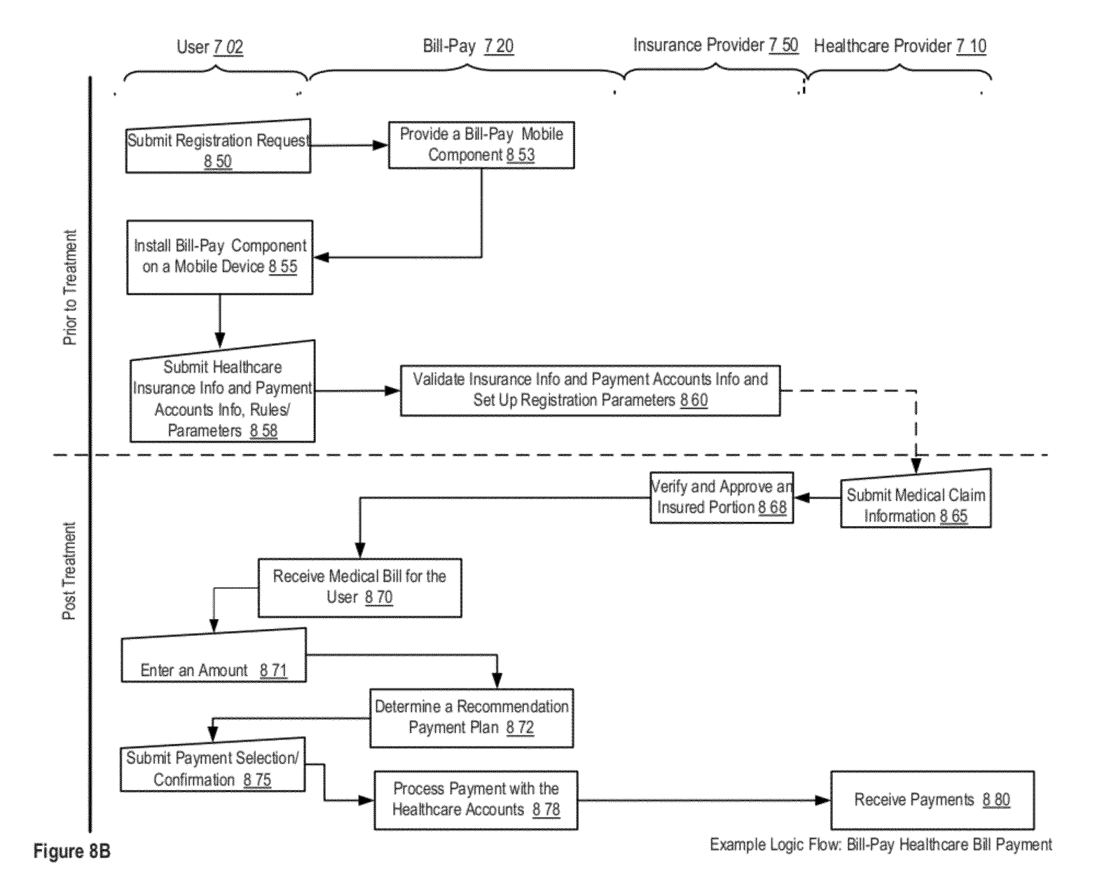

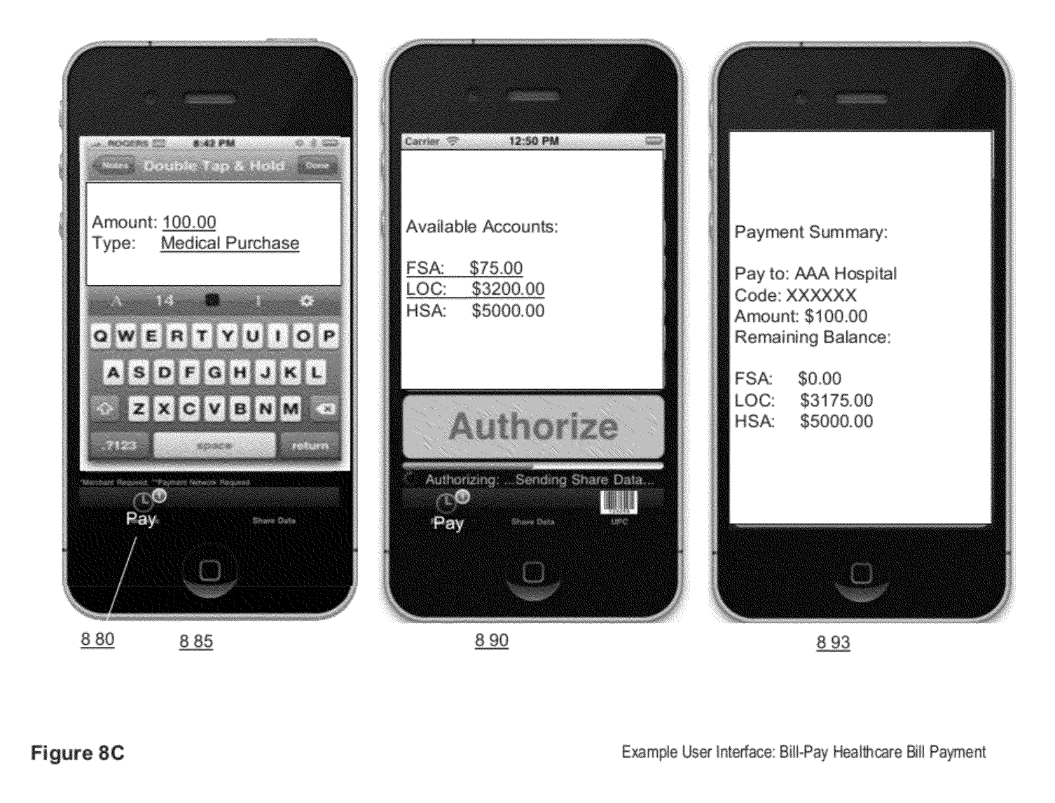

FIG. 8A provides a logic flow diagram illustrating processing healthcare payment within embodiments of the Bill-Pay. In one embodiment, the payment being made by the user is optimized for the user's benefit with respect to considerations of insurance, governmental taxation, and user data so that an optimized payment scheme to be made to satisfy a bill from the healthcare provider for the healthcare.

In one embodiment, a user may check in at a kiosk at a healthcare provider's office 802, e.g., a POS registry a hospital, a clinic, and/or the like. The physician or other healthcare provider may provide healthcare service to the user 806.

In one embodiment, the physician's office determines whether or not the user is insured 810. If the user is insured, then process moves to step 812. Otherwise, the process moves to step 816.

In one implementation, the physician's Point Of Service terminal (POS) may send a bill to the user's insurance company for the healthcare that was provided to the user. For example, the healthcare provider may send the medical bill directly to an insurance provider via mail, email, instant message, and/or the like. For another example, the healthcare provider may submit information related to the medical bill

In one embodiment, at step 814, the physician's point of service terminal receives partial compensation from the user's insurance company for the healthcare that was provided to the user. At step 816, the physician's point of service terminal sends a balance due billing to the user's mobile device, for instance, to an email address or as a text message by use of the user's cellular telephone number.

In one embodiment, at step 818, the mobile device renders to the user a description of the bill as received for the balance due billing from the physician. The rendered bill, shown in step number 118, shows the amount due, the description of the goods and/or services of the healthcare provided to the user by the healthcare provider, and a Merchant Commodity Code (MCC) of the physician or healthcare provider. At step 820 the user's web-enabled device executes an application, which may also perform the rendering at step 818, where a decision process takes place in order to satisfy the bill rendered at step 818.

In one embodiment, the user may obtain and install a mobile application which determines payment accounts in order to pay the bill shown in step 818. To make the determination, the mobile application draws upon one or more online databases to which it has access. Arrow 822 shows online access to a plurality of databases 824. These databases include a database having miscellaneous data for the user, a database for insurance payment coverage rules, a database for local negative wealth impactor and government rules, and one or more databases showing various account balances that have been issued by issuers to the user that have credit or currency available to satisfy the bill shown in step 818. Various rules for incentives and penalties are contained within in the databases as seen at block 824. For instance, available balances for Medicare Part D provisions can be shown as being available to satisfy the bill in step 818.

The various databases can also include considerations for government insurance, pharmacy benefits, employer healthcare considerations, employer pharmacy benefit plans, employer or government subsidizing of healthcare goods and services, and incentives or penalties to use accounts according to negative wealth impactor code provisions as provided by various business rules. The available deductibles and required deductibles for each of the one or more benefit plans can be found in one or more databases seen at reference numeral 824, as well as various co-pay requirements, pre-negative wealth impactor healthcare spending limits, and various negative wealth impactor deferred currency amounts. Various forfeiture rules, such as are applicable to Flexible Savings Accounts (FSA) can also be found in databases 824. The relative merits of using an HSA, with its negative wealth impactor deferred deposit benefits, as well as the ability to grow its balance in terms of both compounding interest and the probability of a rise in the values of various equity holdings, are also taken into consideration. The various user account balances maintained by the databases of block 824 can be assessed via one or more issuers of the respective user accounts as seen at 834. Each issuer is an issuer to an account of the user, who is an account holder on that account that was issued by the issuer.

After the mobile application seen at process 82o receives information, business rules, and data via communication seen at arrow 822, the process 220 calculates a recommendation of one or more accounts having respective one or more amounts to be paid from each account. This recommendation will provide the most favorable tax, cost, and benefits to the user by using the amounts and respective accounts, while also minimized penalties for such use. The mobile applications recommendations are rendered on the mobile device at step 828a as shown in FIG. 8C. The rendering on the web-enabled mobile device may also guard access such as by prompting for, and validating, a user name and the password to enable making withdrawals from respective accounts for respective amounts suggested by process 82o. Each account can be identified by a nickname or identifier, and the nickname will be listed along with the amount that is recommended to be paid from that account toward the balance due billing shown at block 818.

For example, in one implementation, a Visa debit or credit account or a prepaid card may be suggested and identified by a nickname (i.e., a partial account number) along with an amount to be paid from that account. The user has the option to accept or reject the recommendation made as rendered on the web-enabled mobile device at step 828a. If the user decides to reject the payment recommendation, an override can be submitted by the user to change the account and/or amounts and to make effective the changes or to amend the recommendations as to the amounts to be paid from various accounts by the user to the physician. This payment is seen in step 828b where the physician's POS receives a wireless communication from the user's web-enabled mobile device. This wireless communication will contain data that reflects each account and each corresponding amount to be paid from each account to satisfy the balance due billing shown at step 818.

In one embodiment, at arrows 830 and 832, the physician communicates with its acquirer and with a transaction handler (i.e., VisaNet) to send an authorization request for each payment for each account that is designated by the wireless communication from the web-enabled mobile device to the physician's POS. The authorization request is sent from VisaNet via communication 234 to the issuer of each account from which a payment is to be made. Each issuer, respectively, sends an authorization response to the authorization request back to VisaNet, which is in turn sent from VisaNet to the physician's acquirer as shown by communication arrow 832, and from there to the physician's acquirer via communication arrow 830 back to the physician's POS. Once the physician's POS has received an authorization response for the payment from each account, then the physician may deem that the bill, as shown in block 818, has been satisfied. Thereafter, the physician's office, with its acquirer, will initiate a clearing and settlement process for each authorized payment from each account that was used to satisfy the balance due billing seen at block 818.

FIG. 8B provides a logic flow diagram illustrating alternative embodiments of the Bill-Pay. In one embodiment, the user 702 may register to the Bill-Pay 720 prior to utilizing the Bill-Pay payment service after healthcare treatment.

In one embodiment, the user 702 may submit a request 850 for registration with the Bill-Pay, e.g., via an email, a text message, a telephonic phone call to customer service, and/or the like. The Bill-Pay may then provide a Bill-Pay mobile component 853 to the user. For example, the Bill-Pay may provide an indication, a link, etc. for downloading a mobile payment application to the user's mobile device, via which the user may register one or more multi-purpose accounts with the Bill-Pay and process healthcare claims and payments in real-time.

In one embodiment, the user 702 may download and install the Bill-Pay component on a mobile device 855, e.g., an Apple iPhone, etc. The user 702 may then register with the Bill-Pay via the installed Bill-Pay component, by submitting healthcare insurance information and setting up payment accounts 858. For example, the user may associate his FSA/HSA accounts with the Bill-Pay. For another example, the user may be presented rule choices within agreement and IRS policies, and set up his rules and parameters for usage of his FSA/HAS payment accounts. For example, the user may set up a rule such that any medical purchase less than $100.00 until the end of the year will be paid by his FSA account.

For example, a user may set up accounts and spending rules for the Bill-Pay as illustrated in one example in the following table:

| | |
|---|---|
| Primary Account: | Flexible Spending Account (FSA) |
| Balance: | $500.00 |
| End Date: | 12/31/XXXX |
| Rules: | 1. Only use for medical MCC |
| | 2. Use for purchases less than $100.00 |
| | until 10/01/XXXX |
| | 3. After 10/01/XXXX, use available |
| | balance for all medical MCC purchases. |
| Second Account: | Health Savings Account (HSA) |
| Balance: | $5000.00 |
| Rules: | 1. Use for medical MCC |
| | 2. Use for purchases greater than 2000.00 |
| | 3. Use as tertiary fund for medical MCC |
| | purchases |
| Third Account: | Revolving Line of Credit (LOC) |
| Credit Line: | $5000.00 |
| Rules: | 1. Use for any MCC |
| | 2. Use for purchases greater than $100 but |
| | less than $2000.00 |
| | 3. Use as secondary account for medical |
| | purchase |

In one embodiment, the Bill-Pay may provide default settings and rules for the user via a user interface, e.g., the mobile component installed on the user's mobile device. In another embodiment, the user may configure a variety of parameters. In the above example, the user may edit the balancing amount of an account, the end date, the rules, and/or the like.

In one embodiment, upon receiving user provided registration data and related parameters and spending rules, the Bill-Pay may validate the insurance information with the insurance provider 750, and setup spending rules associated with the user's Bill-Pay account 860 to complete the registration. In another implementation, the Bill-Pay 720 may register the user's mobile device for security, such as, via a hardware ID, MAC address, and/or the like.

In one embodiment, after the user is present at a healthcare provider for medical services, the healthcare provider 710 may submit medical claim information 865 to an insurance provider 750 at checkout, wherein the insurance provider may approve an insured portion 868 based on the user's insurance policy. In one implementation, the user may send a payment file (e.g., via text message, email, etc.) to the Bill-Pay, including the amount of patient responsibility, NPI, plan membership, SSN, etc. The Bill-Pay may then verify the submitted user data with verify against the healthcare registration record. If the record matches, the Bill-Pay may generate a “please pay an amount XXX” message and send to the user.

In one implementation, the healthcare provider 710 may send the remaining balance of the medical bill to the Bill-Pay 870 for user payment processing. In another implementation, the user 702 may received a medical bill, e.g., at a mobile device, etc., in real-time at checkout, and enter the amount due into his mobile device for Bill-Pay.

In one implementation, the Bill-Pay 720 may determine a recommendation of payment plan 872 to the user based on the remaining amount in the user's registered payment accounts with Bill-Pay 872, and prompt the user to select a payment method 875. Upon receiving a confirmation of payment selection, the Bill-Pay may process payment with the healthcare accounts 878, and the healthcare provider may send confirmation of payment 880.

For example, if a user goes to a primary care physician on June 8, ______, i.e., more than half a year to the end date to his FSA, and a medical bill indicates a co-pay amount of $50.00, the user may enter $50.00 into the Bill-Pay mobile application and indicate it is medical purchase. The Bill-Pay may then assess the rules in the above example, and provide a screen of options showing the remaining balances in the three accounts, e.g., FSA ($500.00), LOC($2900), HAS($5000.00). In one implementation, the Bill-Pay may list the available accounts in a prioritized order based on the spending rules. For example, in the above example, although LOC is the third account after the HSA, LOC is listed prior to HSA as the rule specifies LOC is applied as secondary account for medical purchase.

For another example, if the user goes to a physical therapist at September 27, ______, i.e., approximately three months to the end date of FSA, and the patient's responsibility is $100.00, the user may enter $100.00 into the Bill-Pay mobile component and confirm it is medical purchase, as shown in the example screen shots in FIG. 8C. In FIG. 8C, the user may press a “pay” button 88o to enter an amount and type of purchase 885. The Bill-Pay may then respond by listing the remaining balances, e.g., FSA ($75.00), LOC ($3200), and HSA ($5000.00), as shown at 890 in FIG. 4C. In this case, even if the FSA has insufficient funds, it is on top of the prioritized list because it will expire at the end of the year. As the remaining balance in FSA is insufficient to cover the amount due, the user may split the amount by selecting FSA to pay $75.00 and LOC to pay the remaining $100−$75=$25. The Bill-Pay may send a report summary to the user including the updated remaining balance of the accounts after payment, and/or the like, as illustrated at 893 in FIG. 8C.

For another example, if the user received a surgery on September 30, ______, i.e., approximately three months to the end date of FSA, and received a medical bill of $2000.00: the Bill-Pay may provide a list of accounts available, e.g., LOC ($3000.00), FSA (o), HAS ($5000.00). In this case, the user may elect to select HAS for the payment.

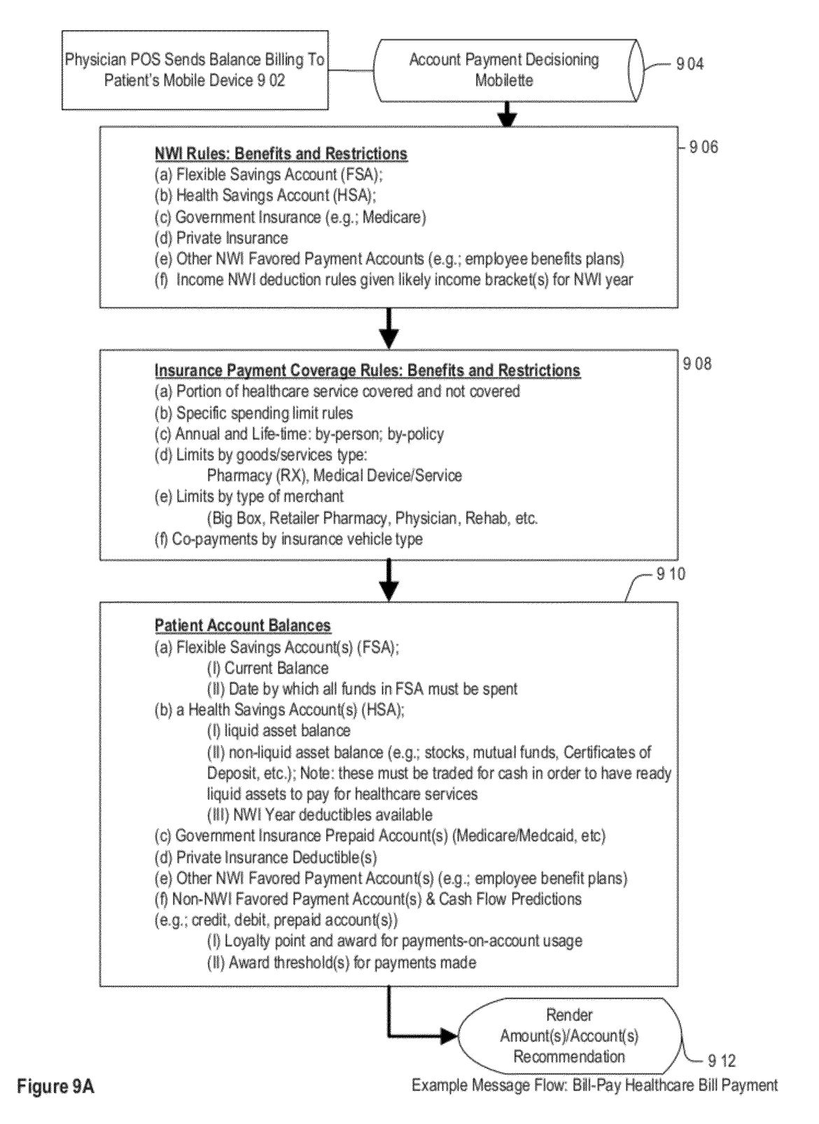

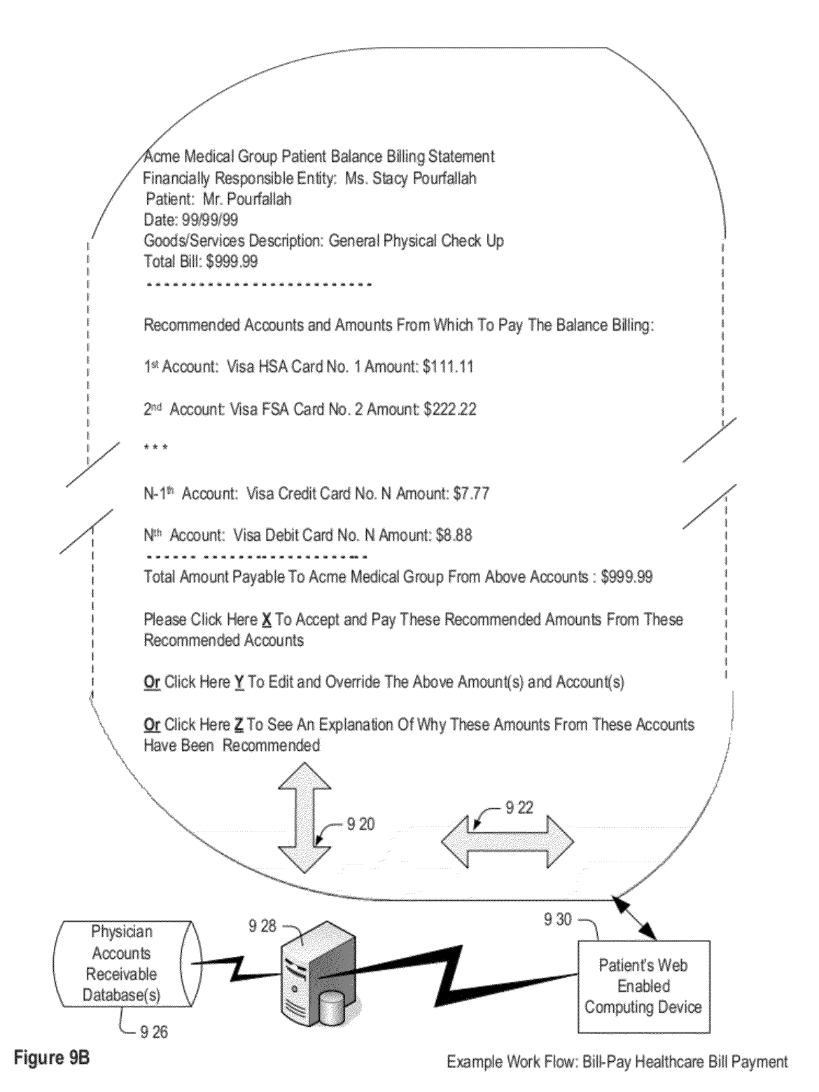

FIG. 9A provides a flow diagram illustrating alternative embodiments of Bill-Pay. A physician has a point of service terminal that sends balance due billing to the patient's web-enabled mobile device 902, and access to information and data interactively between various online databases and the mobile application executing on a patient's web-enabled mobile device 904. Block 906 shows access to retrieve various negative wealth impactor rules and benefits that can be input and considered to make a recommendation as to a payment which should be made from one or more accounts. The negative wealth impactor rules can include those for one or more Flexible Savings Accounts (FSA), one or more Health Savings Accounts (HSA), one or more government insurance programs (i.e., Medicare or Medicaid), various private insurance negative wealth impactor rules, various other negative wealth impactor favored payment accounts such as employment benefit plans or employee pharmacy benefit plans, and income negative wealth impactor deduction rules. Likely income negative wealth impactor brackets for the patient's negative wealth impactor year may also be taken into consideration in arriving at a recommendation.

In one embodiment, considerations are also input through various online databases to show insurance payment coverage rules 908. These business rules can include: (i) that portion of healthcare services that are covered or not covered for a healthcare service that is rendered by a physician to a patient; (ii) various specific spending rule limits and forfeiture rules, various annual and lifetime co-payment and maximum insurance payments by the person and/or by the policy, various limits for various goods and services which may or may not be reimbursable under insurance including pharmacy, vision, and dental payments to respective healthcare service providers; (iii) insurance coverage for various types of merchants that are available as benefits and restriction of benefits including big box retailers, retail pharmacy organizations, physician-owned organizations, rehabilitation organizations, various public and private hospitals, as well as various private preferred providers for respective insurance plans; and (iv) copayments that are available for each of several different insurance vehicles.

In one embodiment, the various patient account balances may be retrieved to determine availability of currency or funds to pay the balance due bill received from the healthcare provider 910. These accounts can be assessed by online communication with the respective issuers to determine account balances. By way of example, these balances can include: (i) a balance for one or more Flexible Savings Accounts (FSA), including a current balance and the date by which all funds in each FSA account must be spent; (ii) one or more health savings accounts (HSA) including a liquid asset balance, a non-liquid asset balance that can including stocks, mutual funds, certificates of deposit, etc. In that some equities must be traded for cash in order to have access to liquid assets to satisfy the healthcare provider's balance due bill, the retrieved information can include various requirements for selling stock or other securities, including commission charges, which information can be taken into consideration by the decisioning application in making the recommendation; (iii) balances for government insurance prepaid accounts, such as Medicare and Medicaid; (iv) private insurance deductibles outstanding and yet to be paid; (v) other negative wealth impactor deferred payment accounts that are available to satisfy the healthcare provider's balance due bill, such as employee benefit plans; (vi) non-negative wealth impactor favored payment accounts and likely cash flow predictions for in each one of those accounts, such as credit available in credit cards, cash available in debit card accounts, cash available on prepaid card accounts, as well as any currency that is available by converting loyalty points for each one of these accounts so that the loyalty points can be used as currency toward balance due billing payments. Also available are calculations made by the mobile application of award thresholds if a payment is made so as to thereby realize more loyalty points that can then be converted into currency to satisfy the healthcare provider's balance due billing.

The various inputs and data that are retrieved are subjected to various calculations as derived from steps 906 through 910 so that the mobile application can make a recommendation as to each account, and each amount to be paid from each account, that will be in the patient's best interest to pay a balance due billing received by the web-enabled mobile device from the patient's physician or other healthcare provider via a point of service terminal.

FIG. 9B shows an exploded screen shot of a display terminal within embodiments of the Bill-Pay. In one implementation, a horizontal and vertical icon is rendered on the screen so that a user can navigate to view vertical and horizontal portions of the display screen, as indicated by icons 920, 922. Screen shot shows the total balance due from the physician as well as each of the accounts 1 through N, and respective amounts to be paid from accounts 1 through N, as recommended by the mobile application to satisfy the healthcare provider's balance due billing. As shown in display screen, the patient can accept the recommended payments from each recommended account by clicking in one location. Alternatively, the patient can edit the respective accounts and their respective payments from each account, by ‘clicking’ on an icon at another location. As a third option, the user can ‘click on’ an icon to receive a rendering of an explanation on display screen as to why the recommendations from each account for each amount was recommended. The explanation will give the patient an understanding upon which the patient can base an approval, modification, or rejection of the recommended payments from each account.

Once the recommendations are accepted, the process taken place as shown in steps 93o through 926, where the patient's web-enabled mobile device transmits to the physician's point of service terminal a communication that describes the payment to be made from each account. An e-commerce server, shown at block 928, processes each payment from each account as is described in FIG. 2A through the issuer processer, the acquirer processer, and the transaction handler (VisaNet) for a clearing and settlement process by which the physician's accounts receivable satisfied as to the balance due payment made by the patient, as shown in block 926.

In one implementation, the patient may operate a web-enabled mobile computing device that can be executing a World Wide Web browser 930, or other special purpose software, in order to access databases.

In one implementation, the Bill-Pay may allow the patient to view specifics of the balance due billing that the physician is charging the patient, as well as funds for payment of the balance due billing. The patient can provide information to the web-enabled mobile device in order to gain access to financial information stored by each issuer that issued an account to the patient. To access financial information for the patient, a name and password can be required. Once supplied by the patient, financial information can be sent and retrieved. This information can include account issuer identifiers (e.g.; account numbers), the name of the issuer who issued the account numbers, and any amounts that the financially responsible person wishes to pay on balance due billing to the doctor. Specifics of a bill that the patient can view may include: (i) the healthcare organization name that provided healthcare services to the patient, (ii) the name of the physician who treated the patient, (iii) the name of the person who is financially responsible for the patient, (iv) the name of the patient, (v) the date the services were provided by the doctor to the patient, (vi) a description of the healthcare goods and/or services that were rendered to the patient by the doctor, (vii) any amounts paid by the insurance company for the foregoing healthcare goods and services, and (viii) any balance due by the person who is financially responsible for the patient to the healthcare organization.

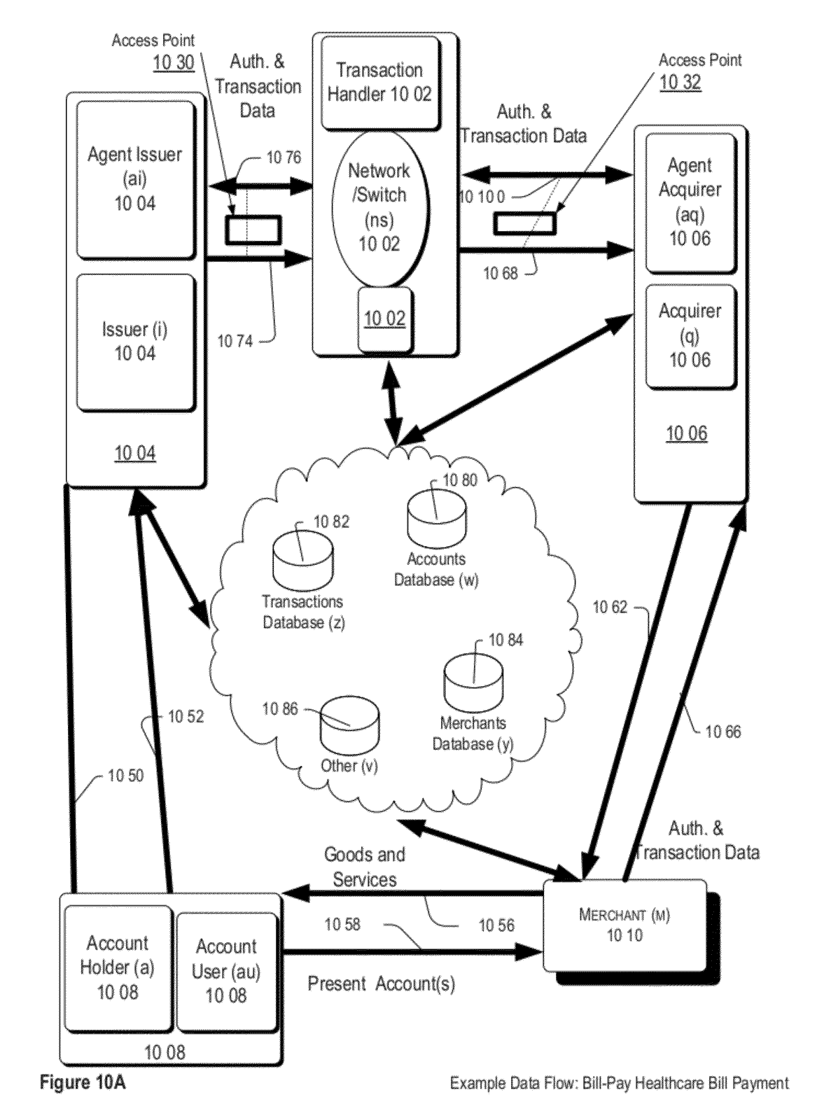

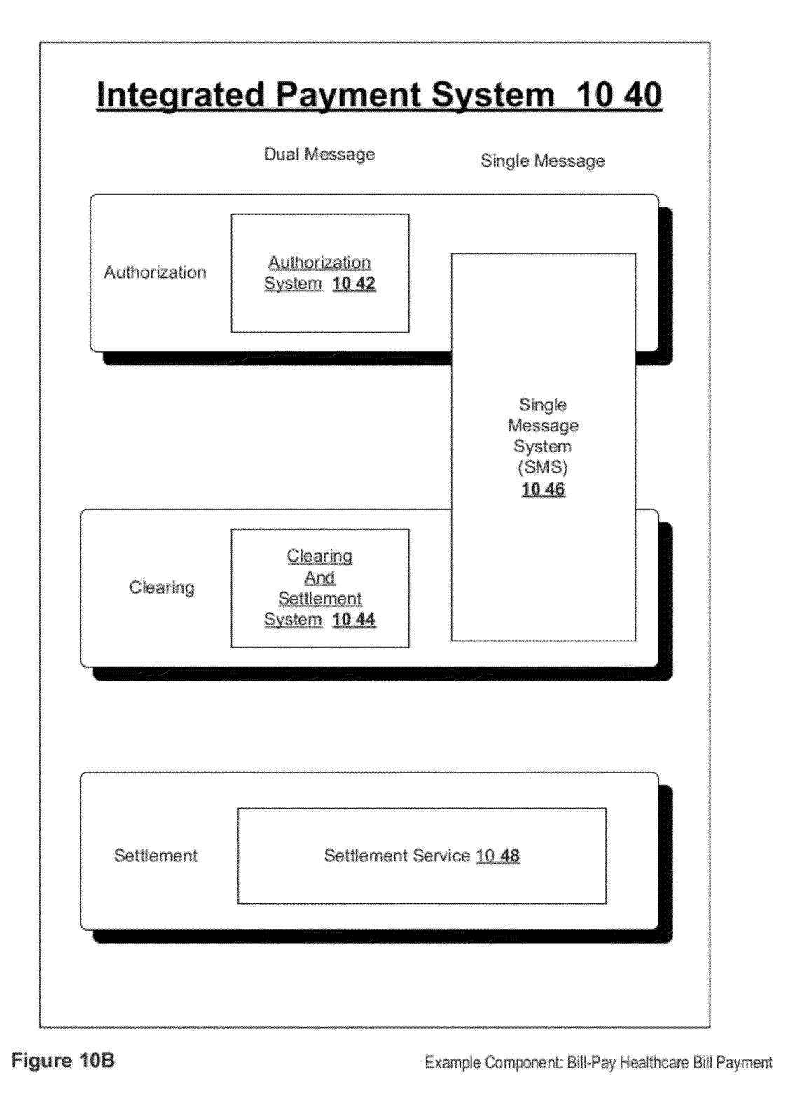

FIG. 10A illustrates an exemplary open system payment processing network, depicting a general environment in which a merchant (m) 1010 can conduct a transaction for goods and/or services with an account user (au) or customer on an account (e.g., a prepaid account, credit account, points account, etc.) issued to an account holder (a) 1008 by an issuer (i) 1004, where the processes of paying and being paid for the transaction are coordinated by a transaction handler 1002. The transaction includes participation from different entities that are each a component of the payment processing system. As such, the open system payment processing network can be used by a patient (or agent thereof) to pay a healthcare service provider to who a balance due bill is owed as described above.

Payment processing system has a plurality of merchants 1010 that includes merchant (1) 1010 through merchant (M) 1010, where M can be up to and greater than an eight digit integer. Payment processing system has a plurality of accounts 1008 each of which is held by a corresponding account holder (1) 1008 through account holder (A) 1008, where A can be up to and greater than a ten eight digit integer.

Payment processing system includes account user (1) 1008 through account user (AU) 1008, where AU can be as large as a ten digit integer or larger. Each account user (au) may act as a customer and initiate a transaction for goods and/or services with merchant (m) 1010 using an account that has been issued by an issuer (i) 1004 to a corresponding account holder (a) 1008. Data from the transaction on the account is collected by merchant (m) and forwarded to a corresponding acquirer (a) Acquirer (a) 1006 forwards the data to transaction handler 1002 who facilitates payment for the transaction from the account issued by the issuer (i) 1004 to account holder (a) 1008.

Payment processing system has a plurality of issuers 1004. Each issuer (i) 1004 may be assisted in processing one or more transactions by a corresponding agent issuer (ai) 1004, where T can be an integer from 1 to I, where ‘ai’ can be an integer from to AI, and where I and AI can be as large as an eight digit integer or larger.

Payment processing system has a plurality of acquirers 1006. Each acquirer (q) 1006 may be assisted in processing one or more transactions by a corresponding agent acquirer (aq) 1004, where ‘q’ can be an integer from 1 to Q, where ‘aq’ can be an integer from 1 to AQ, and where Q and AQ can be as large as a eight digit integer or larger.

Payment processing system has a transaction handler 1002 to process a plurality of transactions. The transaction handler 1002 can include one or a plurality or networks and switches 1002. Each network/switch (ns) 1002 can be a mainframe computer in a geographic location different than each other network/switch (ns) 1002, where ‘ns’ is an integer from one to NS, and where NS can be as large as a four-digit integer or larger.

Dedicated communication systems 1068-1076 (e.g., private communication network(s)) facilitate communication between the transaction handler 1002 and each issuer (i) 1004 and each acquirer (a) 1006. The Internet 1012, via e-mail, the World Wide Web, cellular telephony, and/or other optional public and private communications systems, can facilitate communications using communication systems 1050-1066 among and between each issuer (i) 1004, each acquirer (a) 1006, each merchant (m) 1010, each account holder (a) 1008, and the transaction handler 1002. Alternatively and optionally, one or more dedicated communication systems 1050-1066 can facilitate respective communications between each acquirer (a) 1006 and each merchant (m) 1010, each merchant (m) and each account holder (a) 1008, and each account holder (a) 1008 and each issuer (i) 1004, respectively.

Each acquirer (q) 1006 may be assisted in processing one or more transactions by a corresponding agent acquirer (aq) 1004, where ‘q’ can be an integer from 1 to Q, where aq can be an integer from 1 to AQ, and where Q and AQ can be as large as a eight digit integer or larger.

Merchant (m) 1010 may be a person or entity that sells goods and/or services. Merchant (m) 1010 may also be, for instance, a healthcare service provider, a manufacturer, a distributor, a retailer, a load agent, a drugstore, a grocery store, a gas station, a hardware store, a supermarket, a boutique, a restaurant, or a doctor's office. In a business-to-business setting, the account holder (a) 1008 may be a second merchant making a purchase from another merchant (m) 1010. Merchant (m) 1010 may use at least one stationary and/or mobile point-of-sale terminal (POS) that can communicate with acquirer (a) 1006, transaction handler 1002, or issuer (i) 1004. Thus, the POS terminal is in operative communication with the payment processing system.

Typically, a transaction begins with account user (au) 1008 presenting a portable consumer device to merchant (m) 1010 to initiate an exchange for a good or service. The portable consumer device may be associated with an account (e.g., a monetary or reward points account) of account holder (a) 1008 that was issued to the account holder (a) 1008 by issuer (i) 1004.

The portable consumer device may be in a form factor that can be a payment card, a gift card, a smartcard, a smart media device, a payroll card, a healthcare card, a wrist band, a machine readable medium containing account information, a keychain device, such as a SPEEDPASS® device commercially available from ExxonMobil Corporation, or a supermarket discount card, a cellular phone, personal digital assistant, a pager, a security card, an access card, a wireless terminal, or a transponder. The portable consumer device may include a volatile or non-volatile memory to store information such as the account number or the name of an account holder (a) 1008.

Merchant (m) 1010 may use the POS terminal to obtain account information, such as a number of the account of the account holder (a) 1008, from the portable consumer device. The portable consumer device may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer (i) 1004 of the account corresponding to the portable consumer device. Alternatively, or in combination, the portable consumer device may communicate with issuer (i) 1004, transaction handler 1002, or acquirer (a) 1006.

Issuer (i) 1004 may authorize the transaction using transaction handler Transaction handler 1002 may also clear the transaction. Authorization includes issuer (i) 1004, or transaction handler 1002 on behalf of issuer (i) 1004, authorizing the transaction in connection with issuer (i) 1004's instructions such as through the use of business rules. The business rules could include instructions or guidelines from transaction handler 1002, account holder (a) 1008, merchant (m) 1010, acquirer (a) 1006, issuer (i) 1004, a related financial institution, or combinations thereof. Transaction handler 1002 may maintain a log or history of authorized transactions. Once approved, merchant (m) 1010 will record the authorization, allowing account user (au) 1008 to receive the good or service from merchant (m) or an agent thereof.

21[00172] Merchant (m) 1010 may, at discrete periods, such as at the end of the day, submit a list of authorized transactions to acquirer (a) 1006 or other transaction related data for processing through the payment processing system. Transaction handler 1002 may compare the submitted authorized transaction list with its own log of authorized transactions. If a match is found, transaction handler 1002 may route authorization transaction amount requests from the corresponding acquirer (a) 1006 to the corresponding issuer (i) 1004 involved in each transaction. Once acquirer (a) 1006 receives the payment of the authorized transaction amount from issuer (i) 1004, acquirer (a) 1006 can forward the payment to merchant (m) 1010 less any transaction costs, such as fees for the processing of the transaction. If the transaction involves a debit or prepaid card, acquirer (a) 1006 may choose not to wait for the issuer (i) 1004 to forward the payment prior to paying merchant (m) 1010.

There may be intermittent steps in the foregoing process, some of which may occur simultaneously. For example, acquirer (a) 1006 can initiate the clearing and settling process, which can result in payment to acquirer (a) 1006 for the amount of the transaction. Acquirer (a) 1006 may request from transaction handler 1002 that the transaction be cleared and settled. Clearing includes the exchange of financial information between the issuer (i) 1004 and the acquirer (a) 1006 and settlement includes the exchange of funds. Transaction handler 1002 can provide services in connection with settlement of the transaction. The settlement of a transaction includes depositing an amount of the transaction settlement from a settlement house, such as a settlement bank, which transaction handler 1002 typically chooses, into a clearinghouse, such as a clearing bank, that acquirer (a) 1006 typically chooses. Issuer (i) 1004 deposits the same from a clearinghouse, such as a clearing bank, which issuer (i) 1004 typically chooses, into the settlement house. Thus, a typical transaction involves various entities to request, authorize, and fulfill processing the transaction.

Payment processing system will preferably have network components suitable for scaling the number and data payload size of transactions that can be authorized, cleared and settled in both real time and batch processing. These include hardware, software, data elements, and storage network devices for the same. Examples of payment processing system include those operated, at least in part, by American Express, Master Card, Discover Card, First Data Corporation, Diners Club, and Visa Inc., and agents of the foregoing.

Each network/switch (ns) 1002 can include one or more data centers for processing transactions, where each transaction can include up to 100 kilobytes of data or more. The data corresponding to the transaction can include information about the types and quantities of goods and services in the transaction, information about the account holder (a) 1008, the account user (au) 1008, the merchant (m) 1010, negative wealth impactor and incentive treatment(s) of the goods and services, coupons, rebates, rewards, loyalty, discounts, returns, exchanges, cash-back transactions, etc. Of course, in the case of the data corresponding to a healthcare-related transaction, the information would necessarily be limited with respect to the goods and services in the transaction as would be consistent with full regulatory compliance (e.g.; HIPAA compliance in the USA, the Personal Health Information Protection Act (PHIPA) in Canada, etc.)

By way of example, network/switch (ns) 1002 can include one or more mainframe computers (e.g., one or more IBM mainframe computers) for communications over systems 1068-1076, one or more server farms (e.g., one or more Sun UNIX Superservers), where the mainframe computers and server farms can be in diverse geographic locations.

Each issuer (i) 1004 (or agent issuer (ai) 1004 thereof) and each acquirer (a) 1006 (or agent acquirer (aq) 1006 thereof) can use one or more router/switch (e.g., Cisco routers/switches) to communicate with each network/switch (ns) 1002 via dedicated communication systems 1068-1076, respectively.

Transaction handler 1002 stores information about transactions processed through payment processing system in data warehouses such as may be incorporated as part of the plurality of networks/switches (ns) 1002. This information can be data mined. The data mining transaction research and modeling can be used for advertising, account holder and merchant loyalty incentives and rewards, fraud detection and prediction, and to develop tools to demonstrate savings and efficiencies made possible by use of the payment processing system over paying and being paid by cash, checks, or other traditional payment mechanisms.

The VisaNet® system is an example component of the transaction handler 1002 in the payment processing system. Presently, the VisaNet® system is operated in part by Visa Inc. As of 2007, the VisaNet® system Inc. was processing around 300 million transaction daily, on over 1 billion accounts used in over 170 countries. Financial instructions numbering over 16,000 connected through the VisaNet® system to around 30 million merchants. In 2007, around 81 billion transactions for about 4 trillion U.S. dollars were cleared and settled through the VisaNet® system, some which involved a communication length of around 24,000 miles in around two (2) seconds.

The open system payment processing network seen in FIG. 4A can be enabled via a telecommunications network that may make use of any suitable telecommunications network and may involve different hardware, different software and/or different protocols then those discussed below. FIG. 4A can be deemed to depict a global telecommunications network that supports purchase and cash transactions using any bankcard, travel and entertainment cards, and other private label and proprietary cards. The network also supports ATM transactions for other networks, transactions using paper checks, transactions using smart cards, virtual cards, and transactions using other financial instruments.

These transactions are processed through the network's authorization, clearing and settlement services. Authorization is when an issuer approves or declines a sales transaction before a purchase is finalized or cash is dispersed. Clearing is when a transaction is delivered from an acquirer to an issuer for posting to the customer's account. Settlement is the process of calculating and determining the net financial position of each member for all transactions that are cleared. The actual exchange of funds is a separate process.

Transactions can be authorized, cleared and settled as either a dual message or a single message transaction. A dual message transaction is sent twice—the first time with only information needed for an authorization decision, an again later with additional information for clearing and settlement. A single message transaction is sent once for authorization and contains clearing and settlement information as well. Typically, authorization, clearing and settlement all occur on-line.

FIG. 4B includes one or more transaction handlers 1002, access points 1030, 1032, acquirers 1006, and issuers 1004. Other entities such as drawee banks and third party authorizing agents may also connect to the network through an access point. An interchange center is a data processing center that may be located anywhere in the world. In one embodiment, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferably, the communication lines that connect an interchange center (Transaction Handler 1002) to remote entities use dedicated high-bandwidth telephone circuits or satellite connections based on the IBM SNA-LUo communication protocol. Messages are sent over these lines using any suitable implementation of the ISO 8583 standard.

Access points 1030, 1032 are typically made up of small computer systems located at a processing center that interfaces between the center's host computer and the interchange center The access point facilitates the transmission of messages and files between the host and the interchange center supporting the authorization, clearing and settlement of transaction. Telecommunication links between the acquirer (q) 1006 and its access point 1032, and between the access point 1030 and issuer (i) 1004 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

FIG. 10B illustrates an integrated payment system 1040 housed within an interchange center to provide on-line and off-line transaction processing within embodiments of the Bill-Pay. For dual message transaction, authorization system 1042 provides authorization. Authorization system 1042 supports on-line and off-line functions, and its file includes internal systems tables, a customer database and a merchant central file. The on-line functions of system 1042 support dual message authorization processing. This processing involves routing, cardholder and card verification and stand-in processing, and other functions such as file maintenance. Off-line functions including reporting, billing, and generating recovery bulletins. Reporting includes authorization reports, exception file and advice file reports, POS reports and billing reports. A bridge from system 1042 to system 1046 makes it possible for members using system 542 to communicate with members using system 1046 and access the SMS gateways to outside networks.

Clearing and settlement system 1044 clears and settles previously authorized dual message transactions. Operating six days a week on a global basis, system 1044 collects financial and non-financial information and distributes reports between members It also calculates fees, charges and settlement totals and produces reports to help with reconciliation. A bridge forms an interchange between system 1044 processing centers and system 1046 processing centers.

Single message system 1046 processes full financial transactions. System 546 can also process dual message authorization and clearing transactions, and communicates with system 1042 using a bridge and accesses outside networks as required. System 1046 processes Visa, Plus Interlink and other card transactions. The SMS files comprise internal system tables that control system access and processing, and the cardholder database, which contains files of cardholder data used for PIN verification and stand-in processing authorization. System 1046 on-line functions perform real-time cardholder transaction processing and exception processing for authorization as well as full financial transactions. System 1046 also accumulates reconciliation and settlement totals. System 1046 off-line functions process settlement and funds transfer requests and provide settlement and activities reporting. Settlement service 548 consolidates the settlement functions of system 1044 and 1046, including Interlink, into a single service for all products and services. Clearing continues to be performed separately by system 1044 and system 1046.

Additional embodiments of healthcare bill payment of Bill-Pay may comprise: 1. a processor-implemented healthcare payment method embodiment, comprising: receiving a balance due bill from a healthcare provider for a patient; accessing and retrieving information related to the patient's healthcare payment accounts; deriving a recommendation payment plan including a currency payment amount to pay against the balance due bill respectively from at least one of the patient's healthcare payment accounts; receiving, from a user interface, an indicator of an approval of the recommendation; and transmitting a communication that includes the recommendation for payment to a payment network. The method of embodiment 1, wherein the retrieved information includes one or more of: a negative wealth impacting rule pertaining to payment to the healthcare provider for the healthcare to the patient; an insurance rule pertaining to payment for the healthcare to the patient; data specific to the patent and an insured entity financially responsible for the patient; and currency balances in each of one or more accounts respectively issued by an issuer.

### Bill-Pay Controller

FIG. 11 shows a block diagram illustrating embodiments of a Bill-Pay controller. In this embodiment, the Bill-Pay controller 1101 may serve to aggregate, process, store, search, serve, identify, instruct, generate, match, and/or facilitate interactions with a computer through social network and electronic commerce technologies, and/or other related data.

Typically, users, which may be people and/or other systems, may engage information technology systems (e.g., computers) to facilitate information processing. In turn, computers employ processors to process information; such processors 1103 may be referred to as central processing units (CPU). One form of processor is referred to as a microprocessor. CPUs use communicative circuits to carry and pass encoded (e.g., binary) signals acting as instructions to bring about various operations. These instructions may be operational and/or data instructions containing and/or referencing other instructions and data in various processor accessible and operable areas of memory 1129 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the Bill-Pay controller 1101 may be connected to and/or communicate with entities such as, but not limited to: one or more users from user input devices 1111; peripheral devices 1112; an optional cryptographic processor device 1128; and/or a communications network 1113.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Bill-Pay controller 1101 may be based on computer systems that may comprise, but are not limited to, components such as: a computer systemization 1102 connected to memory 1129.

### Computer Systemization

A computer systemization 1102 may comprise a clock 1130, central processing unit (“CPU(s)” and/or “processor(s)” (these terms are used interchangeable throughout the disclosure unless noted to the contrary)) 1103, a memory 1129 (e.g., a read only memory (ROM) 1106, a random access memory (RAM) 1105, etc.), and/or an interface bus 1107, and most frequently, although not necessarily, are all interconnected and/or communicating through a system bus 1104 on one or more (mother)board(s) 1102 having conductive and/or otherwise transportive circuit pathways through which instructions (e.g., binary encoded signals) may travel to effectuate communications, operations, storage, etc. The computer systemization may be connected to a power source 1186; e.g., optionally the power source may be internal. Optionally, a cryptographic processor 1126 and/or transceivers (e.g., ICs) 1174 may be connected to the system bus. In another embodiment, the cryptographic processor and/or transceivers may be connected as either internal and/or external peripheral devices 1112 via the interface bus I/O. In turn, the transceivers may be connected to antenna(s) 1175, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing Bill-Pay controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1129 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the Bill-Pay controller and beyond through various interfaces. Should processing requirements dictate a greater amount speed and/or capacity, distributed processors (e.g., Distributed Bill-Pay), mainframe, multi-core, parallel, and/or super-computer architectures may similarly be employed.Alternatively, should deployment requirements dictate greater portability, smaller Personal Digital Assistants (PDAs) may be employed.

Depending on the particular implementation, features of the Bill-Pay may be achieved by implementing a microcontroller such as CAST's R8050XC2 microcontroller; Intel's MCS 51 (i.e., 8051 microcontroller); and/or the like. Also, to implement certain features of the Bill-Pay, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the Bill-Pay component collection (distributed or otherwise) and/or features may be implemented via the microprocessor and/or via embedded components; e.g., via ASIC, coprocessor, DSP, FPGA, and/or the like. Alternately, some implementations of the Bill-Pay may be implemented with embedded components that are configured and used to achieve a variety of features or signal processing.

Depending on the particular implementation, the embedded components may include software solutions, hardware solutions, and/or some combination of both hardware/software solutions. For example, Bill-Pay features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the Bill-Pay features. A hierarchy of programmable interconnects allow logic blocks to be interconnected as needed by the Bill-Pay system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the Bill-Pay may be developed on regular FPGAs and then migrated into a fixed version that more resembles ASIC implementations. Alternate or coordinating implementations may migrate Bill-Pay controller features to a final ASIC instead of or in addition to FPGAs. Depending on the implementation all of the aforementioned embedded components and microprocessors may be considered the “CPU” and/or “processor” for the Bill-Pay.

### Power Source

The power source 1186 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1186 is connected to at least one of the interconnected subsequent components of the Bill-Pay thereby providing an electric current to all subsequent components. In one example, the power source 1186 is connected to the system bus component 1104. In an alternative embodiment, an outside power source 1186 is provided through a connection across the I/O 1108 interface. For example, a USB and/or IEEE 1394 connection carries both data and power across the connection and is therefore a suitable source of power.

### Interface Adapters

Interface bus(ses) 1107 may accept, connect, and/or communicate to a number of interface adapters, conventionally although not necessarily in the form of adapter cards, such as but not limited to: input output interfaces (I/O) 1108, storage interfaces 1109, network interfaces 1110, and/or the like. Optionally, cryptographic processor interfaces 1127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1109 may accept, communicate, and/or connect to a number of storage devices such as, but not limited to: storage devices 1114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1110 may accept, communicate, and/or connect to a communications network 1113. Through a communications network 1113, the Bill-Pay controller is accessible through remote clients 1133b (e.g., computers with web browsers) by users 1133a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed Bill-Pay), architectures may similarly be employed to pool, load balance, and/or otherwise increase the communicative bandwidth required by the Bill-Pay controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1110 may be used to engage with various communications network types 1113. For example, multiple network interfaces may be employed to allow for the communication over broadcast, multicast, and/or unicast networks.

Input Output interfaces (I/O) 1108 may accept, communicate, and/or connect to user input devices 1111, peripheral devices 1112, cryptographic processor devices 1128, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 111 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1112 may be connected and/or communicate to I/O and/or other facilities of the like such as network interfaces, storage interfaces, directly to the interface bus, system bus, the CPU, and/or the like. Peripheral devices may be external, internal and/or part of the Bill-Pay controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the Bill-Pay controller may be embodied as an embedded, dedicated, and/or monitor-less (i.e., headless) device, wherein access would be provided over a network interface connection.

Cryptographic units such as, but not limited to, microcontrollers, processors 1126, interfaces 1127, and/or devices 1128 may be attached, and/or communicate with the Bill-Pay controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1129. However, memory is a fungible technology and resource, thus, any number of memory embodiments may be employed in lieu of or in concert with one another. It is to be understood that the Bill-Pay controller and/or a computer systemization may employ various forms of memory 1129. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1129 will include ROM 1106, RAM 1105, and a storage device 1114. A storage device 1114 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1129 may contain a collection of program and/or database components and/or data such as, but not limited to: operating system component(s) 1115 (operating system); information server component(s) 1116 (information server); user interface component(s) 1117 (user interface); Web browser component(s) 1118 (Web browser); database(s) 1119; mail server component(s) 1121; mail client component(s) 1122; cryptographic server component(s) 1120 (cryptographic server); the Bill-Pay component(s) 1135; and/or the like (i.e., collectively a component collection). These components may be stored and accessed from the storage devices and/or from storage devices accessible through an interface bus. Although non-conventional program components such as those in the component collection, typically, are stored in a local storage device 1114, they may also be loaded and/or stored in memory such as: peripheral devices, RAM, remote storage facilities through a communications network, ROM, various forms of memory, and/or the like.

### Operating System

The operating system component 1115 is an executable program component facilitating the operation of the Bill-Pay controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with communications networks, data, I/O, peripheral devices, program components, memory, user input devices, and/or the like. The operating system may provide communications protocols that allow the Bill-Pay controller to communicate with other entities through a communications network 1113. Various communication protocols may be used by the Bill-Pay controller as a subcarrier transport mechanism for interaction, such as, but not limited to: multicast, TCP/IP, UDP, unicast, and/or the like.

### Information Server

An information server component 1116 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Bill-Pay controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Bill-Pay database 1119, operating systems, other program components, user interfaces, Web browsers, and/or the like.

Access to the Bill-Pay database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Bill-Pay. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Bill-Pay as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1117 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1118 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the Bill-Pay enabled nodes. The combined application may be nugatory on systems employing standard Web browsers.

### Mail Server

A mail server component 1121 is a stored program component that is executed by a CPU 1103. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the Bill-Pay.

Access to the Bill-Pay mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1122 is a stored program component that is executed by a CPU 1103. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1120 is a stored program component that is executed by a CPU 1103, cryptographic processor 1126, cryptographic processor interface 1127, cryptographic processor device 1128, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Bill-Pay may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the Bill-Pay component to engage in secure transactions if so desired. The cryptographic component facilitates the secure accessing of resources on the Bill-Pay and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Bill-Pay Database

The Bill-Pay database component 1119 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Bill-Pay database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the Bill-Pay database is implemented as a data-structure, the use of the Bill-Pay database 1119 may be integrated into another component such as the Bill-Pay component 1135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1119 includes several tables 1119a-r. A Users table 1119a may include fields such as, but not limited to: user_id, ssn, dob, first_name, last_name, age, state, address_firstline, address_secondline, zipcode, devices_list, contact_info, contact_type, alt contact_info, alt contact_type, Userincome_, UserBankAccount_, UserPreference_, UserTransactionID_, UserMobileID and/or the like. The Users table may support and/or track multiple entity accounts on a EISA. A Financial Accounts table 1119b may include fields such as, but not limited to: user_id, account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping state, and/or the like. A Clients table 119c may include fields such as, but not limited to: user_id, client_id, client_ip, client_type, client_model, operating_system, os_version, app_installed_flag, and/or the like. A Transactions table 1119d may include fields such as, but not limited to: order_id, user_id, timestamp, transaction cost, purchase details_list, num_products, products_list, product_type, product_params list, product_title, product_summary, quantity, user_id, client_id, client_ip, client_type, client_model, operating_system, os_version, app installed_flag, user_id, account_firstname, account_lastname, account_type, account_num, billingaddress_liner, billingaddress_line2, billing_zipcode, billing_state, shipping_preferences, shippingaddress_line1, shippingaddress_line2, shipping_zipcode, shipping_state, agent_id, agent_name, agent_auth_key, and/or the like. An Issuers table 1119e may include fields such as, but not limited to: issuer_id, issuer_name, issuer_address, ip_address, mac_address, auth_key, port_num, security_settings_list, and/or the like. A Batch Data table 1119f may include fields such as, but not limited to: batch_id, transaction_id_list, timestamp_list, cleared_flag_list, clearance_trigger settings, and/or the like. A Payment Ledger table 1119h may include fields such as, but not limited to: request_id, timestamp, deposit_amount, batch_id, transaction_id, clear_flag, deposit_account, transaction_summary, payor_name, payor_account, and/or the like. An Analysis Requests table 1119h may include fields such as, but not limited to: user_id, password, request_id, timestamp, request_details_list, time_period, time_interval, area_scope, area_resolution, spend_sector_list, client_id, client_ip, client_model, operating_system, os_version, app_installed_flag, and/or the like. A Normalized Templates table 1119i may include fields such as, but not limited to: transaction_record_list, norm_flag, timestamp, transaction_cost, biller_params_list, agent_id, agent_name, agent_auth_key, agent_products_list, num_products, product_list, product_type, product_name, class_labels_list, product_quantity, unit_value, subtotal, comment, user_account_params, account_name, account_type, account_num, billing_line1, billing_line2, zipcode, state, country, phone, sign, and/or the like. A Classification Rules table 1119j may include fields such as, but not limited to: rule_id, rule_name, inputs_list, operations_list, outputs_list, thresholds_list, and/or the like. A Strategy Parameters table 1119k may include fields such as, but not limited to: strategy_id, strategy_params_list, regression_models_list, regression equations_list, regression_coefficients_list, fit_goodness_list, lsm_values_list, and/or the like. A merchant table 1119l includes fields such as, but not limited to: MerchantID, MerchantName, MerchantType, MerchantTerminalID, MerchantAddress, MerchantGPS, MerchantURL, MerchantTransactionID, and/or the like. A Message table 1119m includes fields such as, but not limited to: MessageID, MessageType, MessageUserID, MessageFormat, MessageOriginatorID, MessageDestinationID, MessageHeader, MessageFieldNo, MessageFieldValue, and/or the like. A bill table 1119n includes fields such as, but not limited to: BillID, BillConsumerID, BillAdID, BillMerchantID, TriggreType, BillTime, BillContent, and/or the like. A Biller table 11190 includes fields such as, but not limited to: BillerID, BillerName, BillerURL, BillerAddress, BillerType, BillerAgreement, AgreemenRule, AgreementTime, AgreementChapter, and/or the like. An insurance table 1119p includes fields such as, but not limited to: InsuranceProviderID, InsurancePlan, InsurnaceNetwork, InsuranceUserID, InsuranceTransaction, and/or the like. A Restriction table 1119q includes fields such as, but not limited to: RuleID, RuleTitle, RuleRelatedEntity, RuleUserID, RuleInsuranceID, RuleWhiteListParameter (e.g., including subfields such as MaxAmount, MaxFrequency, etc.), RuleBlackListParameter (e.g., including subfields such as BlockedUserID, BlockedInsurance, BlockedMerchantID, etc.), and/or the like. A Market Data table 1119r may include fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi.

In one embodiment, user program may contain various user interface primitives, which may serve to update the Bill-Pay. Also, various accounts may require custom database tables depending upon the environments and the types of clients the Bill-Pay may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1119a-r. The Bill-Pay may be configured to keep track of various settings, inputs, and parameters via database controllers.

The Bill-Pay database may communicate to and/or with other components in a component collection, including itself, and/or facilities of the like. Most frequently, the Bill-Pay database communicates with the Bill-Pay component, other program components, and/or the like. The database may contain, retain, and provide information regarding other nodes and data.

### The Bill-Pays

The Bill-Pay component 1135 is a stored program component that is executed by a CPU. In one embodiment, the Bill-Pay component incorporates any and/or all combinations of the aspects of the Bill-Pay that was discussed in the previous figures. As such, the Bill-Pay affects accessing, obtaining and the provision of information, services, transactions, and/or the like across various communications networks.

The Bill-Pay transforms user key-entered billing and account inputs and/or barcode reading inputs via Bill-Pay components, such as transaction authorization 1142, registration 1143, payment verification 1145 and/or the like into bill payment outputs.

The Bill-Pay component facilitates access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the Bill-Pay server employs a cryptographic server to encrypt and decrypt communications. The Bill-Pay component may communicate to and/or with other components in a component collection, including itself, and/or facilities of the like. Most frequently, the Bill-Pay component communicates with the Bill-Pay database, operating systems, other program components, and/or the like. The Bill-Pay may contain, communicate, generate, obtain, and/or provide program component, system, user, and/or data communications, requests, and/or responses.

### Distributed Bill-Pays

The structure and/or operation of any of the Bill-Pay node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the Bill-Pay controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the Bill-Pay controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
          $input = “”;
          $input = socket_read($client, 1024);
          $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(″INSERT INTO UserTable (transmission)
VALUES ($data)″); // add data to UserTable table in  a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=
/com.ibm.IBMDI.doc/referenceguide295.htm

and other parser implementations:

http://publib.boulder.ibm.com/infocenter/tivihelp/v2r1/index.jsp?topic=
/com.ibm.IBMDI.doc/referenceguide259.htm

all of which are hereby expressly incorporated by reference.

Additional embodiments of the Bill-Pay may comprise the following:

1. In one embodiment, a processor-implemented bill payment method is disclosed, comprising:

receiving a payer bill payment transaction request from a bill payment third party agent via a user possessed bill payment vehicle,

the received payer bill payment transaction request includes bill information of a bill issued by a biller and payer identifying information;

verifying the obtained bill information including a payment amount;

retrieving payer account information based on the obtained payer identifying information; and

transferring an approved amount of funds to the biller's account from the payer account.

2. The method of embodiment 1, wherein the bill payment vehicle comprises a magnetic card.

3. The method of embodiment 1, wherein the bill payment vehicle comprises a mobile device.

4. The method of embodiment 1, wherein the third party agent comprises any of a kiosk, a convenience store, and a pharmacy.

5. The method of embodiment 1, wherein the bill payment transaction request is submitted by payer swiping a prepaid card.

6. The method of embodiment 1, wherein the bill payment transaction request is submitted by payer instantiating a bill payment component on a mobile device.

7. The method of embodiment 1, wherein the bill payment transaction request is initiated by entering billing information into an electronic cash register at the bill payment third party agent.

8. The method of embodiment 1, wherein the bill information comprises any of a bill code, a payment amount and an account number.

9. The method of embodiment 1, wherein the bill information is included in a barcode.

10. The method of embodiment 8, wherein the bill information is extracted from barcode reading at the third party agent.

11. The method of embodiment 1, wherein the payer identifying information comprises a payer account related to a biller.

12. The method of embodiment 1, further comprising verifying the received bill payment transaction request based on payer specified bill payment rules.

13. The method of embodiment 11, further comprising verifying a requested payment amount does not exceed a specified maximum payment amount.

14. The method of embodiment 1, further comprising approving a payment amount upon verification.

15. The method of embodiment 1, further comprising updating a payer's account associated with the biller to reflect the transaction.

16. The method of embodiment 1, further comprising: receiving barcode information of a bill from a user mobile device, wherein the barcode information comprises a picture of a barcode on a physical bill captured by the user mobile device.

17. The method of embodiment 1, further comprising charging a service fee to a user for a bill payment transaction.

18. The method of embodiment 1, further comprising:

receiving user account information;

issuing the user possessed bill payment vehicle to the user; and

linking the user possessed bill payment vehicle to the received user account information.

19. The method of embodiment 18, wherein the received user account information comprises any of a user's bank account and PayPal account.

20. The method of embodiment 18, wherein the received user account information comprises a user account associated with the biller.

21. The method of embodiment 1, wherein the biller is a toll system.

22. The method of embodiment 1, wherein the biller is a utility payment company.

23. The method of embodiment 1, wherein the bill is a healthcare bill.

24. The method of embodiment 1, wherein the biller is a healthcare provider.

25. The method of embodiment 24, further comprising:

receiving a balance due bill from the healthcare provider for a patient;

accessing and retrieving information related to the patient's healthcare payment accounts;

deriving a recommendation payment plan including a currency payment amount to pay against the balance due bill respectively from at least one of the patient's healthcare payment accounts;

receiving, from a user interface, an indicator of an approval of the recommendation; and

transmitting a communication that includes the recommendation for payment to a payment network.

26. The method of embodiment 25, wherein the retrieved information includes one or more of: a negative wealth impacting rule pertaining to payment to the healthcare provider for the healthcare to the patient; and

an insurance rule pertaining to payment for the healthcare to the patient.

27. The method of embodiment 25, wherein the retrieved information includes data specific to the patent and an insured entity financially responsible for the patient; and

currency balances in each of one or more accounts respectively issued by an issuer.

28. The method of embodiment 25, wherein the patient's healthcare payment accounts comprise any of a Flexible Spending Account, and a Healthcare Spending Account.

29. The method of embodiment 25, further comprising prompting a user via a user interface to select the recommendation payment plan.

30. The method of embodiment 29, wherein the user interface comprises a mobile screen displayed on a user mobile device.

31. In one embodiment, a bill payment system is disclosed, comprising:

means for receiving a payer bill payment transaction request from a bill payment third party agent via a user possessed bill payment vehicle,

the received payer bill payment transaction request includes bill information of a bill issued by a biller and payer identifying information;

means for verifying the obtained bill information including a payment amount;

means for retrieving payer account information based on the obtained payer identifying information; and

means for transferring an approved amount of funds to the biller's account from the payer account.

32. The system of embodiment 31, wherein the bill payment vehicle comprises a magnetic card.

33. The system of embodiment 31, wherein the bill payment vehicle comprises a mobile device.

34. The system of embodiment 31, wherein the third party agent comprises any of a kiosk, a convenience store, and a pharmacy.

35. The system of embodiment 31, wherein the bill payment transaction request is submitted by payer swiping a prepaid card.

36. The system of embodiment 31, wherein the bill payment transaction request is submitted by payer instantiating a bill payment component on a mobile device.

37. The system of embodiment 31, wherein the bill payment transaction request is initiated by entering billing information into an electronic cash register at the bill payment third party agent.

38. The system of embodiment 31, wherein the bill information comprises any of a bill code, a payment amount and an account number.

39. The system of embodiment 31, wherein the bill information is included in a barcode.

40. The system of embodiment 38, wherein the bill information is extracted from barcode reading at the third party agent.

41. The system of embodiment 31, wherein the payer identifying information comprises a payer account related to a biller.

42. The system of embodiment 31, further comprising means for verifying the received bill payment transaction request based on payer specified bill payment rules.

43. The system of embodiment 31, further comprising means for verifying a requested payment amount does not exceed a specified maximum payment amount.

44. The system of embodiment 31, further comprising means for approving a payment amount upon verification.

45. The system of embodiment 31, further comprising means for updating a payer's account associated with the biller to reflect the transaction.

46. The system of embodiment 31, further comprising:

means for receiving barcode information of a bill from a user mobile device, wherein the barcode information comprises a picture of a barcode on a physical bill captured by the user mobile device.

47. The system of embodiment 31, further comprising means for charging a service fee to a user for a bill payment transaction.

48. The system of embodiment 31, further comprising:

means for receiving user account information;

means for issuing the user possessed bill payment vehicle to the user; and

means for linking the user possessed bill payment vehicle to the received user account information.

49. The system of embodiment 48, wherein the received user account information comprises any of a user's bank account and PayPal account.

50. The system of embodiment 48, wherein the received user account information comprises a user account associated with the biller.

51. The system of embodiment 31, wherein the biller is a toll system.

52. The system of embodiment 31, wherein the biller is a utility payment company.

53. The system of embodiment 31, wherein the bill is a healthcare bill.

54. The system of embodiment 31, wherein the biller is a healthcare provider.

55. The system of embodiment 54, further comprising:

means for receiving a balance due bill from the healthcare provider for a patient;

means for accessing and retrieving information related to the patient's healthcare payment accounts;

means for deriving a recommendation payment plan including a currency payment amount to pay against the balance due bill respectively from at least one of the patient's healthcare payment accounts;

means for receiving, from a user interface, an indicator of an approval of the recommendation; and

means for transmitting a communication that includes the recommendation for payment to a payment network.

56. The system of embodiment 55, wherein the retrieved information includes one or more of: a negative wealth impacting rule pertaining to payment to the healthcare provider for the healthcare to the patient; and

an insurance rule pertaining to payment for the healthcare to the patient.

57. The system of embodiment 55, wherein the retrieved information includes data specific to the patent and an insured entity financially responsible for the patient; and

currency balances in each of one or more accounts respectively issued by an issuer.

58. The system of embodiment 55, wherein the patient's healthcare payment accounts comprise any of a Flexible Spending Account, and a Healthcare Spending Account.

59. The system of embodiment 55, further comprising means for prompting a user via a user interface to select the recommendation payment plan.

60. The system of embodiment 59, wherein the user interface comprises a mobile screen displayed on a user mobile device.

61. In one embodiment, a bill payment apparatus is disclosed, comprising:

a memory;

a processor disposed in communication with said memory, and configured to issue a plurality of processing instructions stored in the memory, wherein the processor issues instructions to:

receive a payer bill payment transaction request from a bill payment third party agent via a user possessed bill payment vehicle,
the received payer bill payment transaction request includes bill information of a bill issued by a biller and payer identifying information;

verify the obtained bill information including a payment amount;

retrieve payer account information based on the obtained payer identifying information; and

transfer an approved amount of funds to the biller's account from the payer account.

62. The apparatus of embodiment 61, wherein the bill payment vehicle comprises a magnetic card.

63. The apparatus of embodiment 60, wherein the bill payment vehicle comprises a mobile device.

64. The apparatus of embodiment 61, wherein the third party agent comprises any of a kiosk, a convenience store, and a pharmacy.

65. The apparatus of embodiment 61, wherein the bill payment transaction request is submitted by payer swiping a prepaid card.

66. The apparatus of embodiment 61, wherein the bill payment transaction request is submitted by payer instantiating a bill payment component on a mobile device.

67. The apparatus of embodiment 61, wherein the bill payment transaction request is initiated by entering billing information into an electronic cash register at the bill payment third party agent.

68. The apparatus of embodiment 61, wherein the bill information comprises any of a bill code, a payment amount and an account number.

69. The apparatus of embodiment 61, wherein the bill information is included in a barcode.

70. The apparatus of embodiment 68, wherein the bill information is extracted from barcode reading at the third party agent.

71. The apparatus of embodiment 61, wherein the payer identifying information comprises a payer account related to a biller.

72. The apparatus of embodiment 61, wherein the processor further issues instructions to verify the received bill payment transaction request based on payer specified bill payment rules.

73. The apparatus of embodiment 61, wherein the processor further issues instructions to verify a requested payment amount does not exceed a specified maximum payment amount.

74. The apparatus of embodiment 61, wherein the processor further issues instructions to approve a payment amount upon verification.

75. The apparatus of embodiment 61, wherein the processor further issues instructions to update a payer's account associated with the biller to reflect the transaction.

76. The apparatus of embodiment 61, wherein the processor further issues instructions to:

receive barcode information of a bill from a user mobile device, wherein the barcode information comprises a picture of a barcode on a physical bill captured by the user mobile device.

77. The apparatus of embodiment 61, wherein the processor further issues instructions to charge a service fee to a user for a bill payment transaction.

78. The apparatus of embodiment 61, wherein the processor further issues instructions to:

receive user account information;

issue the user possessed bill payment vehicle to the user; and

link the user possessed bill payment vehicle to the received user account information.

79. The apparatus of embodiment 78, wherein the received user account information comprises any of a user's bank account and PayPal account.

80. The apparatus of embodiment 78, wherein the received user account information comprises a user account associated with the biller.

81. The apparatus of embodiment 61, wherein the biller is a toll system.

82. The apparatus of embodiment 61, wherein the biller is a utility payment company.

83. The apparatus of embodiment 61, wherein the bill is a healthcare bill.

84. The apparatus of embodiment 61, wherein the biller is a healthcare provider.

85. The apparatus of embodiment 84, wherein the processor further issues instructions to:

receive a balance due bill from the healthcare provider for a patient;

access and retrieving information related to the patient's healthcare payment accounts;

derive a recommendation payment plan including a currency payment amount to pay against the balance due bill respectively from at least one of the patient's healthcare payment accounts;

receive, from a user interface, an indicator of an approval of the recommendation; and

transmit a communication that includes the recommendation for payment to a payment network.

86. The apparatus of embodiment 85, wherein the retrieved information includes one or more of: a negative wealth impacting rule pertaining to payment to the healthcare provider for the healthcare to the patient; and

an insurance rule pertaining to payment for the healthcare to the patient.

87. The apparatus of embodiment 85, wherein the retrieved information includes data specific to the patent and an insured entity financially responsible for the patient; and

currency balances in each of one or more accounts respectively issued by an issuer.

88. The apparatus of embodiment 85, wherein the patient's healthcare payment accounts comprise any of a Flexible Spending Account, and a Healthcare Spending Account.

89. The apparatus of embodiment 85, wherein the processor further issues instructions to prompt a user via a user interface to select the recommendation payment plan.

90. The apparatus of embodiment 89, wherein the user interface comprises a mobile screen displayed on a user mobile device.

91. In one embodiment, a bill payment computer-readable non-transitory medium storing processor-issuable-and-generated instructions to:

receive a payer bill payment transaction request from a bill payment third party agent via a user possessed bill payment vehicle,
the received payer bill payment transaction request includes bill information of a bill issued by a biller and payer identifying information;

verify the obtained bill information including a payment amount;

retrieve payer account information based on the obtained payer identifying information; and

transfer an approved amount of funds to the biller's account from the payer account.

92. The medium of embodiment 91, wherein the bill payment vehicle comprises a magnetic card.

93. The medium of embodiment 91, wherein the bill payment vehicle comprises a mobile device.

94. The medium of embodiment 91, wherein the third party agent comprises any of a kiosk, a convenience store, and a pharmacy.

95. The medium of embodiment 91, wherein the bill payment transaction request is submitted by payer swiping a prepaid card.

96. The medium of embodiment 91, wherein the bill payment transaction request is submitted by payer instantiating a bill payment component on a mobile device.

97. The medium of embodiment 91, wherein the bill payment transaction request is initiated by entering billing information into an electronic cash register at the bill payment third party agent.

98. The medium of embodiment 91, wherein the bill information comprises any of a bill code, a payment amount and an account number.

99. The medium of embodiment 91, wherein the bill information is included in a barcode.

100. The medium of embodiment 98, wherein the bill information is extracted from barcode reading at the third party agent.

101. The medium of embodiment 91, wherein the payer identifying information comprises a payer account related to a biller.

102. The medium of embodiment 91, further storing processor-issuable-and-generated instructions to verify the received bill payment transaction request based on payer specified bill payment rules.

103. The medium of embodiment 91, further storing processor-issuable-and-generated instructions to verify a requested payment amount does not exceed a specified maximum payment amount.

104. The medium of embodiment 91, further storing processor-issuable-and-generated instructions to approve a payment amount upon verification.

105. The medium of embodiment 91, further storing processor-issuable-and-generated instructions to update a payer's account associated with the biller to reflect the transaction.

106. The medium of embodiment 91, further storing processor-issuable-and-generated instructions to:

receive barcode information of a bill from a user mobile device, wherein the barcode information comprises a picture of a barcode on a physical bill captured by the user mobile device.

107. The medium of embodiment 91, further storing processor-issuable-and-generated instructions to charge a service fee to a user for a bill payment transaction.

108. The medium of embodiment 91, further storing processor-issuable-and-generated instructions to:

receive user account information;

issue the user possessed bill payment vehicle to the user; and

link the user possessed bill payment vehicle to the received user account information.

109. The medium of embodiment 108, wherein the received user account information comprises any of a user's bank account and PayPal account.

110. The medium of embodiment 108, wherein the received user account information comprises a user account associated with the biller.

111. The medium of embodiment 91, wherein the biller is a toll system.

112. The medium of embodiment 91, wherein the biller is a utility payment company.

113. The medium of embodiment 91, wherein the bill is a healthcare bill.

114. The medium of embodiment 91, wherein the biller is a healthcare provider.

115. The medium of embodiment 114, further storing processor-issuable-and-generated instructions to:

receive a balance due bill from the healthcare provider for a patient;

access and retrieving information related to the patient's healthcare payment accounts;

derive a recommendation payment plan including a currency payment amount to pay against the balance due bill respectively from at least one of the patient's healthcare payment accounts;

receive, from a user interface, an indicator of an approval of the recommendation; and

transmit a communication that includes the recommendation for payment to a payment network.

116. The medium of embodiment 115, wherein the retrieved information includes one or more of: a negative wealth impacting rule pertaining to payment to the healthcare provider for the healthcare to the patient; and

an insurance rule pertaining to payment for the healthcare to the patient.

117. The medium of embodiment 115, wherein the retrieved information includes data specific to the patent and an insured entity financially responsible for the patient; and

currency balances in each of one or more accounts respectively issued by an issuer.

118. The medium of embodiment 115, wherein the patient's healthcare payment accounts comprise any of a Flexible Spending Account, and a Healthcare Spending Account.

119. The medium of embodiment 115, further storing processor-issuable-and-generated instructions to prompt a user via a user interface to select the recommendation payment plan.

120. The medium of claim 119, wherein the user interface comprises a mobile screen displayed on a user mobile device.

In order to address various issues and advance the art, the entirety of this application for ACCOUNT NUMBER BASED BILL PAYMENT PLATFORM APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a Bill-Pay individual and/or enterprise user, database configuration and/or relational model, data type, data transmission and/or network framework, syntax structure, and/or the like, various embodiments of the Bill-Pay, may be implemented that facilitates a great deal of flexibility and customization. While various embodiments and discussions of the Bill-Pay have been directed to social networks, however, it is to be understood that the embodiments described herein may be readily configured and/or customized for a wide variety of other applications and/or implementations.

What is claimed is:

1. A processor-implemented bill payment method, comprising:
receiving a payer bill payment transaction request from a bill payment third party agent via a user possessed bill payment vehicle,
the received payer bill payment transaction request includes bill information of a bill issued by a biller and payer identifying information;
verifying the obtained bill information including a payment amount;
retrieving payer account information based on the obtained payer identifying information; and
transferring an approved amount of funds to the biller's account from the payer account.

2. The method of claim 1, wherein the bill payment vehicle comprises a magnetic card.

3. The method of claim 1, wherein the bill payment vehicle comprises a mobile device.

4. The method of claim 1, wherein the third party agent comprises any of a kiosk, a convenience store, and a pharmacy.

5. The method of claim 1, wherein the bill payment transaction request is submitted by payer swiping a prepaid card.

6. The method of claim 1, wherein the bill payment transaction request is submitted by payer instantiating a bill payment component on a mobile device.

7. The method of claim 1, wherein the bill payment transaction request is initiated by entering billing information into an electronic cash register at the bill payment third party agent.

8. The method of claim 1, wherein the bill information comprises any of a bill code, a payment amount and an account number.

9. The method of claim 1, wherein the bill information is included in a barcode.

10. The method of claim 8, wherein the bill information is extracted from barcode reading at the third party agent.

11. The method of claim 1, wherein the payer identifying information comprises a payer account related to a biller.

12. The method of claim 1, further comprising verifying the received bill payment transaction request based on payer specified bill payment rules.

13. The method of claim 11, further comprising verifying a requested payment amount does not exceed a specified maximum payment amount.

14. The method of claim 1, further comprising approving a payment amount upon verification.

15. The method of claim 1, further comprising updating a payer's account associated with the biller to reflect the transaction.

16. The method of claim 1, further comprising:
receiving barcode information of a bill from a user mobile device, wherein the barcode information comprises a picture of a barcode on a physical bill captured by the user mobile device.

17. The method of claim 1, further comprising charging a service fee to a user for a bill payment transaction.

18. The method of claim 1, further comprising:
receiving user account information;
issuing the user possessed bill payment vehicle to the user; and
linking the user possessed bill payment vehicle to the received user account information.

19. The method of claim 18, wherein the received user account information comprises any of a user's bank account and PayPal account.

20. The method of claim 18, wherein the received user account information comprises a user account associated with the biller.

21. The method of claim 1, wherein the biller is a toll system.

22. The method of claim 1, wherein the biller is a utility payment company.

23. The method of claim 1, wherein the bill is a healthcare bill.

24. The method of claim 1, wherein the biller is a healthcare provider.

25. The method of claim 24, further comprising:
receiving a balance due bill from the healthcare provider for a patient;
accessing and retrieving information related to the patient's healthcare payment accounts;
deriving a recommendation payment plan including a currency payment amount to pay against the balance due bill respectively from at least one of the patient's healthcare payment accounts;
receiving, from a user interface, an indicator of an approval of the recommendation; and
transmitting a communication that includes the recommendation for payment to a payment network.

26. The method of claim 25, wherein the retrieved information includes one or more of: a negative wealth impacting rule pertaining to payment to the healthcare provider for the healthcare to the patient; and
an insurance rule pertaining to payment for the healthcare to the patient.

27. The method of claim 25, wherein the retrieved information includes data specific to the patent and an insured entity financially responsible for the patient; and
currency balances in each of one or more accounts respectively issued by an issuer.

28. The method of claim 25, wherein the patient's healthcare payment accounts comprise any of a Flexible Spending Account, and a Healthcare Spending Account.

29. The method of claim 25, further comprising prompting a user via a user interface to select the recommendation payment plan.

30. The method of claim 29, wherein the user interface comprises a mobile screen displayed on a user mobile device.

31. A bill payment system, comprising:
means for receiving a payer bill payment transaction request from a bill payment third party agent via a user possessed bill payment vehicle,
the received payer bill payment transaction request includes bill information of a bill issued by a biller and payer identifying information;
means for verifying the obtained bill information including a payment amount;
means for retrieving payer account information based on the obtained payer identifying information; and
means for transferring an approved amount of funds to the biller's account from the payer account.

32. A bill payment apparatus, comprising:
a memory;
a processor disposed in communication with said memory, and configured to issue a plurality of processing instructions stored in the memory, wherein the processor issues instructions to:
receive a payer bill payment transaction request from a bill payment third party agent via a user possessed bill payment vehicle,
the received payer bill payment transaction request includes bill information of a bill issued by a biller and payer identifying information;
verify the obtained bill information including a payment amount;
retrieve payer account information based on the obtained payer identifying information; and
transfer an approved amount of funds to the biller's account from the payer account.

33. A bill payment computer-readable non-transitory medium storing processor-issuable-and-generated instructions to:
receive a payer bill payment transaction request from a bill payment third party agent via a user possessed bill payment vehicle,
the received payer bill payment transaction request includes bill information of a bill issued by a biller and payer identifying information;
verify the obtained bill information including a payment amount;
retrieve payer account information based on the obtained payer identifying information; and
transfer an approved amount of funds to the biller's account from the payer account.
